(19) United States
(12) Patent Application Publication
(10) Pub. No.: US 2011/0131005 A1
(43) Pub. Date: Jun. 2, 2011

(54) MOBILE RECORDING APPARATUS, BODY MOVEMENT MEASURING APPARATUS, INFORMATION PROCESSING APPARATUS, MOVEMENT PATTERN DETERMINING APPARATUS, ACTIVITY AMOUNT CALCULATING APPARATUS, RECORDING METHOD, BODY MOVEMENT MEASURING METHOD, INFORMATION PROCESSING METHOD, MOVEMENT PATTERN DETERMINING METHOD, ACTIVITY AMOUNT CALCULATING MET

(76) Inventors: Hiromu Ueshima, Shiga (JP); Takahiro Kido, Shiga (JP); Kazuo Shimizu, Shiga (JP)

(21) Appl. No.: 12/808,543

(22) PCT Filed: Sep. 16, 2008
(86) PCT No.: PCT/JP2008/002536

§ 371 Date: Jan. 19, 2011

(30) Foreign Application Priority Data
Dec. 18, 2007 (JP) 2007-325378
Jun. 3, 2008 (JP) 2008-146324

(51) Int. Cl. G01P 15/00

(52) U.S. Cl. 702/141; 73/488

(57) ABSTRACT

In an automatic recording mode, an action sensor 6 detects acceleration depending on motion of a user 9 in a three-dimensional space, displays the number of steps as computed on the basis of the detected acceleration on an LCD 35 as equipped therewith, and records it. In a manual recording mode, the action sensor 6 records behavior information and body information as inputted by the user 9. In a communication mode, the action sensor 6 transmits the information recorded in the automatic recording mode and the manual recording mode to a cartridge 4 while the cartridge 4 visualizes the information. In the communication mode, the action sensor 6 inputs the acceleration information to the cartridge 4 in real time, and provide the user 9 with various contents using a video image to be displayed on a television monitor 5 in cooperation with the cartridge 4.

### TECHNICAL FIELD

The present invention relates to a portable recording apparatus and the related arts for recording behavior information and/or body information of a user.

Also, the present invention relates to a portable body motion measuring apparatus and the related arts for measuring motion of a body of a user in three-dimensional space.

Further, the present invention relates to a motion form determining apparatus and the related arts for determining motion form of a user.

Still further, the present invention relates to an activity computing apparatus and the related arts for computing amount of activity of a user.

### BACKGROUND ART

In recent years, a metabolic syndrome is a social issue, and prevention and improvement thereof are an important subject. The metabolic syndrome causes arteriosclerosis by complication of two or more of hyperglycemia, hyperpiesia, and hyperlipemia based on visceral fat obesity, thereby increases risk of deadly disease such as heart disease and apoplexia cerebri exponentially, and is therefore very harmful.

By the way, Patent Document 1 discloses a compact motion recording and analyzing apparatus which can be mounted on a human body and so on without providing any uncomfortable feeling. The compact motion recording and analyzing apparatus detects motion of an animal in time series by three acceleration sensors of high accuracy in such a manner that the motion is divided into respective accelerations, which represent a movement in a front-back direction, a movement in a horizontal direction, and a movement in a vertical direction, and records in a recording medium (a recording unit), and compare the respective values with stored information as preformulated, and determines and classifies the current motion by the difference therebetween (an analyzing unit).

In the motion recording and analyzing apparatus, the recording unit is worn, measures the motion for a period, and sends the measured data to the analyzing unit. And, the analyzing unit analyzes the motion on the basis of the measured data. A user looks at the result of the analysis, wears the recording unit, and moves again.
[Patent Document 1] Japanese Unexamined Utility Model Application Publication No. 61-54802

### DISCLOSURE OF THE INVENTION

### Problem to be Solved by the Invention

Although the recording unit detects the motion of the user, the analyzing unit does not receive the result of the detection by the recording unit as real-time input. Accordingly, the analyzing unit does not perform the output in response to real-time input from the recording unit. In this way, the recording unit and the analyzing unit function only as stand-alone bodies respectively, and do not function in cooperation with each other.

Also, the recording unit can record only the physical quantity detectable by the sensor. Although this can sufficiently accomplish this Document's objective of recording the motion, this may be insufficient as record for managing behavior, health and/or lifestyle of the user.

It is therefore an object of the present invention to provide a portable recording apparatus and the related techniques thereof suitable for managing behavior, health, and/or lifestyle by recording behavior information and/or body information at anytime and any place when a user wants and visualizing when needed.

It is an another object of the present invention to provide a body motion measuring apparatus and the related techniques thereof capable of functioning also alone by detecting motion of a user in three-dimensional space and displaying a result of detection on a display device as equipped, and moreover functioning in cooperation with an external device by inputting the result of the detection to the external device on a real-time basis.

It is a further object of the present invention to provide a motion form determining apparatus and the related techniques thereof suitable for computing amount of activity.

It is a still further object of the present invention to provide an activity computing apparatus and the related techniques thereof capable of computing amount of activity in which motion of a user is more directly reflected.

### Solution of the Problem

In accordance with a first aspect of the present invention, a portable recording apparatus for recording input information from a user, and capable of being carried, comprising: an input unit configured to be operated by the user, receive an input from the user, and output the input information; a displaying unit operable to display information depending on the operation of said input unit; a recording unit operable to record the input information as outputted by said input unit in association with at least time information, in a manual recording mode; and a transmitting unit operable to transmit the input information as associated with time information, which is recorded in said recording unit, in a communication mode, to an external device which processes the input information to visualize, wherein the input information includes behavior information and/or body information of the user.

In accordance with this configuration, since the present apparatus is portable, the user can input and record the behavior information and the body information at any time and place which he/she desires. And, the recorded information is transmitted to the external device and is visualized therein. In this case, since the record is associated with the time, it is possible to visualize time variation of the record. Accordingly, this is useful in the behavior management, the health management, the lifestyle management, or the like of the user.

The portable recording apparatus further comprising: a detecting unit operable to detect physical quantity depending on motion of the user in a three-dimensional space, in an automatic recording mode; and a computing unit operable to compute predetermined information on the basis of the physical quantity as detected by said detecting unit, and updates the predetermined information on the basis of the physical quantity which is sequentially detected, in the automatic recording mode, wherein said displaying unit displays the predetermined information as updated by said computing unit, in the automatic recording mode, wherein said recording unit records the predetermined information in association with at least time information, in the automatic recording mode, and wherein said transmitting unit transmits the predetermined information as associated with time information, which is recorded in said recording unit, in the communication mode, to the external device.

In accordance with this configuration, since the motion of the user is automatically detected and the result of the processing thereof is recorded in the automatic recording mode, it is possible to record the information difficult or impossible to input manually by the user. For example, this is suitable for recording the result (e.g., the number of steps in the embodiment) of the operation to the information (e.g., the acceleration in the embodiment) which is required to be measured and operated continually.

In the portable recording apparatus, wherein in the automatic recording mode, said computing unit applies a first-order processing to the physical quantity which said detecting unit detects to compute first-order processed data as the predetermined information, and a high-order processing for processing the first-order processed data is not performed.

In accordance with this configuration, since the first-order processed data obtained by applying the first-order processing to the physical quantity as the original data is recorded in the automatic recording mode, it is possible to reduce memory capacity of the recording unit in comparison with the case of recording the original data. Also, since volume of data to be transmitted to the external device is smaller, it is possible to speed up the data communication. If the volume of the communication data is smaller, it is possible to reduce power consumption of the portable recording apparatus. Also, it is possible to further improve the function of the portable recording apparatus as a stand-alone device by performing the first-order processing to display the information which the user can easily recognize.

In this way, in the automatic recording mode, the portable recording apparatus does not perform the second or more-order processing (the high-order processing). Accordingly, it is possible to suppress the arithmetic capacity and the power consumption of the portable recording apparatus as much as possible. Also, while the displaying unit is required to relatively enlarge size and resolution thereof in order to perform the high-order processing and fully express the result, since the portable recording apparatus does not perform the high-order processing, it is possible to suppress the performance of the displaying unit. Also, since it is possible to miniaturize the size of the displaying unit, it is possible to improve the portability of the present recording apparatus, and furthermore it is possible to reduce the power consumption thereof.

In the above portable recording apparatus, wherein said detecting unit detects the physical quantity depending on motion of the user in a three-dimensional space, in the communication mode, and wherein said transmitting unit transmits information relating to the physical quantity which said detecting unit sequentially detects depending on motion of the user, in the communication mode, in real time sequentially, to the external device which processes the information relating to the physical quantity in association with at least any one of a video image, audio, a computer, and a predetermined mechanism.

In accordance with this configuration, in the communication mode, the information relating to the physical quantity as detected is inputted to the external device in real time, and therefore it is possible to provide the user with various contents using the video image, the audio, the computer, or the predetermined mechanism in cooperation with the external device.

Also, in the automatic recording mode and the manual recording mode, the user can also do exercise carrying only the portable recording apparatus. On the other hand, in the communication mode, the user can input the physical quantity depending on the motion to the external device in real time by moving the body. That is, the action for inputting to the external device corresponds to an exercise in itself. In this case, the external device provides the user with the various contents using the images and so on in accordance with the input from the user. Accordingly, instead of moving the body excursively, the user can do exercise while enjoying these contents.

As the result, while the exercise is done carrying only the portable recording apparatus in the manual recording mode and the automatic recording mode, it is possible to supplement the insufficient exercise therein with the portable recording apparatus and the external device using the communication mode. Also, the opposite is true. In this way, it is possible to more effectively support attainment of a goal of the exercise by doing exercise in two stages.

In the above portable recording apparatus, wherein in the manual recording mode, an n-th-order processing (n is one or a larger integer) is not applied to the input information, and said transmitting unit transmits the input information as an original data.

In accordance with this configuration, in the manual recording mode, the input information from the user is recorded as the original data without applying the n-th-order processing thereto. As the result, it is possible to reduce the processing load and suppress the arithmetic capacity of the present recording apparatus. In passing, the original data in this case is inputted by the user, and the data volume thereof is considerably small in comparison with the output data from the sensor. For this reason, the first-order processing thereof is not required, unlike the output data form the sensor.

In accordance with a second aspect of the present invention, an information processing apparatus for processing behavior information and/or body information as inputted by a user, which said portable recording apparatus according to the above first aspect transmits, comprising: a receiving unit operable to receive the behavior information and/or the body information from said portable recording apparatus; and a processing unit operable to visualize the behavior information and/or the body information as received.

In accordance with this configuration, it is possible to provide the user with the behavior information and/or the body information as inputted by the user at any place in an easily visibly understandable format by visualizing. As the result, this is useful in the behavior management, the health management, the lifestyle management, or the like of the user.

In accordance with a third aspect of the present invention, a body motion measuring apparatus having a first mode and a second mode, for measuring motion of a body of a user in a three-dimensional space, and capable of being carried, comprising: a detecting unit operable to detect physical quantity depending on motion of the user in a three-dimensional space, in the first mode and the second mode; a computing unit operable to compute predetermined display information on the basis of the physical quantity as detected by said detecting unit, and update the predetermined display information on the basis of the physical quantity which is sequentially detected, in the first mode at least; a displaying unit operable to display the predetermined display information as updated by said computing unit, in the first mode at least; and a transmitting unit operable to transmit information relating to the physical quantity which said detecting unit sequentially detects depending on motion of the user, in the second mode, in real time sequentially, to an external device which processes the information relating to the physical quantity in association with at least any one of a video image, audio, a computer, and a predetermined mechanism.

In accordance with this configuration, the body motion measuring apparatus detects the physical quantity in accordance with the motion of the user in the three-dimensional space, and therefore can display the information based on the detected physical quantity on the displaying unit as equipped therewith, and thereby also functions as a stand-alone device. That is, in the first mode, it does not communicate with the external device, and singly functions independently of the external device. In addition to this function, in the second mode, it is possible to input the information relating to the physical quantity as detected to the external device in real time, and provide the user with various contents using the video image, the audio, the computer, or the predetermined mechanism in cooperation with the external device.

Also, the user can also do exercise carrying only the body motion measuring apparatus in the first mode. On the other hand, in the second mode, the user can input the physical quantity depending on the motion to the external device in real time by moving the body. That is, the action for inputting to the external device corresponds to an exercise in itself. In this case, the external device provides the user with the various contents using the images and so on in accordance with the input from the user. Accordingly, instead of moving the body excursively, the user can do exercise while enjoying these contents.

As the result, while the exercise is done carrying only the body motion measuring apparatus in the first mode, it is possible to supplement the insufficient exercise therein with the body motion measuring apparatus and the external device using the second mode. Also, the opposite is true. In this way, it is possible to more effectively support attainment of a goal of the exercise by doing exercise in two stages.

Incidentally, in the present specification and claims, the term “information relating to physical quantity” includes the physical quantity itself (e.g., the acceleration in the embodiment) and the result of the operation based on the physical quantity (e.g., the number of steps for each motion form in the embodiment).

In the body motion measuring apparatus, wherein the physical quantity is acceleration. In accordance with this configuration, since the acceleration sensor, which becomes widely used, can be used, it is possible to reduce the cost.

In the above body motion measuring apparatus, wherein the predetermined display information is the number of steps. In accordance with this configuration, the body motion measuring apparatus can function as a pedometer.

The above body motion measuring apparatus is mounted on a torso or a head region.

In accordance with this configuration, since the body motion measuring apparatus is mounted on the torso or the head region, it is possible to measure not the motion of the part of user (the motion of arms and legs) but the motion of the entire body.

Generally, since the arms and legs can be moved independently from the torso, even if the body motion measuring apparatus are mounted on the arms and legs, it is difficult to detect the motion of the entire body, and therefore it is required to mount the body motion measuring apparatus on the torso. However, although the head region can be moved independently from the torso, in the case where the torso is moved, the head region hardly moves by itself, and usually moves integrally with the torso, therefore, even when the body motion measuring apparatus is mounted on the head region, it is possible to detect the motion of the entire body.

Incidentally, in the present specification and claims, the term “torso” represents a body except a head, a neck, and arms and legs. The head region represents a head and a neck.

In accordance with a fourth aspect of the present invention, an information processing apparatus for processing information relating to physical quantity depending on motion of a user, which said body motion measuring apparatus according to the above third aspect transmits, comprising: a receiving unit operable to receive the information relating to the physical quantity which is sequentially detected depending on motion of the user, from said body motion measuring apparatus in real time sequentially; and a processing unit operable to processes the information relating to the physical quantity, which is sequentially received in real time, in association with at least any one of a video image, audio, a computer, and a predetermined mechanism.

In accordance with this configuration, it is possible to provide the user with various contents using the video image, the audio, the computer, or the predetermined mechanism in cooperation with the novel body motion measuring apparatus according to the above third aspect. In this case, the processing unit may control the image, the audio, the computer, or the predetermined mechanism on the basis of the information relating to the physical quantity as received from the body motion measuring apparatus, or may also process the information relating to the physical quantity as received from the body motion measuring apparatus in association with the image, the audio, the computer, or the predetermined mechanism, which the processing unit controls without depending on the information relating to the physical quantity.

In the information processing apparatus, wherein said processing unit includes: an instructing unit operable to instruct the user to perform a predetermined motion, by a video image at least; and a determining unit operable to determine whether or not the user performs the predetermined motion as instructed by said instructing unit on the basis of the information relating to the physical quantity.

Generally, various exercises such as a stretching exercise and a circuit exercise have a goal, and it is required to adequately perform specified motion so as to effectively attain the goal. In this case, while an instruction indicates the motion by an image and so on, it is difficult for the user himself or herself to judge whether or not the user adequately performs the instructed motion.

However, in accordance with the present invention, it is possible to judge whether or not the user performs the motion as instructed by the image, and therefore it is possible to show the result of the judgment to the user. For this reason, the user can correct his/her motion by looking at the result, and adequately perform the instructed exercise. As the result, the user can effectively attain the goal of the instructed exercise.

Also, in the above information processing apparatus, wherein said processing unit may include: a moving image controlling unit operable to control a moving image to be displayed on a display device on the basis of the information relating to the physical quantity.

In accordance with this configuration, the user can control the moving image as displayed on the display device by moving the body in the three-dimensional space. As the result, since the user can do exercise while looking at the moving image which responds to the motion of his/her own body, the user 9 does not get bored easily in comparison with the case where the body is excursively moved, and it is possible to support the continuation of the exercise.

Incidentally, in the present specification and claims, the term “moving image” includes a moving image in the first person viewpoint and a moving image in the third person viewpoint (e.g., a response object as described below).

In the information processing apparatus, wherein said processing unit further includes: a guiding unit operable to display a guide object, which guides the user so as to do a stepping exercise, on the display device.

In accordance with this configuration, the user can do the stepping exercise not at a subjective pace but at a pace of the guide object, i.e., at an objective pace by doing the stepping exercise in accordance with the guide object.

In the information processing apparatus, wherein said processing unit further includes: an evaluating unit operable to evaluate the stepping exercise of the user relative to the guide object on the basis of the information relating to the physical quantity.

In accordance with this configuration, it is possible to determine whether or not the user appropriately carries out the stepping exercise which the guide object guides, and provide the result of the determination with the user. For this reason, the user can correct the pace of his/her stepping and so on by looking at the result, and stably do the stepping exercise.

In the above information processing apparatus, wherein the moving image is a response object which responds to motion of the user on the basis of the information relating to the physical quantity.

In accordance with this configuration, the user can control the response object by moving the body. As the result, since it is possible to do exercise while looking at the response object which responds to the motion of his/her own body, he/she does not get bored easily in comparison with the case where the body is excursively moved, and it is possible to support the continuation of the exercise.

In the above information processing apparatus, wherein said processing unit includes: a position updating unit operable to update a position of the user in a virtual space as displayed on a display device on the basis of the information relating to the physical quantity; and a direction updating unit operable to update a direction of the user in the virtual space on the basis of acceleration or angular velocity which is included in the information relating to the physical quantity.

In accordance with this configuration, the user can look at such the video image as if actually moving in virtual space as displayed on the display device by moving the body in the three-dimensional space. That is, the user 9 can experience the event in the virtual space by simulation by moving the body. As the result, the tediousness is not felt easily in comparison with the case where the body is excursively moved, and it is possible to support the continuation of the exercise. Also, the change of the direction in the virtual space is performed on the basis of the acceleration or the angular velocity. Accordingly, the user 9 can intuitively change the direction in the virtual space only by changing the direction of the body, on which the body motion measuring apparatus is mounted, to the desired direction.

In the information processing apparatus, wherein said processing unit further includes: a mark unit operable to display a mark which is close to the position of the user in the virtual space, and indicates a direction of a predetermined point in the virtual space in real time.

Although a size of the virtual space is substantially infinite, a part thereof is just displayed on the display device. Accordingly, even if the user tries to travel to a predetermined location in the virtual space, the user can not recognize the location. However, in accordance with the present invention, since the mark, which indicates the direction of the predetermined location, is displayed, it is possible to assist the user whose objective is to reach the predetermined location in the huge virtual space.

In the information processing apparatus, wherein said position updating unit updates the position of the user in a maze, which is formed in the virtual space, on the basis of the information relating to the physical quantity, and wherein said mark unit displays the mark which is close to the position of the user in the maze, and indicates the direction of the predetermined point which is a goal of the maze in real time.

In accordance with this configuration, the user can experience the maze by simulation. A maze game is well known and does not require knowledge and experience, and therefore many users can easily enjoy the maze game using the body motion measuring apparatus and the information processing apparatus.

In the above information processing apparatus, wherein said processing unit includes: a pass point arranging unit operable to arrange a plurality of pass points, which continue toward a depth in the virtual space at a viewpoint of the user; and a guiding unit operable to display a guide object which guides the user to the pass point.

Generally, in the case where his/her own position is moved in the virtual space as displayed on the display device, it may be difficult for a person who is unused to a video game and so on for playing in the virtual space to get the feeling of the virtual space (e.g., his/her own position in the virtual space, the position relative to the other object in the virtual space, and so on). However, in accordance with the present invention, the guide object is displayed, and thereby it is possible to assist the user so as to be appropriately able to move toward the pass point. As the result, even a person is unused to the virtual space, it is easily handled.

In the above information processing apparatus, wherein said processing unit includes: an activity amount computing unit operable to compute amount of body activity of the user on the basis of the information relating to the physical quantity.

In accordance with this configuration, since the amount of the activity of the user is computed, the user can acquire his/her objective amount of the activity by showing it to the user.

In accordance with a fifth aspect of the present invention, a motion form determining apparatus for determining a motion form of a user, comprising: a first classifying unit operable to classify motion of the user into any one of a plurality of first motion forms on the basis of magnitude of acceleration which arises due to the motion of the user; and a second classifying unit operable to classify the motion of the user which is classified into the first motion form into any one of a plurality of second motion forms on the basis of information relating to velocity of the user based on the acceleration.

In accordance with this configuration, the motion of the user 9 is provisionally classified into any one of the plurality of the first motion forms at first. The reason is as follows.

It is assumed that the amount of the activity is calculated depending on the motion form of the user. The amount (Ex) of the activity is obtained by multiplying the intensity (METs) of the motion by the time (hour). The intensity of the motion is determined depending on the motion form. The motion form in this case is classified on the basis of the velocity. Accordingly, in the case where the amount of the activity is calculated depending on the motion form, it is preferred that the motion of the user is finally classified on the basis of the velocity.

However, if the classification is performed using only the velocity, there is a possibility that the following inexpedience occurs. A specific example will be described. A stride and a time corresponding to one step are needed so as to obtain the velocity of the user. In general, the time corresponding to one step is shorter when walking, and is longer when running. On the other hand, in general, the stride decreases when walking, and increases when running. Accordingly, although he/she really runs, if the velocity is calculated on the basis of the stride in walking, the value thereof becomes small, and therefore it may be classified into the walking. On the other hand, although he/she really walks, if the velocity is calculated on the basis of the stride in running, the value thereof becomes large, and therefore it may be classified into the running.

Because of this, in the present invention, the motion of the user is provisionally classified into any one of the plurality of the first motion forms on the basis of the magnitude of the acceleration. In this way, the stride can be set for each of the first motion forms. As the result, the above inexpedience does not occur, it is possible to appropriately classify the motion of the user into any one of the plurality of the second motion forms in accordance with the velocity, and eventually it is possible to appropriately calculate the amount of the activity. That is, the present invention is suitable for the calculation of the amount of the activity.

Incidentally, in the present specification and claims, the term “information relating to velocity” includes the velocity itself, information representing indirectly the velocity, and information correlating with the velocity (e.g., the tempo in the embodiment).

The motion form determining apparatus further comprising: a determining unit operable to determine whether or not the user performs motion corresponding to one step on the basis of the acceleration, wherein said first classifying unit performs the process for classifying after said determining unit determines that the motion corresponding to one step is performed.

In accordance with this configuration, it is possible to separate the motion corresponding to one step from the noise before the classifying process. Accordingly, the process for eliminating the noise is not required in the classifying process, and therefore it is possible to simplify and speed up the classifying process. In passing, while the classifying process includes many determination processes, setting the determination of the noise after the first determination process aside, in the case where it is determined as the noise after the subsequent determination process, the determination process and the processing, which are performed till then, waste. In the present invention, it is possible to reduce these wasteful processes by eliminating the noise before the classifying process.

In the above motion form determining apparatus, wherein said first classifying unit performs the process for classifying on the basis of a maximum value and a minimum value of the acceleration during a period from time when one step arises until time when a next one step arises.

In accordance with this configuration, since the first classifying unit performs the classifying process on the basis of the maximum value and the minimum value of the acceleration, i.e., magnitude of amplitude of the acceleration, it is possible to classify the motion of the user into any one of the plurality of the first motion forms simply appropriately.

In the motion form determining apparatus, wherein said first classifying unit classifies the motion of the user into the first motion form indicating running if the maximum value exceeds a first threshold value and the minimum value is below a second threshold value, and classifies the motion of the user into the first motion form indicating walking if the maximum value is below the first threshold value at least or if the minimum value exceeds the second threshold value at least.

In accordance with this configuration, the first classifying unit classifies the motion of the user into the running if the amplitude of the acceleration is large, otherwise classifies it into the walking.

In the above motion form determining apparatus, wherein in a case where the motion of the user is classified into the first motion form indicating walking, said second classifying unit classifies the motion of the user into the second motion form indicating standard walking if the information relating to the velocity of the user is below a third threshold value at least, and classifies the motion of the user into the second motion form indicating rapid walking if the information relating to the velocity of the user exceeds the third threshold value at least.

In accordance with this configuration, the second classifying unit can classify the walking of the first motion form into either the standard walking or the rapid walking in more detail in accordance with the velocity of the user.

The motion form determining apparatus further comprising: a first specifying unit operable to specify that the second motion form includes going up and down if a maximum value of the acceleration during a period from time when one step arises until time when a next one step arises exceeds a fourth threshold value, in a case where the motion of the user is classified into the second motion form indicating standard walking.

In accordance with this configuration, In this case, it is possible to specify what kind of form is further included in the standard walking of the second motion form on the basis of the magnitude of the acceleration of the user.

In this case, it is possible to determine the going up and down because the first classifying unit classifies the motion of the user on the basis of the magnitude of the acceleration in the stage before determining the going up and down, and then moreover the second classifying unit classifies on the basis of the velocity. If the motion of the user is classified using only the magnitude of the acceleration, the going up and down can not be distinguished from the running.

In the above motion form determining apparatus, wherein in a case where the motion of the user is classified into the first motion form indicating running, said second classifying unit classifies the motion of the user into the second motion form indicating rapid walking/running if the information relating to the velocity of the user exceeds a fifth threshold value at least, and classifies the motion of the user into the second motion form indicating rapid walking if the information relating to the velocity of the user is below the fifth threshold value at least.

In accordance with this configuration, the second classifying unit can classify the running of the first motion form into either the rapid walking/running or the rapid walking in more detail in accordance with the velocity of the user.

Incidentally, in the present specification and claims, the term “rapid walking/running” indicates the state where the motion of the user is either the rapid walking or the running and therefore is unsettled yet.

The motion form determining apparatus further comprising: a second specifying unit operable to specify that the motion of the user is the second motion form indicating running if a maximum value of the acceleration during a period from time when one step arises until time when a next one step arises exceeds a sixth threshold value at least, and specify that the motion of the user is the second motion form indicating rapid walking if the maximum value is below the sixth threshold value at least, in a case where the motion of the user is classified into the second motion form indicating rapid walking/running.

In accordance with this configuration, after the motion of the user is classified into the rapid walking/running, the second specifying unit conclusively specifies to be anyone of the rapid walking and the running on the basis of the magnitude of the acceleration. Because, if the classifying process is performed using only the fifth threshold value, there is a possibility of the classification into the running depending on a person despite the rapid walking really, and therefore the classification has to perform more certainly.

The above motion form determining apparatus further comprising: an activity amount computing unit operable to compute amount of activity for each second motion form.

In accordance with this configuration, since the amount of the activity of the user is computed, the user can acquire his/her objective amount of the activity by showing it to the user.

The above motion form determining apparatus further comprising: a third specifying unit operable to specify on the basis of magnitude of the acceleration that the motion of the user as classified into the second motion form is the second motion form including a third motion form.

In accordance with this configuration, in the case where the motion of the user is classified into the first motion form on the basis of the magnitude of the acceleration, and moreover the first motion form is classified into the second motion form on the basis of the velocity, it is possible to specify on the basis of the magnitude of the acceleration what kind of the motion form is further included in the second motion form.

Also, the above motion form determining apparatus further comprising: a third classifying unit operable to classify the motion of the user as classified into the second motion form into any one of a plurality of fourth motion forms on the basis of magnitude of the acceleration.

In accordance with this configuration, in the case where the motion of the user is classified into the first motion form on the basis of the magnitude of the acceleration, and moreover the first motion form is classified into the second motion form on the basis of the velocity, the second motion form is further classified in detail on the basis of the magnitude of the acceleration. As the result, it is possible to classify the motion of the user more accurately.

In accordance with a sixth aspect of the present invention, an activity computing apparatus, comprising:

a unit operable to acquire acceleration data which arises depending on motion of a user; and a unit operable to obtain amount of activity in acquiring the acceleration data by multiplying the acceleration data by predetermined amount of activity per unit acceleration.

In accordance with this configuration, the amount of the activity in acquiring the acceleration is obtained by multiplying the acceleration of the user as acquired by the amount of the activity per unit acceleration. In this way, by obtaining the amount of the activity of the user on the basis of the amount of the activity per unit acceleration, it is anticipated that it is possible to obtain the amount of the activity in which the motion of the user is more directly reflected in comparison with the case where the amount of the activity is obtained on the basis of the number of steps (the case of obtaining the amount of the activity of the user by multiplying the number of steps by the amount of the activity per step). The reason is as follows.

It is assumed that the amount of the activity per step is set to one value. But, even when the attention is paid only upon the walking, the movements differ depending on respective steps or persons, or current conditions. Accordingly, when these are lumped together as the walking, even if the amount of the activity per step is multiplied the number of steps, the result is not necessarily a value in which the motion of the user is more directly reflected. Of course, if the walking is classified into one of the more forms and the amount of the activity per step is set for each form, it is possible to obtain the amount of the activity in which the motion of the user is reflected in more detail. However, there is a limit to the number of classifications, and it is difficult to reflect ways of walking and current conditions of respective persons. Although the user can input his/her own way of walking and the current condition, it is impractical.

By the way, the acceleration data correlates with the motion of the user. That is, the motion of the user is directly reflected in the acceleration. And, in the present invention, the amount of the activity is obtained on the basis of the acceleration data in which the motion of the user is directly reflected. As the result, in the present invention, it is possible to obtain the amount of the activity in which the motion of the user is more directly reflected.

The activity computing apparatus further comprising: a unit operable to accumulate the amount of the activity in acquiring the acceleration data. In accordance with this configuration, it is possible to compute the total amount of the activity of the user during the accumulation period.

In accordance with a seventh aspect of the present invention, a recording method capable of being performed by a portable recording apparatus for recording input information from a user, said portable recording apparatus capable of being carried, comprising the steps of: receiving an input from the user, and outputting the input information; recording the input information in association with at least time information; and transmitting the input information as recorded in association with time information to an external device which processes the input information to visualize, wherein the input information includes behavior information and/or body information of the user.

In accordance with this configuration, the same advantage as the portable recording apparatus according to the above first aspect can be gotten.

In accordance with an eighth aspect of the present invention, a information processing method for processing input information as transmitted from a portable recording apparatus including: an input unit configured to be operated by a user, receive an input from the user, and output the input information; a recording unit operable to record the input information as outputted by said input unit in association with at least time information; and a transmitting unit operable to transmit the input information as associated with time information, which is recorded in said recording unit, to an external device which processes the input information to visualize, comprising the steps of: receiving the input information from said portable recording apparatus; and visualizing the received input information, wherein the input information includes behavior information and/or body information of the user.

In accordance with this configuration, the same advantage as the information processing apparatus according to the above second aspect can be gotten.

In accordance with a ninth aspect of the present invention, a body motion measuring method capable of being performed by a portable body motion measuring apparatus having a first mode and a second mode, for measuring motion of a user in a three-dimensional space, comprising the steps of: detecting physical quantity depending on motion of the user in the three-dimensional space, in the first mode and the second mode; computing predetermined display information on the basis of the physical quantity as detected by said step of detecting, and updating the predetermined display information on the basis of the physical quantity which is sequentially detected, in the first mode at least; displaying the predetermined display information as updated by said step of updating, in the first mode at least; and transmitting information relating to the physical quantity which said step of detecting detects sequentially depending on motion of the user, in the second mode, in real time sequentially, to an external device which processes the information relating to the physical quantity in association with at least any one of a video image, audio, a computer, and a predetermined mechanism.

In accordance with this configuration, the same advantage as the body motion measuring apparatus according to the above third aspect can be gotten.

In accordance with a tenth aspect of the present invention, a information processing method for processing information relating to physical quantity depending on motion of a user, which is transmitted by the portable body motion measuring apparatus according to the above third aspect, comprising the steps of: receiving the information relating to the physical quantity, which sequentially is detected depending on the motion of the user, from said body motion measuring apparatus in real time sequentially; and processing the information relating to the physical quantity, which is sequentially received in real time, in association with at least any one of a video image, audio, a computer, and a predetermined mechanism.

In accordance with this configuration, the same advantage as the information processing apparatus according to the above fourth aspect can be gotten.

In accordance with an eleventh aspect of the present invention, a motion form determining method for determining a motion form of a user, comprising the steps of: classifying motion of the user into any one of a plurality of first motion forms on the basis of magnitude of acceleration which arises due to the motion of the user; and classifying the motion of the user which is classified into the first motion form into any one of a plurality of second motion forms on the basis of information relating to velocity of the user based on the acceleration.

In accordance with this configuration, the same advantage as the motion form determining apparatus according to the above fifth aspect can be gotten.

In accordance with a twelfth aspect of the present invention, an activity computing method, comprising the steps of: acquiring acceleration data which arises depending on motion of a user; and obtaining amount of activity in acquiring the acceleration data by multiplying the acceleration data by predetermined amount of activity per unit acceleration.

In accordance with this configuration, the same advantage as the activity computing apparatus according to the above sixth aspect can be gotten.

In accordance with a thirteenth aspect of the present invention, a computer program enables a computer to perform the recording method according to the above seventh aspect. In accordance with this configuration, the same advantage as the portable recording apparatus according to the above first aspect can be gotten.

In accordance with a fourteenth aspect of the present invention, a computer program enables a computer to perform the information processing method according to the above eighth aspect. In accordance with this configuration, the same advantage as the information processing apparatus according to the above second aspect can be gotten.

In accordance with a fifteenth aspect of the present invention, a computer program enables a computer to perform the body motion measuring method according to the above ninth aspect. In accordance with this configuration, the same advantage as the body motion measuring apparatus according to the above third aspect can be gotten.

In accordance with a sixteenth aspect of the present invention, a computer program enables a computer to perform the information processing method according to the above tenth aspect. In accordance with this configuration, the same advantage as the information processing apparatus according to the above fourth aspect can be gotten.

In accordance with a seventeenth aspect of the present invention, a computer program enables a computer to perform the motion form determining method according to the above eleventh aspect. In accordance with this configuration, the same advantage as the motion form determining apparatus according to the above fifth aspect can be gotten.

In accordance with an eighteenth aspect of the present invention, a computer program enables a computer to perform the activity computing method according to the above twelfth aspect. In accordance with this configuration, the same advantage as the activity computing apparatus according to the above sixth aspect can be gotten.

In accordance with a nineteenth aspect of the present invention, a computer readable recording medium embodies the computer program according to the above thirteenth aspect. In accordance with this configuration, the same advantage as the portable recording apparatus according to the above first aspect can be gotten.

In accordance with a twentieth aspect of the present invention, a computer readable recording medium embodies the computer program according to the above fourteenth aspect. In accordance with this configuration, the same advantage as the information processing apparatus according to the above second aspect can be gotten.

In accordance with a twenty-first aspect of the present invention, a computer readable recording medium embodies the computer program according to the above fifteenth aspect. In accordance with this configuration, the same advantage as the body motion measuring apparatus according to the above third aspect can be gotten.

In accordance with a twenty-second aspect of the present invention, a computer readable recording medium embodies the computer program according to the above sixteenth aspect. In accordance with this configuration, the same advantage as the information processing apparatus according to the above fourth aspect can be gotten.

In accordance with a twenty-third aspect of the present invention, a computer readable recording medium embodies the computer program according to the above seventeenth aspect. In accordance with this configuration, the same advantage as the motion form determining apparatus according to the above fifth aspect can be gotten.

In accordance with a twenty-fourth aspect of the present invention, a computer readable recording medium embodies the computer program according to the above eighteenth aspect. In accordance with this configuration, the same advantage as the activity computing apparatus according to the above sixth aspect can be gotten.

In the present specification and claims, the recording mediums include, for example, a flexible disk, a hard disk, a magnetic tape, a magneto-optical disk, a CD (including CD-ROM, Video-CD), a DVD (including DVD-Video, DVD-ROM, DVD-RAM), a ROM cartridge, a RAM memory cartridge with a battery backup unit, a flash memory cartridge, a nonvolatile RAM cartridge, and so on.

### BRIEF DESCRIPTION OF DRAWINGS

The novel features of the present invention are set forth in the appended any one of claims. The invention itself, however, as well as other features and advantages thereof, will be best understood by reference to the detailed description of specific embodiments which follows, when read in conjunction with the accompanying drawings, wherein:

FIG. 1 is a view showing the entire configuration of an exercise supporting system in accordance with a first embodiment of the present invention.

FIG. 2 is a view showing a mounted state of an action sensor 11 of FIG. 1.

FIG. 3 is a view showing the electric configuration of the exercise supporting system of FIG. 1.

FIG. 4 is an explanatory view showing a method for identifying motion form by a pedometer 31 of FIG. 3.

FIG. 5 is a view showing transition of processing by a processor 13 of FIG. 3.

FIG. 6 is a view showing an example of an exercise start screen.

FIG. 7 is a view showing an example of a stretch screen.

FIG. 8 is a view showing an example of a circuit screen.

FIG. 9 is a view showing an example of a step exercise screen.

FIG. 10 is a view showing another example of the step exercise screen.

FIG. 11 is a view showing further another example of the step exercise screen.

FIG. 12 is a view showing an example of a train exercise screen.

FIG. 13 is a view showing another example of the train exercise screen.

FIG. 14 is an explanatory view showing a method for identifying body motion by the processor 13 of FIG. 3.

FIG. 15 is a view showing an example of a maze exercise screen.

FIG. 16 is a view showing an example of a map screen.

FIG. 17 is a view showing an example of a ring exercise screen.

FIG. 18 is a view showing another example of the ring exercise screen.

FIG. 19 is a view showing the entire configuration of an exercise supporting system in accordance with a second embodiment of the present invention.

FIG. 20 is a view showing the electric configuration of the exercise supporting system of FIG. 19.

FIG. 21 is a flow chart showing a process for measuring motion form, which is performed by an MCU 52 of an action sensor 6 of FIG. 20.

FIG. 22 is a flow chart showing a former part of a process for detecting one step, which is performed in step S1007 of FIG. 21.

FIG. 23 is a flow chart showing a latter part of the process for detecting one step, which is performed in step S1007 of FIG. 21.

FIG. 24 is a flow chart showing a process for acquiring acceleration data, which is performed in step S1033 of FIG. 22.

FIG. 25 is an explanatory view showing a method for determining motion form, which is performed in step S1011 of FIG. 21.

FIG. 26 is a flow chart showing the process for determining the motion form, which is performed in step S1011 of FIG. 21.

FIG. 27 is a flow chart showing the process for determining motion form within an indetermination period, which is performed in step S1145 of FIG. 26.

FIG. 28 is a flowchart showing the overall process flow by a processor 13 of a cartridge 4 of FIG. 20.

FIG. 29 is a view showing the communication procedure among the processor 13 of the cartridge 4, an MCU 48 of an antenna unit 24, and the MCU 52 of the action sensor 6, which is performed in logging in step S100 of FIG. 28.

FIG. 30 is a flow chart showing a process for setting a clock in step S2017 of FIG. 29.

FIG. 31 is a flow chart showing a process of a stretch & circuit mode, which is performed in an exercise process of step S109 of FIG. 28.

FIG. 32 is a flow chart showing a stretch process, which is performed in step S130 of FIG. 31.

FIG. 33 is a flow chart showing a circuit process, which is performed in step S132 of FIG. 31.

FIG. 34 is a flow chart showing a process for identifying body motion (a first body motion pattern), which is started in step S176 of FIG. 33.

FIG. 35 is a flow chart showing a former part of a process for identifying body motion (a second body motion pattern), which is started in step S176 of FIG. 33.

FIG. 36 is a flow chart showing a latter part of a process for identifying the body motion (the second body motion pattern), which is started in step S176 of FIG. 33.

FIG. 37 is a flow chart showing a former part of a process for identifying body motion (a fifth body motion pattern), which is started in step S176 of FIG. 33.

FIG. 38 is a flow chart showing a mid part of the process for identifying the body motion (the fifth body motion pattern), which is started in step S176 of FIG. 33.

FIG. 39 is a flow chart showing a latter part of the process for identifying the body motion (the fifth body motion pattern), which is started in step S176 of FIG. 33.

FIG. 40 is a flowchart showing a step exercise process, which is performed in an exercise process of step S109 of FIG. 28.

FIG. 41 is a flow chart showing a train exercise process, which is performed in the exercise process of step S109 of FIG. 28.

FIG. 42 is a flow chart showing a process for setting a user flag, which is performed in step S448 of FIG. 41.

FIG. 43 is a flow chart showing a process for setting a velocity Vt of a trainer character 43, which is performed in step S436 of FIG. 41.

FIG. 44 is a flow chart showing a process for setting a moving velocity Vp of a user 9, which is performed in step S440 of FIG. 41.

FIG. 45 is a flowchart showing a maze exercise process, which is performed in the exercise process of step S109 of FIG. 28.

FIG. 46 is a flowchart showing a ring exercise process, which is performed in the exercise process of step S109 of FIG. 28.

FIG. 47 is a flow chart showing a process for computing a position of a player character 78, which is performed in step S598 of FIG. 46.

FIG. 48 is a flow chart showing a process for computing amount of activity, which is performed in step S615 of FIG. 46.

FIG. 49 is a flow chart showing a process for measuring motion form, which is performed by the processor 13 of the cartridge 4 of FIG. 20.

FIG. 50 is a flow chart showing a process for determining motion form, which is performed in step S787 of FIG. 49.

FIG. 51 is a flow chart showing a process for displaying a remaining battery level, which is performed by the processor 13 of the cartridge 4 of FIG. 20.

FIG. 52 is a flow chart showing a process for displaying state of communication, which is performed by the processor 13 of the cartridge 4 of FIG. 20.

FIG. 53 is a view showing an example of a screen for amending a weight-loss program.

FIG. 54 is a view showing an example of a menu screen.

FIG. 55 is a view showing an example of a screen for indicating an achievement rate of reduction.

FIG. 56 is a view showing an example of a tendency graph screen.

FIG. 57 is a view showing an example of a transition screen including a display for one week.

FIG. 58 is a view showing an example of a vital sign screen.

FIG. 59 is a flow chart showing a process in a manual recording mode of an action sensor 6 in accordance with a third embodiment of the present invention.

FIG. 60 is a flow chart showing a process in an automatic recording mode of the action sensor 6 in accordance with the third embodiment of the present invention.

### EXPLANATION OF REFERENCES

1 . . . adapter, 3, 4 . . . cartridge, 5 . . . television monitor, 6, 11 . . . action sensor, 13 . . . processor, 15 . . . external memory, 19, 27, 44 . . . EEPROM, 21, 23 . . . RF module, 24 . . . antenna unit, 29 . . . acceleration sensor, 31 . . . pedometer, 17, 25, 48, 52 . . . MCU, 35 . . . LCD, 20, 37, 50 . . . switch section, 33 . . . LCD driver, 42 . . . USB controller, and 56 . . . RTC.

### BEST MODE FOR CARRYING OUT THE INVENTION

In what follows, several embodiments of the present invention will be explained in detail with reference to the accompanying drawings. Meanwhile, like references indicate the same or functionally similar elements throughout the respective drawings, and therefore redundant explanation is not repeated.

In the present embodiments, virtual space where a player character, a trainer character, and so on are placed is displayed on a television monitor. However, a display device is not limited to the television monitor 5, and therefore various types of display devices may be employed.

### First Embodiment

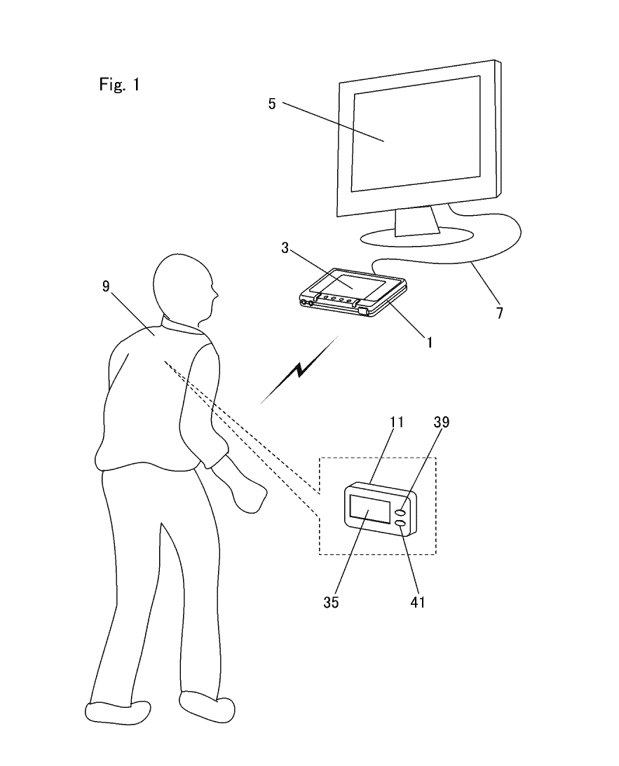

FIG. 1 is a view showing the entire configuration of an exercise supporting system in accordance with the first embodiment of the present invention. Referring to FIG. 1, the exercise supporting system includes an adapter 1, a cartridge 3, an action sensor 11, and a television monitor 5. The cartridge 3 is inserted into the adapter 1. Also, the adapter 1 is coupled with the television monitor 5 by an AV cable 7. Accordingly, a video signal VD and an audio signal AU generated by the cartridge 3 is supplied to the television monitor 5 by the adapter 1 and the AV cable 7.

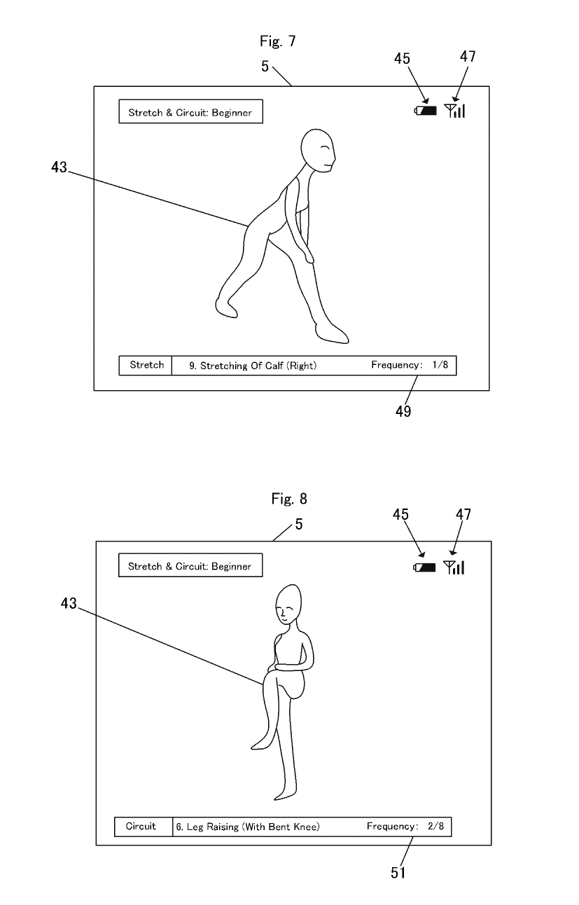

The action sensor 11 is mounted on a torso or a head region of a user 9. The torso represents a body of the user except a head, a neck, and arms and legs. The head region represents a head and a neck. The action sensor 11 is provided with an LCD (Liquid Crystal Display) 35, a mode switching button 39, and a display switching button 41. The mode switching button 39 switches between a pedometer mode and a communication mode. The pedometer mode is a mode in which the action sensor 11 is used alone and the number of steps of the user 9 is measured. The communication mode is a mode in which the action sensor 11 and the cartridge 3 communicate with each other and function in cooperation with each other, and moreover the action sensor 11 is used as an input device to the cartridge 3. For example, the action sensor 11 is entered the communication mode, and the user 9 exercises while looking at the respective various screens (of FIGS. 7 to 13, and FIGS. 15 to 18 as described below) displayed on the television monitor 5.

The LCD 35 displays the measured result of the number of steps and time in the pedometer mode, displays time in the communication mode, and displays switching setting information of the action sensor 11. The display switching button 41 is a button for switching information to be displayed on the LCD 35.

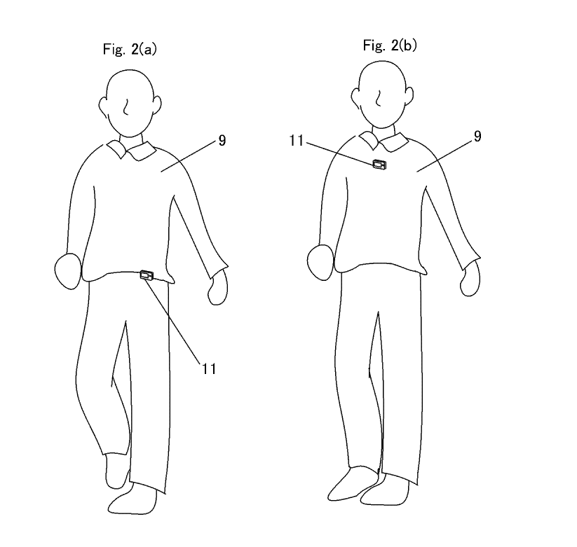

In the pedometer mode, for example, as shown in FIG. 2(a), the user 9 wears the action sensor 11 on a roughly position of the waist. In the communication mode, when the exercise is performed while looking at the television monitor 5, for example, as shown in FIG. 2(b), the user 9 wears the action sensor 11 on roughly position of the center of the chest. Needless to say, in each case, it may be worn on any portion of the torso or head region.

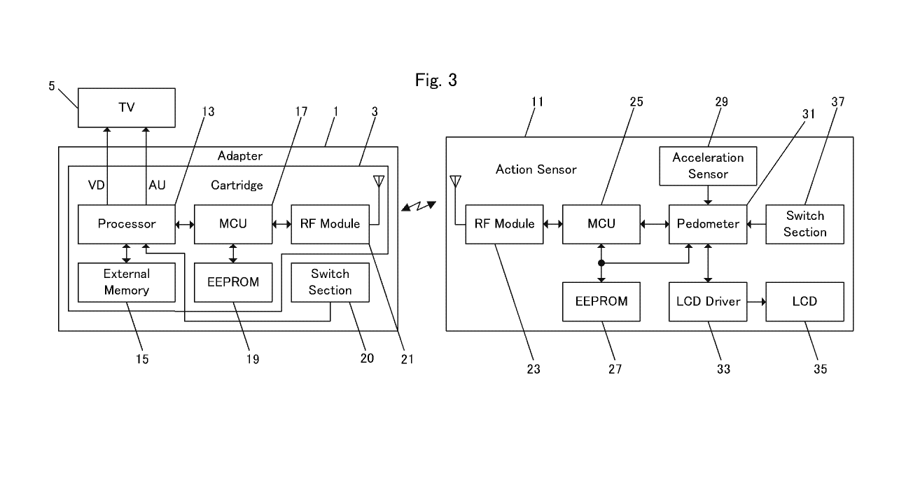

FIG. 3 is a view showing the electric configuration of the exercise supporting system of FIG. 1. Referring to FIG. 3, the action sensor 11 of the exercise supporting system is provided with an RF (Radio Frequency) module 23, an MCU (Micro Controller Unit) 25, an EEPROM (Electrically Erasable Programmable Read Only Memory) 27, an acceleration sensor 29, a pedometer 31, an LCD driver 33, the LCD 35, and a switch section 37. The cartridge 3 which is inserted into the adapter 1 is provided with a processor 13, an external memory 15, an MCU 17, an RF module 21, and an EEPROM 19. The EEPROMs 19 and 27 store information required to communicate between the RF modules 21 and 23. The adapter 1 is provided with a switch section 20 which inputs manipulation signals to the processor 13. The switch section 20 includes a cancel key, an enter key, and arrow keys (up, down, right, and left).

The acceleration sensor 29 of the action sensor 11 detects accelerations in the respective direction of the three axes (x, y, z) which are at right angles to one another.

In the pedometer mode, the pedometer 31 counts the number of steps of the user 9 on the basis of the acceleration data from the acceleration sensor 29, stores data of the number of steps in the EEPROM 27, and sends data of the number of steps to the LCD driver 33. The LCD driver 33 displays the received data of the number of steps on the LCD 35.

On the other hand, in the communication mode, the pedometer 31 instructs the MCU 25 to transmit acceleration data from the acceleration sensor 29, state of the switch section 37, and data vo indicating output voltage (battery voltage) of a battery (not shown in the figure). In response to the transmission instruction from the MCU 25, the RF module 23 modulates the acceleration data, the state of the switch section 37, and the output voltage data vo, and transmits them to the RF module 23 of the cartridge 3. Incidentally, the data of the number of steps as stored in the EEPROM 27 in the pedometer mode is transmitted from the action sensor 11 to the cartridge 3 at the time of the first communication.

The LCD driver 33 is provided with an RTC (Real Time Clock), and displays time information by giving the time information to the LCD 35. The switch section 37 includes the mode switching button 39 and the display switching button 41. The pedometer 31 controls the LCD driver 33 in response to the manipulation of the display switching button 41 to switch between the displays of the LCD 35. Also, the pedometer 31 switches between the modes (the pedometer mode and the communication mode) in response to the manipulation of the mode switching button 39.

Incidentally, in the present embodiment, the action sensor 11 is mounted on the user so that a horizontal direction of the user 9 becomes parallel to an x axis of the acceleration sensor 29 (the left direction in the viewpoint of the user 9 is positive), a vertical direction of the user 9 becomes parallel to a y axis of the acceleration sensor 29 (the upper direction in the view of the user 9 is positive), and a front-back direction of the user 9 becomes parallel to a z axis (the front direction in the view of the user 9 is positive).

By the way, the processor 13 of the cartridge 3 is connected with the external memory 15. The external memory 15 is provided with a ROM, a RAM, and/or a flash memory, and so on in accordance with the specification of the system. The external memory 15 includes a program area, an image data area, and an audio data area. The program area stores control programs (including an application program). The image data area stores all of the image data items which constitute the screens to be displayed on the television monitor 5. The audio data area stores audio data for generating music, voice, sound effect, and so on. The processor 13 executes the control programs in the program area, reads the image data in the image data area and the audio data in the audio data area, processes them, and generates a video signal VD and an audio signal AU.

Also, the processor 13 performs the control program and instructs the MCU 17 to communicate with the RF module 23 and acquire the data of the number of steps, the acceleration data, and the output voltage data vo. In response to the instruction from the MCU 17, the RF module 21 receives the data of the number of steps, the acceleration data, and the output voltage data vo from the RF module 23, demodulates them, and sends them to the MCU 17. The MCU 17 sends the data of the number of steps, the acceleration data, and the output voltage data vo as demodulated to the processor 13. The processor 13 computes the number of steps and amount of activity and identifies the motion form of the user 9 on the basis of the acceleration data from the action sensor 11 so as to display on the television monitor 5 in an exercise process in step S9 of FIG. 5 as described below. Also, the processor 13 displays a remaining battery level of the action sensor 11 on the television monitor 5 on the basis of the output voltage data vo as received. Incidentally, the cartridge 3 can communicate with the action sensor 11 only when the mode of the action sensor 11 is the communication mode. Because of this, the action sensor 11 functions as an input device to the processor 13 only in the communication mode.

Although not shown in the figure, the processor 13 is provided with a central processing unit (hereinafter referred to as the “CPU”), a graphics processing unit (hereinafter referred to as the “GPU”), a sound processing unit (hereinafter referred to as the “SPU”), a geometry engine (hereinafter referred to as the “GE”), an external interface block, a main RAM, an A/D converter (hereinafter referred to as the “ADC”) and so forth.

The CPU performs various operations and controls the entire system by executing the programs stored in the external memory 15. The CPU performs the process relating to graphics operations, which are performed by running the program stored in the external memory 15, such as the calculation of the parameters required for the expansion, reduction, rotation and/or parallel displacement of the respective objects and the calculation of eye coordinates (camera coordinates) and view vector. In this description, the term “object” is used to indicate a unit which is composed of one or more polygons or sprites and to which expansion, reduction, rotation and parallel displacement transformations are applied in an integral manner. For example, a trainer character 43 and a player character 78 as described below are a type of the object.

The GPU serves to generate a three-dimensional image composed of polygons and sprites on a real time base, and converts it into the analog composite video signal VD. The SPU generates PCM (pulse code modulation) wave data, amplitude data, and main volume data, and generates the analog audio signal AU from them by analog multiplication. The GE performs geometry operations for displaying a three-dimensional image. Specifically, the GE executes arithmetic operations such as matrix multiplications, vector affine transformations, vector orthogonal transformations, perspective projection transformations, the calculations of vertex brightnesses/polygon brightnesses (vector inner products), and polygon back face culling processes (vector cross products).

The external interface block is an interface with peripheral devices (the MCU 17 and the switching section in the case of the present embodiment) and includes programmable digital input/output (I/O) ports of 24 channels. The ADC is connected to analog input ports of 4 channels and serves to convert an analog signal, which is input from an analog input device through the analog input port, into a digital signal. The main RAM is used by the CPU as a work area, a variable storing area, a virtual memory system management area and so forth.

Incidentally, in the present embodiment, a unit “MET” is used as a unit for representing intensity of body activity, and a unit “Ekusasaizu (Ex)” is used as a unit representing amount of body activity. A unit “MET” is a unit which represents intensity of body activity by how many times of intensity in a resting state intensity corresponds to, in which sitting in the resting state corresponds to 1 MET and average walking corresponds to 3 METs. A unit “Ekusasaizu (Ex)” is obtained by multiplying intensity of body activity (METs) by performance time of the body activity (hour). Incidentally, amount of body activity may be called amount of activity. In the present embodiment, a unit “Ekusasaizu (Ex)” is used as a unit of amount of activity unless otherwise specified.

By the way, Energy consumption may be used as another indication for representing amount of body activity. Energy consumption (kcal) is expressed by 1.05×Ekusasaizu (METs·hour)×Body weight(kg).

Next, a method for identifying the motion form by the pedometer 31 will be described. In the present embodiment, three types of motion forms (walking, slow running, and normal running) are identified.

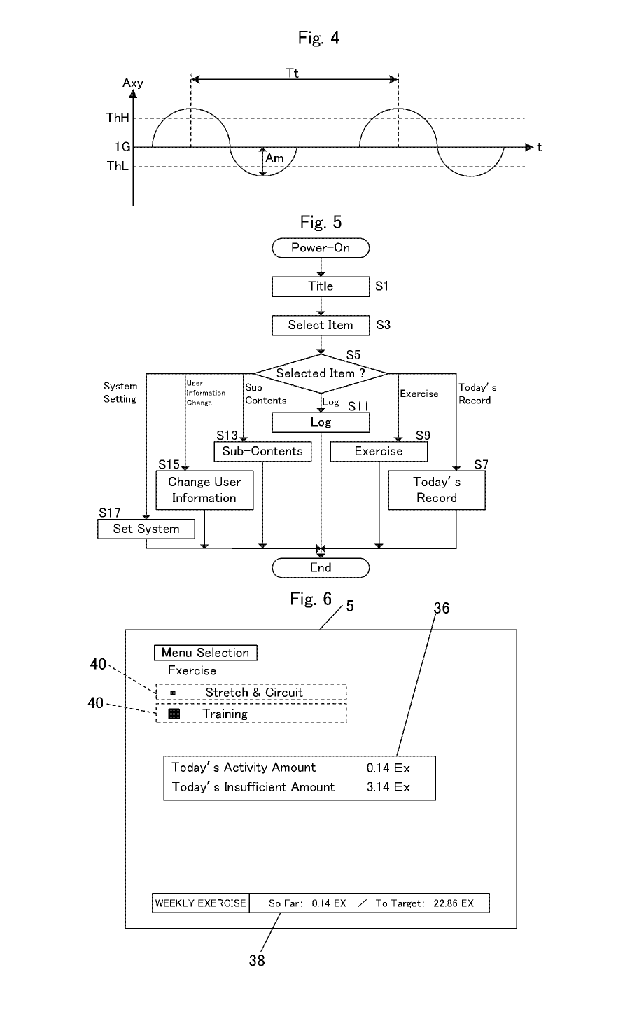

FIG. 4 is an explanatory view showing the method for identifying the motion form by the pedometer 31 of FIG. 3. Referring to FIG. 4, a vertical axis indicates resultant acceleration Axy(=\sqrt{ax²+ay²}) of acceleration ax in the direction of the x axis and acceleration ay in the direction of the y axis of the acceleration sensor 29, while a horizontal axis indicates time t. In the case where the user 9 stands still, since only gravity acceleration is detected, the resultant acceleration Axy is equal to 1G (9.8 m/s²).

In the case where the resultant acceleration Axy increases from 1G, exceeds a threshold value ThH, and subsequently drops below a threshold value ThL, the pedometer 31 determines whether or not an absolute Am value of a difference between 1G and the minimum value exceeds a predetermined value C1. It is determined that the user 9 runs slowly or normally if it exceeds the predetermined value C1, conversely it is determined that the user 9 walks if it is the predetermined value C1 or less.

Further, in the case where it is determined that the user runs slowly or normally, the pedometer 31 compares a time interval Tt between the successive maximum values of the resultant acceleration Axy with a predetermined value C2. It is determined that the user runs slowly if the time interval Tt exceeds the predetermined value C2, conversely it is determined that the user runs normally if it is the predetermined value C2 or less. The threshold values ThH and ThL, and the predetermined values C1 and C2 can be given empirically experimentally.

Also, the pedometer 31 counts the number of times of determining that the user walks (the number of steps), the number of times of determining that the user runs slowly (the number of steps), and the number of times of determining that the user runs normally (the number of steps). These are transmitted as the data of the number of steps to the cartridge 3.

The acceleration in the direction of the z axis is not taken into account because the following case may occur in the method for identifying the motion form as described here. That is, an waveform similar to an waveform indicating one step is detected at the beginning of the walking or the running, it may be therefore determined that it indicates one step, and moreover it is determined that the subsequent waveform indicating the primary one step is also one step. As the result, it may be erroneously determined that one step in the beginning of the walking or the running is two steps.

The processor 13 computes the amount (Ex) of the activity on the basis of the number of times of each of the three types of the motion forms (walking, slow running, and normal running). In this case, the amount of the activity corresponding to one step is preliminarily obtained for each motion form, and is multiplied by the number of times of the corresponding motion form, and thereby the amount of the activity of the motion form is obtained. Incidentally, the number of steps during one hour is estimated for each motion form, and the time corresponding to one step (unit is hour) is obtained for each motion form. And, the time corresponding to one step (unit is hour) is multiplied by the intensity (METs) of the corresponding motion form, and the result indicates the amount (Ex) of the activity corresponding to one step.

By the way, the processor 13 also identifies the three types of motion forms (walking, slow running, and normal running) in the same manner as the pedometer 31 on the basis of the acceleration data received from the action sensor 11. And, the amount (Ex) of the activity is calculated on the basis of the number of times of each of the three types of the motion forms (walking, slow running, and normal running). The calculation method is the same as the above mention.

FIG. 5 is a view showing transition of processing by the processor 13 of FIG. 3. Referring to FIG. 5, in step S1, the processor 13 displays a title screen on the television monitor 5. Next, in step S3, the processor 13 displays an item selection screen for selecting an item. The user manipulates the switch section 20 to select the intended item on the item selection screen by manipulating the switch section 20. In the present embodiment, the prepared items are an item “Today's record”, an item “Exercise”, an item “Log”, an item “Sub-contents”, an item “User information change”, and an item “System setting”.

In step S5, the process of the processor 13 proceeds to any one of steps S7, S9, S11, S13, S15, and S17 in accordance with the item as selected in step S3.

In step S7 after the item “Today's record” is selected, the processor 13 displays a record screen, which includes activity record and measurement record for today, on the television monitor 5. Specifically, the activity record includes the number of steps for today, amount (Ex) of activity for today, and calorie consumption (kcal) corresponding to the amount of the activity for today, and the number of steps until reaching the targeted number of steps in one day as set by the user.

The number of steps for today is the sum of data of the number of steps in the pedometer mode as received from the action sensor 11 and data of the number of steps as computed by the processor 13 on the basis of the acceleration received from the action sensor 11 in the communication mode. With regard to the amount of the activity for today, amount of activity as computed by the processor 13 on the basis of the data of the number of steps in the pedometer mode as received from the action sensor 11, amount of activity as computed by the processor 13 on the basis of the acceleration as received from the action sensor 11 in the communication mode, and the sum of them are displayed. The amount of the activity as computed on the basis of the data of the number of steps in the pedometer mode as received from the action sensor 11 is displayed for each motion form of the user 9 (walking, slow running, and normal running).

The measurement record includes body weight for today, an abdominal circumference, a systolic blood pressure, a diastolic blood pressure, and a cardiac rate, and weight until reaching a targeted body weight and length until reaching a targeted abdominal circumference, which are set by the user 9. The body weight for today, the abdominal circumference, the systolic blood pressure, the diastolic blood pressure, and the cardiac rate are input by the user 9.

Also, the amount of the activity for today and insufficient amount of activity until reaching targeted amount of activity in one week as set by the user 9 are displayed in juxtaposition.

In step S9 after the item “Exercise” is selected, the processor 9 performs the processing and the screen display for making the user 9 do exercise. More specific description is as follows.

The processor 13 displays an exercise start screen of FIG. 6 on the television monitor 5 just after the item “Exercise” is selected. The exercise start screen contains an activity amount displaying section 36. The activity amount displaying section 36 displays the amount of the activity as performed today by the user 9, and the insufficient amount of the activity relative to the targeted value for today. The amount of the activity for today is the sum of amount of activity for today computed by the processor 13 on the basis of the data of the number of steps in the pedometer mode as received from the action sensor 11, and amount of activity for today computed by the processor 13 on the basis of the acceleration as received from the action sensor 11 in the communication mode. The insufficient amount for today is a value obtained by computing targeted amount of activity for one day on the basis of the targeted amount of the activity for one week as set by the user 9 and subtracting the amount of the activity for today from the result of the computation. Also, the screen contains an area 38 in which the amount of the activity for today and the insufficient amount of the activity until reaching the targeted amount of the activity for one week as set by the user 9 are displayed in juxtaposition.

Further, the exercise start screen contains icons 40 for selecting modes. A stretch & circuit mode and a training mode are prepared as the modes. The user 9 selects the icon 40 corresponding to the intended mode by manipulating the switch section 20.

The stretch & circuit mode includes a stretch mode and a circuit mode. And, the stretch mode is set at the beginning and at the end, and the circuit mode is set therebetween.

In the stretch mode, the processor 13 displays a stretch screen of FIG. 7. The processor 13 displays animation on the screen, in which a trainer character 45 does stretching exercises. The user 9 looks at the motion of the trainer character 43, and does the stretching exercises which the trainer character 43 does. In the present embodiment, the trainer character 43 does eight types of stretching exercises. That is, these are “raising and lowering of shoulders (four times)”, “stretching and shrinking of a chest (four times)”, “forward bending in an oblique direction (two times for each of right and left)”, “stretching of a front side of a thigh (four times for each of right and left)”, “twisting of an upper body (two times for each of right and left)”, “rotating of an ankle (four times for each of right and left where two times of rotating in each time)”, “stretching of a calf (eight times for each of right and left)”, and “spreading legs (straddling) (two times for each of right and left)”.

Also, the processor 13 shows how many times a single motion of the stretching exercise has been performed on a frequency displaying section 49. In the example of FIG. 7, the trainer character 43 performs the “stretching of a calf”, and the frequency displaying section 49 displays how many times the trainer character 43 has performed the “stretching of a calf” in eight times in all.

Further, the processor 13 controls a gauge of a remaining battery level displaying section 45 on the basis of the output voltage vo of the battery of the action sensor 11. The gauge consists of three rectangular segments which is horizontally aligned and have the same length, and the processor 13 controls turning on/off of the rectangular segments on the basis of the output voltage vo of the battery of the action sensor 11. All of the rectangular segments are turned on when the output voltage vo of the battery is sufficient, and the rectangular segments are turned off in the order from the left as the output voltage vo of the battery decreases. The user 9 can get the remaining battery level of the action sensor 11 by looking at the remaining battery level displaying section 45.

Specifically, three threshold values v0, v1, and v2 are prepared. The relation thereof is v0>v1>v2. All of the rectangular segments are turned on if vo≧v0, the central rectangular segment and the rightmost rectangular segment are turned on if v0>vo≧v1, the rightmost rectangular segment is turned on if v1>vo≧v2, and all of the rectangular segments are turned off if vo<v2.

Further, the processor 13 displays a communication condition between the action sensor 11 and the cartridge 3 on a communication condition displaying section 47. The communication condition displaying section 47 includes three vertical bars which are horizontally arranged. The more rightwards each of the three bars is positioned, the longer the length thereof is. The processor 13 controls turning on/off of the bars in accordance with the communication condition between the action sensor 11 and the cartridge 3. The processor 13 turns on all of the bars if the communication condition is good, and turns off the bars in order from the right depending on the extent of the communication condition. The user 9 can get the communication condition by looking at the communication condition displaying section 47. More specific description is as follows.

The processor 13 determines whether or not the communication condition is good on the basis of the number of times of success and failure of the communication per second. Accordingly, the processor 13 counts the number of times of the success and failure of the communication for 1 second. That is, the value “1” is added to a count value Tc if the communication is successful while the value “1” is subtracted from the count value Tc if it is failed. Since the counting is performed every 1/60 second, the count value Tc is 60 if the all are successful while the count value Tc is 0 if the all are failed.

The processor 13 turns off all the bars if the communication is not carried out for 1 second or the communication is never successful during 1 second, i.e., if the count value Tc is 0. The processor 13 turns on all the bars if the communication error does not occur during 1 second, i.e., if the count value Tc is 60. If the count value Tc has a value other than these, the processor 13 controls turning on/off of the bars depending on the count value Tc. Specifically, the number N of bars to be turned on is represented by the count value Tc divided by twenty. Decimal fractions of Tc/20 are truncated. Accordingly, all of the three bars are turned on if Tc=60, the two bars at the left end and the center are turned on if 59≧Tc≧40, the one bar at the left end is turned on if 39≧Tc≧20, and all of the three bars are turned off if Tc<20.

By the way, in the circuit mode, the processor 13 displays a circuit screen of FIG. 8. The processor 13 displays animation on the screen, in which a trainer character 45 does circuit exercises. The user 9 looks at the motion of the trainer character 43, and does the circuit exercises which the trainer character 43 does. A beginner level (light muscle training) and an advanced level (little hard muscle training) are implemented. Also, in the present embodiment, the trainer character 43 does ten types of circuit exercises. That is, these are “on-the-spot stepping”, “side raising”, “side stepping”, “arm-leg-alternately stretching out”, “arms-leg-alternately stretching out”, “waltz stepping”, “leg raising (with a bent knee)”, “leg raising (with an extended knee)”, “cha-cha stepping”, and “squatting and calf raising”.

The “on-the-spot stepping” is the stepping on the spot without advancing. The “side raising” is an exercise in which both arms as put down are moved over a head while keeping the extended arms, and then both palms are in contact with each other over the head, standing up with the heels together. The “side stepping” is an exercise in which one foot is moved sideways and then the other foot is brought to the one foot, swinging arms. The “arm-leg-alternately stretching out” is an exercise in which one foot is pulled backward while the opposite arm is extended forward from a standing posture, and then the posture is returned to the standing posture again. The “arms-leg-alternately stretching out” is an exercise in which one foot is pulled backward while both arms are extended forward from a standing posture, and then the posture is returned to the standing posture again.

The “waltz stepping” is an exercise in which stepping is performed once again after the “side stepping”. The “leg raising (with a bent knee)” is an exercise in which thighs are alternately raised so that the thigh becomes horizontal. The “leg raising (with an extended knee)” is an exercise in which legs are alternately raised with an extended knee so that the leg becomes horizontal. The “cha-cha stepping” is an exercise in which stepping is performed further three times after the “side stepping”. The “squatting and calf raising” in which a body is lowered by bending knees from a standing posture, subsequently, stretching out is performed so that heels are raised, and thereby the posture is returned to an erected state.

In the beginner level, the trainer character 43 performs the “on-the-spot stepping (30 seconds)”, the “side raising (4 times)” without a load, the “side stepping (30 seconds)”, the “arm-leg-alternately stretching out (4 times for each of right and left)”, the “waltz stepping (30 seconds)”, the “leg raising (with a bent knee) (4 times for each of right and left)”, the “cha-cha stepping (30 seconds)”, and the “squatting and calf raising (¼)”. At a point of time when the trainer character 43 has performed all the circuit exercises of the beginner level, it is regarded that the user 9 has also performed all of these exercises, the amount of the activity of the user 9 at the time is regarded as 0.11 (Ex), and then is added to the amount of the activity for today.

In the advanced level, the trainer character 43 performs the “on-the-spot stepping (30 seconds)”, the “side raising (4 times)” with a load, the “side stepping (30 seconds)”, the “arms-leg-alternately stretching out (4 times for each of right and left)”, the “waltz stepping (30 seconds)”, the “leg raising (with an extended knee) (4 times for each of right and left)”, the “cha-cha stepping (30 seconds)”, and the “squatting and calf raising (½)”. At a point of time when the trainer character 43 has performed all the circuit exercises of the advanced level, it is regarded that the user 9 has also performed all of these exercises, the amount of the activity of the user 9 at the time is regarded as 0.14 (Ex), and then is added to the amount of the activity for today.

Incidentally, in the “squatting and calf raising (½)”, the body is more lowered than that of the “squatting and calf raising (¼)”.

Also, the processor 13 shows how many times a single motion of the circuit exercise has been performed on a frequency displaying section 51. In the example of FIG. 8, the trainer character 43 performs the “leg raising (with a bent knee)”, and the frequency displaying section 51 displays how many times the trainer character 43 has performed the “leg raising (with a bent knee)” in eight times in all.

It is determined in a following manner whether or not the user 9 has performed the motion instructed by the trainer character 43.

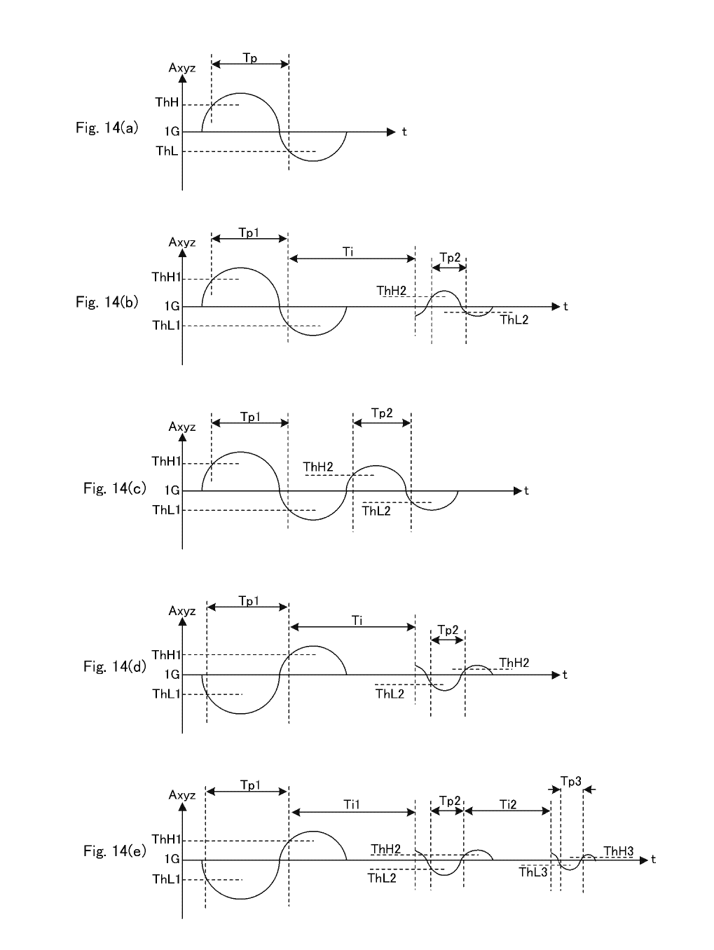

FIGS. 14(a) to 14(e) are explanatory views showing methods for identifying body motions by the processor 13 of FIG. 3. Referring to FIGS. 14(a) to 14(e), a vertical axis indicates resultant acceleration Axyz (=\sqrt{ax²+ay²+az²}) of acceleration ax in the direction of the x axis, acceleration ay in the direction of the y axis, acceleration az in the direction of the z axis of the acceleration sensor 29, while a horizontal axis indicates time t. The processor 13 determines whether or not the user has performed the motion instructed by the trainer character 43 on the basis of the resultant acceleration Axyz. Also, in the case where the user 9 stands still, since only gravity acceleration is detected, the resultant acceleration Axyz is equal to 1G.

Incidentally, the body motion patterns of FIGS. 14(a), 14(b), 14(c), 14(d) and 14(e) may be referred to as a first body motion pattern, a second body motion pattern, a third body motion pattern, a fourth body motion pattern, and a fifth body motion pattern respectively.

FIG. 14(a) shows schematically an wave form of the resultant acceleration Axyz which is generated in the case where the user 9 raises one foot as grounded, then lowers it, and thereby the one foot is landed. The processor 13 determines that the user 9 has performed the “on-the-spot stepping” in the case where the resultant acceleration Axyz exceeds a threshold value ThH by increasing from 1G, and subsequently drops below the threshold value ThL, and furthermore a time Tp from a point of time when it exceeds the threshold value ThH until a point of time when it drops below the threshold value ThL is within a predetermined range PD. Incidentally, the similar determination process is performed also with regard to the “leg raising (with a bent knee)” and the “leg raising (with a extended knee)”. However, the threshold values ThH and ThL, and the predetermined range PD differ therefrom. The threshold values ThH and ThL, and the predetermined range PD can be empirically given depending on the type of the motion.

Referring to FIG. 14(b), in the case where the resultant acceleration Axyz exceeds a threshold value ThH1 by increasing from 1G, and subsequently drops below the threshold value ThL1, and furthermore a time Tp1 from a point of time when it exceeds the threshold value ThH1 until a point of time when it drops below the threshold value ThL1 is within a predetermined range PD1, and furthermore in the case where it exceeds a threshold value ThH2 after a certain time T1 elapses from a point of time when it drops below the threshold value ThL1, and subsequently it drops below a threshold value ThL2, and furthermore a time Tp2 from a point of time when it exceeds the threshold value ThH2 until a point of time when it drops below the threshold value ThL2 is within a predetermined range PD2, the processor 13 determines that the user 9 has performed the “side raising”. The initial wave form (undulation) of the resultant acceleration Axyz is generated by a process in which the user 9 raises both hands over a head while the last wave form (undulation) is generated when the user 9 returns to the erected posture by lowering both the hands. The time Ti corresponds to a period in which the user 9 brings one palm into contact with the other palm over the head and keeps the condition, variation of the wave form occurs in the period, and therefore the determination process is not carried out. The threshold values ThH1, ThL1, ThH2, and ThL2, and the predetermined ranges PD1 and PD2 can be empirically given.

Referring to FIG. 14(c), in the case where the resultant acceleration Axyz exceeds a threshold value ThH1 by increasing from 1G, and subsequently drops below the threshold value ThL1, and furthermore a time Tp1 from a point of time when it exceeds the threshold value ThH1 until a point of time when it drops below the threshold value ThL1 is within a predetermined range PD1, and continuously in the case where it exceeds a threshold value ThH2, and subsequently it drops below a threshold value ThL2, and furthermore a time Tp2 from a point of time when it exceeds the threshold value ThH2 until a point of time when it drops below the threshold value ThL2 is within a predetermined range PD2, the processor 13 determines that the user 9 has performed the “side stepping”. The initial wave form (undulation) of the resultant acceleration Axyz is generated by a process in which the user 9 moves one leg sideways while the subsequent wave form (undulation) is generated when the user 9 draws the other leg.

The similar determination process is performed also with regard to the “waltz stepping” and the “cha-cha stepping”. However, the threshold values ThH1, ThL1, ThH2, and ThL2, and the predetermined ranges PD1 and PD2 differ therefrom. The threshold values ThH1, ThL1, ThH2, and ThL2, and the predetermined ranges PD1 and PD2 can be empirically given depending on the type of the motion. Also, with regard to the “waltz stepping” and the “cha-cha stepping”, the determination is not carried out during a certain time PD3 from when it drops below the threshold value ThL2. Because the additional one step and three steps have to been ignored. Since the exercises to be performed by the user 9 are preliminarily set in the circuit mode, such determination process causes no problem. Needles to say, the certain time PD3 differs between the “waltz stepping” and the “cha-cha stepping”.

Referring to FIG. 14(d), in the case where the resultant acceleration Axyz drops below a threshold value ThL1 by decreasing from 1G, and subsequently exceeds a threshold value ThH1, and furthermore a time Tp1 from a point of time when it drops below the threshold value ThL1 until a point of time when it exceeds the threshold value ThH1 is within a predetermined range PD1, and furthermore in the case where it drops below a threshold value ThL2 after a certain time Ti elapses from a point of time when it exceeds the threshold value ThH1, and subsequently it exceeds a threshold value ThH2, and furthermore a time Tp2 from a point of time when it drops below the threshold value ThL2 until a point of time when it exceeds the threshold value ThH2 is within a predetermined range PD2, the processor 13 determines that the user 9 has performed the “arm-leg-alternately stretching out”.

The initial wave form (undulation) of the resultant acceleration Axyz is generated by a process in which the user 9 pulls one leg backward while the last wave form (undulation) is generated when the user 9 returns to the erected posture by returning the one leg as pulled backward. The time Ti corresponds to a stationary state after the user 9 pulls the one leg backward, and a period for returning it to the initial position, variation of the wave form occurs in the period, and therefore the determination process is not carried out.

The similar determination process is performed also with regard to “arms-leg-alternately stretching out”. However, the threshold values ThH1, ThL1, ThH2, and ThL2, and the predetermined ranges PD1 and PD2 differ therefrom. The threshold values ThH1, ThL1, ThH2, and ThL2, and the predetermined ranges PD1 and PD2 can be empirically given depending on the type of the motion.

Referring to FIG. 14(e), in the case where the resultant acceleration Axyz drops below a threshold value ThL1 by decreasing from 1G, and subsequently exceeds a threshold value ThH1, and furthermore a time Tp1 from a point of time when it drops below the threshold value ThL1 until a point of time when it exceeds the threshold value ThH1 is within a predetermined range PD1, furthermore in the case where it drops below a threshold value ThL2 after a certain time Ti1 elapses from a point of time when it exceeds the threshold value ThH1, and subsequently it exceeds a threshold value ThH2, and furthermore a time Tp2 from a point of time when it drops below the threshold value ThL2 until a point of time when it exceeds the threshold value ThH2 is within a predetermined range PD2, and furthermore in the case where it drops below a threshold value ThL3 after a certain time Ti2 elapses from a point of time when it exceeds the threshold value ThH2, and subsequently it exceeds a threshold value ThH3, and furthermore a time Tp3 from a point of time when it drops below the threshold value ThL3 until a point of time when it exceeds the threshold value ThH3 is within a predetermined range PD3, the processor 13 determines that the user 9 has performed the “squatting and calf raising”.

The first wave form (undulation) of the resultant acceleration Axyz is generated by a process in which the user 9 lowers the body by bending the knees, the second wave form (undulation) is generated by a process in which the user 9 stretches out, and the third wave form (undulation) is generated when the heels of the user 9 land. The threshold values ThH1, ThL1, ThH2, ThL2, ThH3 and ThL3, and the predetermined ranges PD1, PD2 and PD3 can be empirically given.

As described above, the process does not identify what kind of exercise the user performs, but determines whether or not the user performs the instructed exercise. Accordingly, the resultant acceleration Axyz is preliminarily measured when an exercise to be instructed is performed, necessary conditions are set from among such a plurality of conditions as a threshold value, a time from when a threshold value is exceeded until when another threshold value is dropped below, a time from when a threshold value is dropped below until when another threshold value is exceeded, an elapsed time from a point of time when a threshold value is dropped below, an elapsed time from a point of time when a threshold value is exceeded, and it is determined that the user 9 performs the exercise if all the conditions as set are satisfied.

By the way, the training mode includes a “step exercise”, a “train exercise”, a “maze exercise”, and a “ring exercise”. In these exercises, the user 9 stands in front of the television monitor 5, and then does the stepping on the spot and so on.

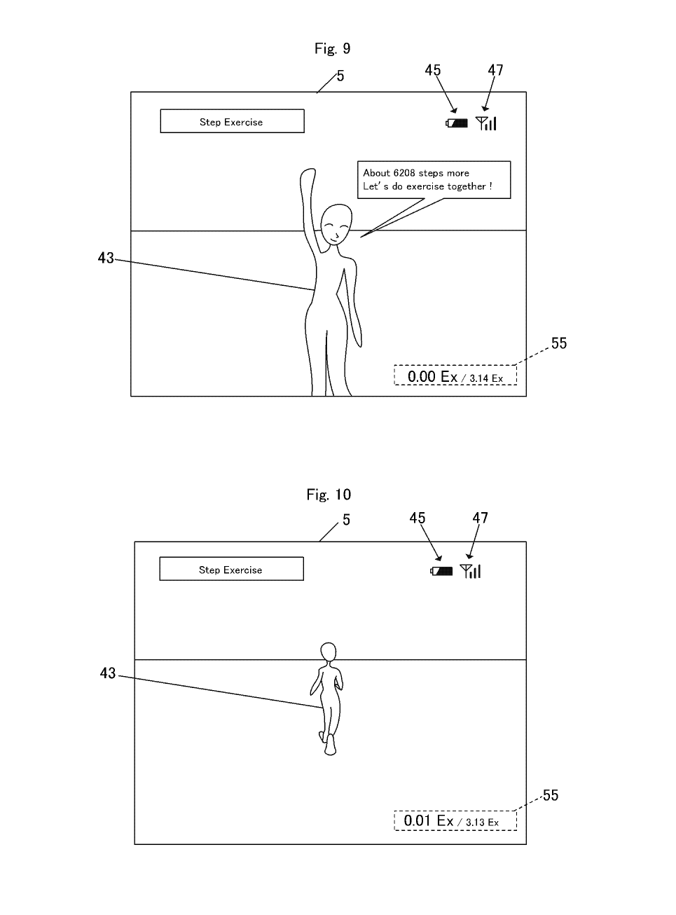

When the user 9 selects the “step exercise”, the processor 13 displays a step exercise screen of FIG. 9 on the television monitor 5. The screen contains a trainer character 43. The trainer character 43 indicates the number of steps which is required so as to expend insufficient amount of activity until reaching the targeted amount of activity for a day as obtained from the targeted amount of activity in one week as set by the user 9. Also, an activity amount displaying section 55 displays the amount of the activity in the “step exercise” in real time, and furthermore displays the insufficient amount of the activity relative to the targeted amount of the activity for a day. As described above, the amount of the activity which is displayed is computed on the basis of the number of times of each of the motion forms (walking, slow running, and normal running), and is a cumulative value in the “step exercise”.

Next, as shown in FIG. 10, the processor 13 runs the trainer character 43 with a constant velocity toward a depth of the screen, i.e., toward a depth of virtual space displayed on the television monitor 5. The user 9 does the stepping on the spot in accordance with such running of the trainer character 43.

The screen is expressed in first person viewpoint, and the video image therein changes as if the user 9 moved in the virtual space in response to the stepping of the user 9. In this case, the moving velocity of the user 9 in the virtual space is determined depending on the velocity of the stepping of the user 9.

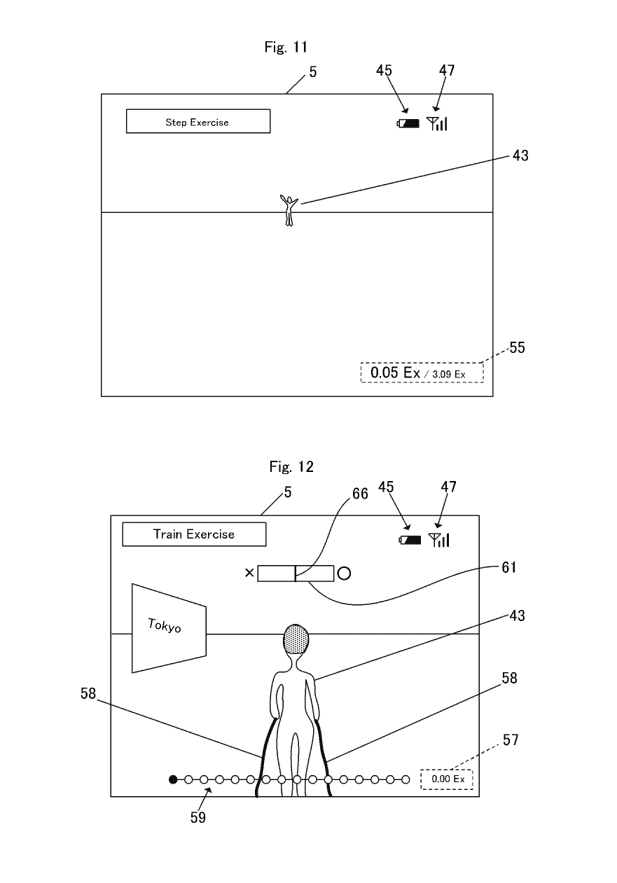

When a distance between a location of the user 9 in the virtual space and a location of the trainer character 43 becomes equal to a first predetermined distance D1, as shown in FIG. 11, the processor 13 stops and turns around the trainer character 43, and generates voice. Subsequently, when the distance between the location of the user 9 in the virtual space and the location of the trainer character 43 becomes equal to a second predetermined distance D1, the processor 13 runs the trainer character 43 again. The relation between the first predetermined distance and the second predetermined distance is D1>D2. The first predetermined distance D1 is determined from among a plurality of candidates in a random manner at a point of time when the trainer character 43 begins to run. The second predetermined distance is fixed.

The voice varies depending on a time from a point of time when the trainer character 43 begins to run until a point of time when the trainer character 43 stops. While the trainer character 43 stops only after the positional difference between the both sides becomes equal to the first predetermined distance D1, since the difference of the first predetermined distance D1 is not brought if the user 9 keeps up with the trainer character 43, it takes time to the stop of the trainer character. On the other hand, since the difference of the first predetermined distance D1 is brought relatively quickly if the user 9 does not keep up with the trainer character 43, the trainer character 43 stops relatively quickly. Therefore, as a time from a point of time when the trainer character 43 begins to run until a point of time when the trainer character 43 stops is longer, the voice represents better evaluation, while as it is shorter, the voice represents worse evaluation.

By the way, the “train exercise”, in which the predetermined number of virtual stations are passed through, simulates the so-called train play. When the user 9 selects the “train exercise”, as shown in FIG. 12, the processor 13 displays a train exercise screen including the trainer character 43 on the television monitor 5. The trainer character 43 advances toward the depth of the screen, i.e., toward the depth of the virtual space displayed on the television monitor 5 with a constant velocity (in the present embodiment, 40 kilometers per hour) while holding ropes 58 at the forefront. The ropes 58 are slack at the start. The user 9 does the stepping in accordance with such advance of the trainer character 43.

The screen is expressed in first person viewpoint, and the video image therein changes as if the user 9 moved in the virtual space in response to the stepping of the user 9. In this case, the moving velocity of the user 9 in the virtual space is determined depending on the velocity of the stepping of the user 9.

If a distance Dtp between a location of the trainer character 43 and a location of the user 9 in the virtual space is less than a predetermined value DL (=the distance when the ropes 58 are strained), and is more than a predetermined value DS (=the distance when the ropes 58 are slackest), a pointer 66 of a mood meter 61 keeps the position. In this case, the relation is DL>DS.

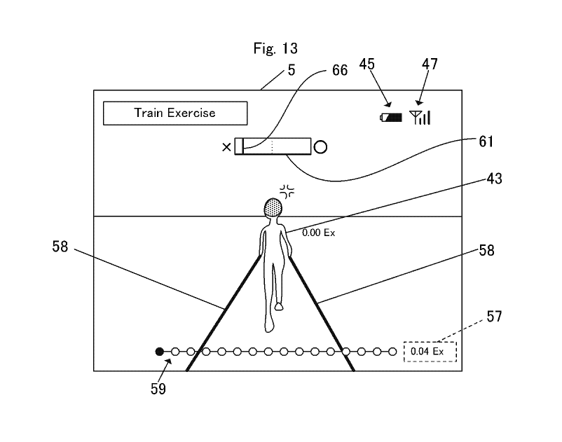

As shown in FIG. 13, when the distance Dtp becomes equal to the predetermined distance DL, the ropes 58 are strained, the pointer 66 of the mood meter 61 begins to move horizontally to the left, the trainer character 43 slows down, and an effect indicating a bad mood is displayed. And, the trainer character 43 stops after 1 second from when the pointer 66 reaches the left end, and thereby the game is over. On the other hand, when the distance Dtp becomes equal to the predetermined distance DS, the pointer 66 begins to move horizontally to the right, and an effect indicating a good mood is displayed. When a velocity of the user 9 is more than a predetermined value (in the present embodiment, 50 kilometers per hour) after the distance Dtp becomes equal to the predetermined distance DS, a speed of the trainer character 43 is increased depending on the velocity.

An activity amount displaying section 57 of the train exercise screen displays the amount of the activity of the user 9 in the “train exercise” in real time. As described above, the amount of the activity which is displayed is computed on the basis of the number of times of each of the motion forms (walking, slow running, and normal running), and is a cumulative value in the “train exercise”. An elapsed station displaying section 59 changes a white circle to a red circle each time the station is passed through.

Incidentally, it may be set so that the trainer character 43 does not run. That is, only the walking is set.

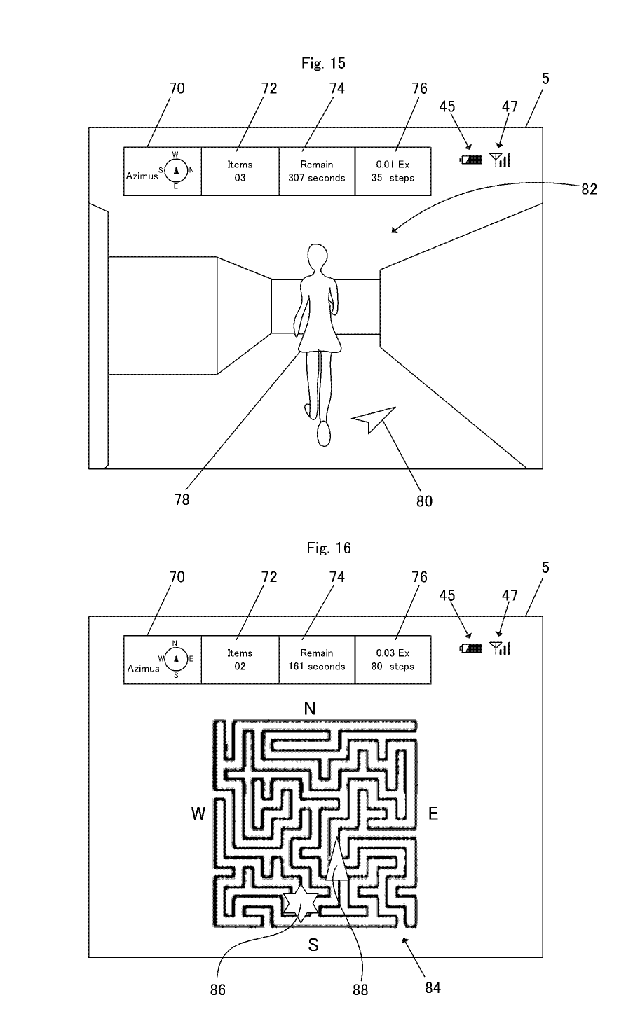

By the way, FIG. 15 is a view showing an example of amaze exercise screen. When the user 9 selects the “maze exercise”, the processor 13 displays the maze exercise screen as shown in FIG. 15 on the television monitor 5. The screen is expressed in third person viewpoint, and contains a player character 78 which responds to the motion of the user 9. The processor 13 identifies the three types of motion forms (walking, slow running, and normal running) in the same manner as the pedometer 31 on the basis of the acceleration data received from the action sensor 11. The processor 13 has an advance velocity of the player character 78 (v0, v1, and v2) for each of the three types of motion forms (walking, slow running, and normal running), determines the advance velocity of the player character 78 in accordance with the motion form as identified, and advances the player character 78 in amaze 82 in the virtual space.

Also, if the absolute value of the acceleration ax in the x-axis direction of the acceleration sensor 29 exceeds a certain value, the processor 13 rotates the player character 78 by 90 degrees leftward or rightward depending on a sign of the acceleration ax (change of course). Incidentally, when the user 9 twists a body thereof leftward or rightward so as to exceed a certain extent, the absolute value of the acceleration ax in the x-axis direction of the acceleration sensor 29 exceeds the certain value.

By the way, the processor 13 displays a mark 80 in the maze 82. The mark 80 indicates a direction of a goal. Also, the processor 13 displays an azimuth direction displaying section 70 for indicating an azimuth direction in which the player character 78 heads, an item number displaying section 72 for displaying the number of map items which the user 9 has, a time displaying section 74 for indicating a remaining time until a time limit, an activity displaying section 76 for indicating the total amount of activity and the total number of steps in the “maze exercise”, the remaining battery level displaying section 45, and the communication condition displaying section 47.

The predetermined number of the map items are given at the start of the “maze exercise”. However, the map item appears in the maze 82, and can be accordingly acquired by bringing the player character 78 into contact with the map item. In the case where the user 9 has the map item (s), when a mode switching button 39 is pushed, the processor 13 reduces one from the map item (s) which the user 9 has, and displays a map screen of FIG. 16. When the mode switching button 39 is pushed again in the screen, the map screen changes to the screen of the maze 82. The map screen contains overall construction 84 of the maze 82, a mark 86 for indicating a location of the goal, and an arrow 88 for indicating the present location of the player character 78. The direction of the arrow 88 indicates an azimuth direction in which the player character 78 heads.

Incidentally, since the time displaying section 74 continues to count also during the map screen is displayed, to reach the goal within the time limit, the user 9 can not look at the map screen unlimitedly.

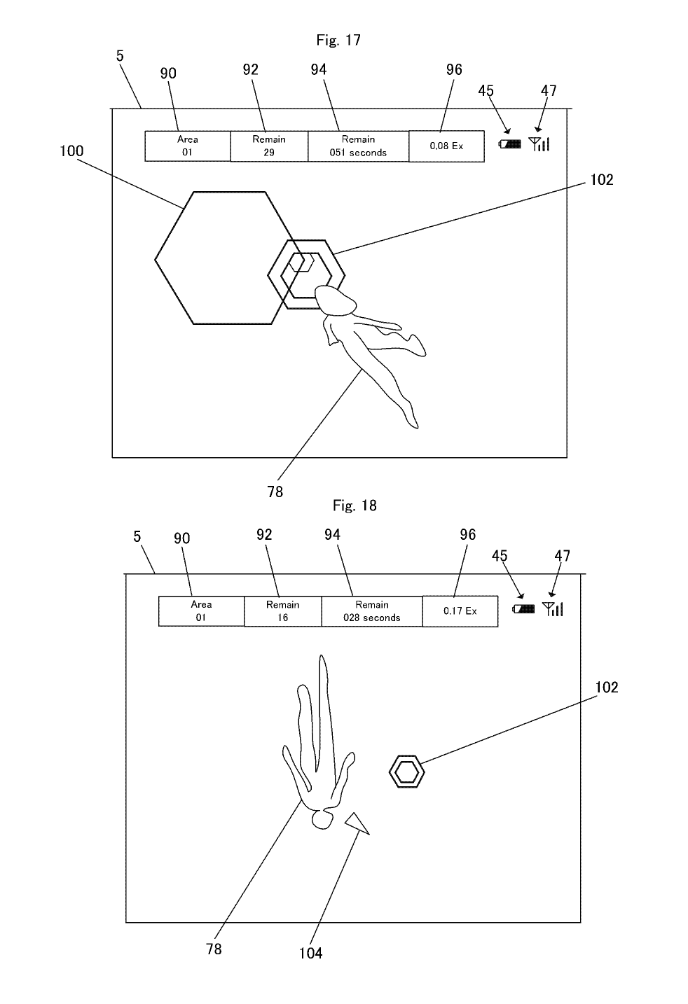

By the way, FIG. 17 is a view showing an example of a ring exercise screen. When the user 9 selects the “ring exercise”, the processor 13 displays the ring exercise screen of FIG. 17 on the television monitor 5. The screen is expressed in third person viewpoint, and contains the player character 78 which responds to the motion of the user 9. The player character 78 (representing a woman in the figure) swims toward the depth of the screen in water formed in the virtual space depending on the acceleration data from the action sensor 11. That is, the processor 13 computes a moving vector of the player character 78 (a speed and a direction of a movement) on the basis of the acceleration data received from the action sensor 11. More specific description is as follows.

Incidentally, a three-dimensional coordinate system in displaying objects such as the player character 78 on the television monitor 5 (being common in the present specification) will be described. An X-axis is parallel to the screen and extends in a horizontal direction, a Y-axis is parallel to the screen and extends in a direction perpendicular to the X axis, and a Z-axis extends in a direction perpendicular to the X-axis and Y-axis (in a direction perpendicular to the screen). A positive direction of the X-axis corresponds to a left direction toward the screen, a positive direction of the Y-axis corresponds to a lower direction toward the screen, and a positive direction of the Z-axis corresponds to a direction toward the depth of the screen.

First, a method for obtaining magnitude of the moving vector of the player character 78 will be described. The processor 13 adds the resultant acceleration Axyz of the acceleration ax in the direction of the x-axis, the acceleration ay in the direction of the y-axis, and the acceleration az in the direction of the z-axis to present magnitude of the moving vector of the player character 78 (i.e., speed), and uses the result of the addition as magnitude of the moving vector of the player character 78 to be next set (i.e., speed).

Accordingly, the user 9 controls the magnitude of the resultant acceleration Axyz by adjusting the motion of the body, and thereby controls the speed of the player character 78. For example, the user 9 can generate the acceleration (resultant acceleration Axyz) by carrying out squat exercise (motion of bending and extending knees quickly), and thereby increase the velocity of the player character 78. Incidentally, if the user 9 does not carry out such motion as the acceleration is generated, the player character 78 slows down, and then stops soon.

Next, a method for obtaining a direction of the moving vector of the player character 78 will be described. The processor 13 relates the acceleration az in the direction of the z-axis and the acceleration ax in the direction of the x-axis of the acceleration sensor 29 to a rotation about the X-axis and a rotation about the Y-axis of the player character 78 respectively. And, a unit vector (0, 0, 1) is rotated about the X-axis and Y-axis depending on the accelerations az and ax, and a direction of the unit vector after rotating is set to the direction of the moving vector of the player character 78.

Incidentally, in the case where the acceleration in the direction of the z-axis increases positively, the case means that the user 9 tilts the body forward (a forward tilt), and this direction corresponds to the downward direction of the player character 78 (the positive direction of the Y-axis) in the virtual space. In the case where the acceleration az in the direction of the z-axis increases negatively, the case means that the user 9 tilts the body backward (a backward tilt), and this direction corresponds to the upward direction of the player character 78 (the negative direction of the Y-axis) in the virtual space. That is, the vertical direction, i.e., the rotation about the X-axis of the player character 78 in the virtual space is determined by the direction and the magnitude of the acceleration az in the direction of the z-axis of the acceleration sensor.

Also, in the case where the acceleration ax in the direction of the x-axis increases positively, the case means that the user 9 tilts the body leftward, and this direction corresponds to the leftward direction of the player character 78 (the positive direction of the X-axis) in the virtual space. In the case where the acceleration ax in the direction of the x-axis increases negatively, the case means that the user 9 tilts the body rightward, and this direction corresponds to the rightward direction of the player character 78 (the negative direction of the X-axis) in the virtual space. That is, the horizontal direction, i.e., the rotation about the Y-axis of the player character 78 in the virtual space is determined by the direction and the magnitude of the acceleration ax in the direction of the x-axis of the acceleration sensor.

Accordingly, the user 9 can set the moving direction of the player character 78 to the downward direction, the upward direction, the leftward direction, or the rightward direction by moving the body in the forward direction, the backward direction, the leftward direction, or the rightward direction.

By the way, the processor 13 arranges and displays a plurality of target rings 102 in the direction of the Z-axis of the screen. The user 9 moves the body to control the player character 78 so that the player character 78 passes through the target ring 102. Also, the processor 13 displays a guide ring 100 similar to the target ring 102 so as to guide the controlling of the player character 78. The X and Y coordinates of the guide ring 100 are the same as the X and Y coordinate of the target ring 102. Also, the Z coordinate of the guide ring 100 is the same as the Z coordinate of the top of the head of the player character 78. Accordingly, if the controlling is carried out so that the player character 78 enters the guide ring 100, the player character 78 can pass through the target ring 102.

Also, the processor 13 displays an area displaying section 90 for indicating an area where the player character 78 is currently located, a ring number displaying section 92 for indicating the number of the remaining target rings, a time displaying section 94 for indicating a remaining time until a time limit, an activity displaying section 96 for indicating the total amount of activity in the “ring exercise”, the remaining battery level displaying section 45, and the communication condition displaying section 47.

Incidentally, one stage consists of a plurality of the areas, and a plurality of the target rings 102 are arranged in each area. In this case, a plurality of arrangement patterns each of which consists of a set of a plurality of the target rings 102 are prepared preliminarily. The one area is configured with the one arrangement pattern as selected in a random manner from among the plurality of the arrangement patterns.

Also, referring to FIG. 18, the processor 13 displays a mark 104 for indicating the direction of the target ring 10 to be next passed through if the position of the player character 78 is deviated and thereby the guide ring 100 is located outside a display range (the screen). If the player character 78 is controlled in accordance with the mark 104, the guide ring 100 can be viewed. Incidentally, the target ring 102 shown in FIG. 18 is not the target ring 102 to be next passed through.

Returning to FIG. 5, in step S11 after selecting the item “Log”, the processor 13 selectively displays one of movement of amount of activity, movement of a vital sign, and a record. With regard to the movement of the amount of the activity, one of the movement for 24 hours, the movement for one week, and the movement for one month is selectively displayed using a bar graph in accordance with the manipulation of the switch section 20 by the user 9. In this case, the amount of the activity computed by the processor 13 on the basis of the data of the number of steps in the pedometer mode received from the action sensor 11, and the amount of the activity computed by the processor 13 on the basis of the acceleration received from the action sensor 11 in the communication mode are displayed in separate colors. Further, the amount of the activity as computed on the basis of the data of the number of steps received from the action sensor 11 is displayed in separate colors for each motion form of the user 9 (walking, slow running, and normal running). With regard to the movement of the vital sign, one of body weight for one month, an abdominal circumference for one month, and blood pressure for one month is selectively displayed using a bar graph in accordance with the manipulation of the switch section 20 by the user 9. The record includes the activity record and the measurement record for a day as selected by the user 9.

In step S13 after selecting the item “Sub-contents”, the processor 13 selectively performs one of measurement of a cardiac rate, measurement of leg strength (an air sit test), measurement of physical strength, a physical strength age test, and brain training in accordance with the manipulation of the switch section 20 by the user 9. These are all performed using the action sensor 11.

In the measurement of the cardiac rate, the processor 13 displays an instruction “Push the button of the action sensor after being ready. The signal to begin the measurement is given after a period of time, so count the pulse by 10 beats and then push the button again.”, and text for instructing the how for measuring a pulse on the television monitor 5. And, when it is detected that the mode switching button 39 of the action sensor 39 is pushed, the processor 13 displays the signal to begin the measurement on the television monitor 5, and begins measuring time. When the user 9 finishes measuring the pulse by 10 beats and it is detected that the mode switching button 39 is pushed, the processor 13 finishes measuring the time. Then, the processor 13 computes the cardiac rate on the basis of the time as measured and displays it.

In the measurement of the leg strength, the processor 13 displays an instruction “Push the button of the action sensor after being ready.”, and text for instructing on the television monitor 5. The text for instructing includes instructions “1. Spread the legs shoulder-width apart, and direct outward the toes.”, “2. Hold the action sensor, and extend the arms forward.”, and “3. Incline the upper body frontward a little, and bend the knees about 90 degrees.” The user 9 assumes the position in accordance with the text for instructing (such a posture as if sitting in a chair despite of the absence of the chair), and then pushes the mode switching button 39. When it is detected that the mode switching button 39 of the action sensor 11 is pushed, the processor 13 displays display of “in the measurement”, and an instruction “When you can not keep the current posture, push the button of the action sensor.” At the same time, the processor 13 begins measuring time. And, when it is detected that the user 9 pushes the mode switching button 39 again, the processor 13 finishes measuring the time, and displays the measurement result (the measured time) and comment. It is indicated that the longer the measured time is, the longer the above posture is kept, and it indicates that the leg strength is stronger.

In step S15 after selecting the item “User information change”, the processor 13 selectively performs one of change of basic information, change of detailed information, and change of a target in accordance with the manipulation of the switch section 20 by the user 9. The basic information includes a name, ID, sex, and an age. The detailed information includes a height, body weight, an abdominal circumference, a stride, life intensity, BMI, a systolic blood pressure, a diastolic blood pressure, a cardiac rate, neutral fat, HDL, and a blood glucose value. The target includes a weight loss for each month, a decrease of an abdominal circumference for each month, the number of steps for a day, and amount of activity for a week.

In step S17 after selecting the item “System setting”, the processor 13 selectively performs one of setting of a clock and initial setting in accordance with the manipulation of the switch section 20 by the user 9.

By the way, as described above, the action sensor 11 according to the present embodiment detects physical quantity (the acceleration in the above example) in accordance with the motion of the user 9 in the three-dimensional space, and therefore can display information (the number of steps in the above example) based on the detected physical quantity on the LCD 35 as equipped therewith. Therefore, the action sensor 11 also functions as a stand-alone device (functions as a pedometer in the above example). That is, in the pedometer mode, it does not communicate with an external device (the cartridge 3 in the above example), and singly functions independently of the external device. In addition to this function, in the communication mode, it is possible to input information (the acceleration in the above example) relating to physical quantity as detected to an external device (the cartridge 3 in the above example) in real time, and provide the user 9 with various contents (representatively, the stretching exercise, the circuit exercise, the step exercise, the train exercise, the maze exercise, the ring exercise, and so on) using the images (representatively, FIGS. 7 to 13, FIGS. 15 to 18, and so on) in cooperation with the external device.

In this case, the processor 13 of the cartridge 3 may control an image (representatively, FIGS. 15 to 18, and so on) on the basis of the information (the acceleration in the above example) relating to the physical quantity as received from the action sensor 11, or may also process the information relating to the physical quantity as received from the action sensor 11 in association with an image (representatively, FIGS. 7 to 13, and so on) which the processor 13 of the cartridge 3 controls without depending on the information relating to the physical quantity.

Also, the user 9 can also do exercise (walking or running) carrying only the action sensor 11 in the pedometer mode. On the other hand, in the communication mode, the user 9 can input physical quantity (the acceleration in the above example) depending on the motion to an external device (the cartridge 3 in the above example) in real time by moving the body. That is, the action for inputting to the external device corresponds to an exercise in itself. In this case, the external device provides the user 9 with the various contents (representatively, the stretching exercise, the circuit exercise, the step exercise, the train exercise, the maze exercise, the ring exercise, and so on) using the images (representatively, FIGS. 7 to 13, FIGS. 15 to 18, and so on) in accordance with the input from the user 9. Accordingly, instead of moving the body excursively, the user 9 can do exercise while enjoying these contents.

As the result, while the exercise is done carrying only the action sensor 11 in the pedometer mode, it is possible to supplement the insufficient exercise therein with the action sensor 11 and the external device (the cartridge 3 in the above example) using the communication mode. Also, the opposite is true. In this way, it is possible to more effectively support attainment of a goal of the exercise by doing exercise in two stages.

By the way, generally, various exercises such as a stretching exercise and a circuit exercise have a goal, and it is required to adequately perform specified motion so as to effectively attain the goal. In this case, while an instruction indicates the motion by an image and so on, it is difficult for the user himself or herself to judge whether or not the user adequately performs the instructed motion.

However, in accordance with the present embodiment, it is possible to judge whether or not the user 9 performs the motion as instructed by the image, and therefore it is possible to show the result of the judgment to the user (representatively, the circuit exercise of FIG. 8). For this reason, the user 9 can correct his/her motion by looking at the result, and adequately perform the instructed exercise. As the result, the user 9 can effectively attain the goal of the instructed exercise.

Also, in accordance with the present embodiment, since the acceleration information depending on the motion is transmitted from the action sensor 11 to the cartridge 3, the user 9 can control the moving image as displayed on the television monitor 5 (the traveling in the virtual space in the first person viewpoint in the step exercise and the train exercise of FIGS. 9 to 13, and the traveling of the player character 78 in the virtual space in the maze exercise and the ring exercise of FIGS. 15 to 18) by moving the body in the three-dimensional space. As the result, since the user 9 can do exercise while looking at the moving image which responds to the motion of his/her own body, the user 9 does not get bored easily in comparison with the case where the body is excursively moved, and it is possible to support the continuation of the exercise.

For example, the user 9 can control the player character 78 by moving the body (representatively, the maze exercise and the ring exercise). As the result, since the user 9 can do exercise while looking at the player character 78 which responds to the his/her motion, the user 9 does not get bored easily in comparison with the case where the body is excursively moved, and it is possible to support the continuation of the exercise.

Also, for example, the user 9 can look at such the video image as if actually moving in virtual space as displayed on the television monitor 5 by moving the body in the three-dimensional space (representatively, the step exercise, the train exercise, the maze exercise, and the ring exercise). That is, the user 9 can experience the event in the virtual space by simulation by moving the body. As the result, the tediousness is not felt easily in comparison with the case where the body is excursively moved, and it is possible to support the continuation of the exercise.

Especially, the user 9 can experience the maze 82 by simulation by doing the maze exercise. A maze game is well known and does not require knowledge and experience, and therefore many users 9 can easily enjoy the maze game using the action sensor 11 and the cartridge 3.

By the way, although a size of the virtual space is substantially infinite, a part thereof is just displayed on the television monitor 5. Accordingly, even if the user 9 tries to travel to a predetermined location in the virtual space, the user 9 can not recognize the location. However, in accordance with the present embodiment, since the mark 80, which indicates the direction of the goal of the maze 82 as formed in the virtual space, is displayed, it is possible to assist the user 9 whose objective is to reach the goal of the maze 82 as formed in the huge virtual space (representatively, the maze exercise).

Further, in accordance with the present embodiment, the change of the direction in the virtual space is performed on the basis of the acceleration transmitted from the action sensor 11. Accordingly, the user 9 can intuitively change the direction in the virtual space only by changing the direction of the body, on which the action sensor 11 is mounted, to the desired direction (representatively, the maze exercise and the ring exercise).

By the way, generally, in the case where its own position is moved in the virtual space as displayed on the television monitor 5, it may be difficult for a person who is unused to a video game and soon for playing in the virtual space to get the feeling of the virtual space (e.g., its own position in the virtual space, the position relative to the other object in the virtual space, and so on). However, especially, the guide ring 100 is displayed in the ring exercise, and thereby it is possible to assist the user 9 so as to be appropriately able to move toward the target ring 102. As the result, even the case where a person is unused to the virtual space, it is easily handled.

Still further, in accordance with the present embodiment, the user can do the stepping exercise not at a subjective pace but at a pace of the trainer character 43, i.e., at an objective pace by doing the stepping exercise in accordance with the trainer character 43 (representatively, the step exercise and the maze exercise). In this case, it is determined that whether or not the user 9 appropriately carries out the stepping exercise which the trainer character 43 guides, and the result of the determination is shown to the user 9 via the television monitor 5 (in the above example, the voice of the trainer character 43 in the step exercise, and the mood meter 61 and the effect in the train exercise). For this reason, the user can correct the pace of his/her stepping and so on by looking at the result, and stably do the stepping exercise.

Moreover, in accordance with the present embodiment, since the action sensor 11 is mounted on the torso or the head region, it is possible to measure the motion of the entire body as well as the motion of the part of user 9 (the motion of arms and legs).

Generally, since the arms and legs can be moved independently from the torso, even if the action sensors 11 are mounted on the arms and legs, it is difficult to detect the motion of the entire body, and therefore it is required to mount the action sensor 11 on the torso. However, although the head region can be moved independently from the torso, in the case where the torso is moved, the head region hardly moves by itself, and usually moves integrally with the torso, therefore, even when the action sensor 11 is mounted on the head region, it is possible to detect the motion of the entire body.

Also, in accordance with the present embodiment, since the amount of the activity of the user 9 is computed, the user 9 can acquire his/her objective amount of the activity by showing it to the user 9 via television monitor 5.

Because of the above advantage, for example, the exercise supporting system according to the present embodiment can be utilized so as to prevent and improve a metabolic syndrome.

### Second Embodiment

The primary difference between the second embodiment and the first embodiment is the method for detecting the number of steps based on the acceleration. Also, although the motion of the user 9 is classified into any one of the walking, the slow running, and the normal running in the first embodiment, the motion of the user 9 is classified into any one of standard walking, rapid walking, and running in the second embodiment. Incidentally, the contents for instructing the user to do exercise are the same as those of the first embodiment (FIGS. 7 to 13, and FIGS. 15 to 18).

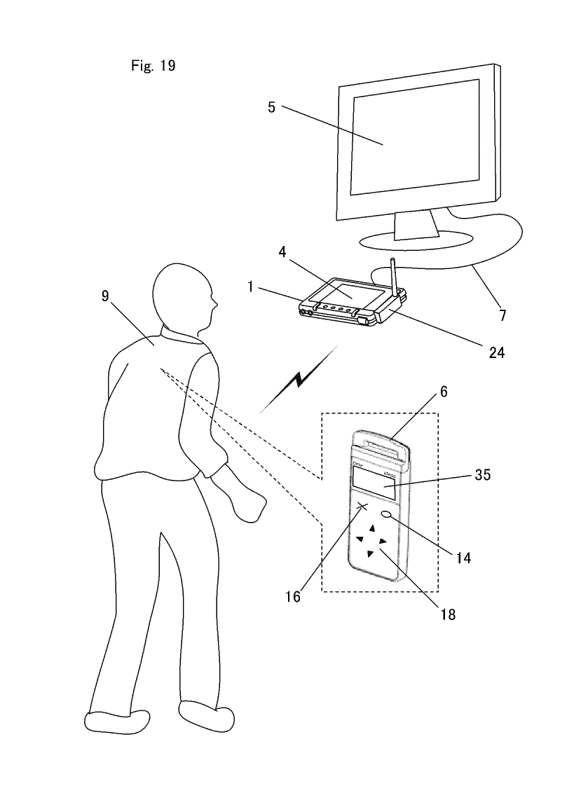

FIG. 19 is a view showing the entire configuration of an exercise supporting system in accordance with the second embodiment of the present invention. Referring to FIG. 19, the exercise supporting system includes the adapter 1, a cartridge 4, an antenna unit 24, an action sensor 6, and the television monitor 5. The cartridge 4 and the antenna unit 24 are connected to the adapter 1. Also, the adapter 1 is coupled with the television monitor 5 by an AV cable 7. Accordingly, a video signal VD and an audio signal AU generated by the cartridge 4 is supplied to the television monitor 5 by the adapter 1 and the AV cable 7.

The action sensor 6 is mounted on a torso or a head region of a user 9. The torso represents a body of the user except a head, a neck, and arms and legs. The head region represents a head and a neck. The action sensor 6 is provided with the LCD 35, a decision button 14, a cancel button 16, and arrow keys 18 (up, down, right, and left).

The action sensor 6 has two modes (a pedometer mode and a communication mode). The pedometer mode is a mode in which the action sensor 6 is used alone and the number of steps of the user 9 is measured. The communication mode is a mode in which the action sensor 6 and the cartridge 4 (the antenna unit 24) communicate with each other and function in cooperation with each other, and moreover the action sensor 6 is used as an input device to the cartridge 4. For example, by using the action sensor 6 in the communication mode, the user 9 exercises while looking at the respective various screens (of FIGS. 7 to 13, and FIGS. 15 to 18) displayed on the television monitor 5.

The LCD 35 displays time/year/month/day, and the number of steps in the pedometer mode. In this case, when 30 seconds elapse after displaying them, the display thereof is cleared because of the reduction of power consumption. Also, the LCD 35 displays an icon for indicating a remaining battery level of the action sensor 6.

The decision button 14 switches among time, a year, and a month and a day by rotation in the pedometer mode. Also, the decision button 14 mainly determines the selection operation in the communication mode. The cancel button 16 mainly cancels the selection operation in the communication mode. The arrow keys 18 are used to operate the screen of the television monitor 5 in the communication mode.

In the pedometer mode, for example, as shown in FIG. 2(a), the user 9 wears the action sensor 6 on a roughly position of the waist. In the communication mode, when the exercise is performed, for example, as shown in FIG. 2(b), the user 9 wears the action sensor 11 on roughly position of the center of the chest. Needless to say, in each case, it may be worn on any portion of the torso or head region.

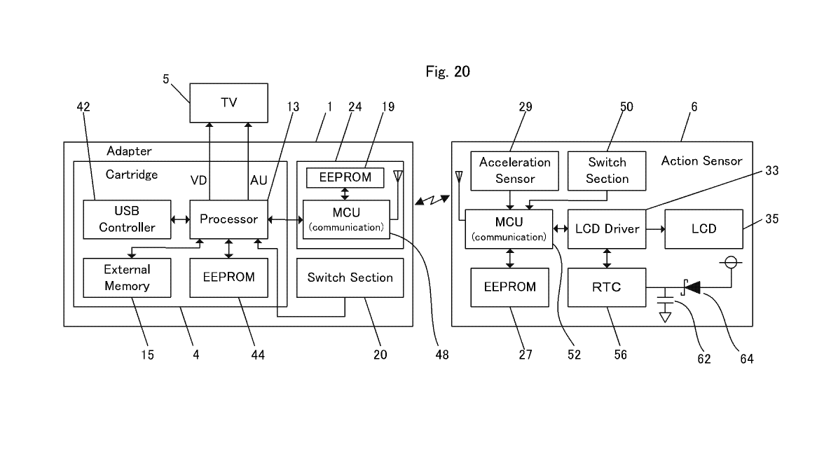

FIG. 20 is a view showing the electric configuration of the exercise supporting system of FIG. 19. Referring to FIG. 20, the action sensor 6 of the exercise supporting system is provided with an MCU 52 with a wireless communication function, an EEPROM 27, an acceleration sensor 29, an LCD driver 33, the LCD 35, an RTC 56, and a switch section 50. The switch section 50 includes the decision button 14, the cancel button 16, and the arrow keys 18. The adapter 1 includes a switch section 20, and manipulation signals from the switch section 20 are input to the processor 13. The switch section 20 includes a cancel key, an enter key, and arrow keys (up, down, right, and left). The cartridge 4 inserted into the adapter 1 includes the processor 13, an external memory 15, an EEPROM 44, and a USB controller 42. The antenna unit 24 to be connected to the adapter 1 includes an MCU 48 with a wireless communication function, and an EEPROM 19. The antenna unit 24 is electrically connected with the cartridge 4 via the adapter 1. The EEPROMs 19 and 27 stores information required to communicate between the MCU 48 and 52.

The acceleration sensor 29 of the action sensor 6 detects accelerations ax, ay, and az in the respective direction of the three axes (x, y, z) which are at right angles to one another.

In the pedometer mode, the MCU 52 counts the number of steps of the user 9 on the basis of the acceleration data from the acceleration sensor 29, stores data of the number of steps in the EEPROM 27, and sends data of the number of steps to the LCD driver 33. The LCD driver 33 displays the received data of the number of steps on the LCD 35.

Also, the MCU 52 controls the LCD driver 33 in response to the manipulation of the decision button 14 to switch among the displays of the LCD 35 in the pedometer mode. Further, when the decision button 14 and the cancel button 16 are simultaneously pressed in the pedometer mode, the MCU 52 shifts to the communication mode. However, when a beacon is received from the MCU 48 of the antenna unit 24 for 5 seconds, the MCU 52 shifts to the pedometer mode again.

On the other hand, in the communication mode, the MCU 52 modulates the acceleration data from the acceleration sensor 29, the state of the switch section 50, and the output voltage data vo of a battery (as not shown in the figure), and transmits them to the MCU 48 of the antenna unit 24. Incidentally, the data of the number of steps as stored in the EEPROM 27 in the pedometer mode is transmitted from the action sensor 6 to the antenna unit 24 at the time of the first communication.

The LCD driver 33 receives the time information from the RTC 56, displays it on the LCD 35, and sends it to the MCU 52. The RTC 56 generates the time information. The RTC 56 is connected with one terminal of a capacitor 62 and a cathode of the Schottky diode 64. The other terminal of the capacitor 62 is grounded. A battery (as not shown in the figure) applies the power-supply voltage to an anode of the diode 64. Accordingly, the capacitor 62 accumulates electrical charge from the battery via the diode 64. As the result, even if the battery is demounted so as to replace the battery, the RTC 56 can continuously generate the time information during a certain time by the electrical charge accumulated in the capacitor 62. If a new battery is set before the certain time elapses, the RTC 56 can keep the correct time information and give it to the LCD driver 33 without being reset. Incidentally, if the battery is demounted, data stored in an internal RAM (not shown in the figure) of the MCU 52 is instantaneously lost.

The processor 13 of the cartridge 4 is connected with the external memory 15. The external memory 15 is provided with a ROM, a RAM, and/or a flash memory, and so on in accordance with the specification of the system. The external memory 15 includes a program area, an image data area, and an audio data area. The program area stores control programs (including an application program). The image data area stores all of the image data items which constitute the screens to be displayed on the television monitor 5. The audio data area stores audio data for generating music, voice, sound effect, and so on. The processor 13 executes the control programs in the program area, reads the image data in the image data area and the audio data in the audio data area, processes them, and generates a video signal VD and an audio signal AU. These detailed processing will be obvious by flowcharts as described below.

Also, the processor 13 performs the control program and instructs the MCU 48 to communicate with the MCU 52 of the action sensor 6 and acquire the acceleration data, the state of the switch section 50, and the output voltage data vo. In response to the instruction from the processor 13, the MCU 48 receives the acceleration data, the state of the switch section 50, and the output voltage data vo from the MCU 52, demodulates them, and sends them to the processor 13.

The processor 13 computes the number of steps and amount of activity and identifies the motion form of the user 9 on the basis of the acceleration data from the action sensor 6 so as to display on the television monitor 5 in an exercise process in step S109 of FIG. 28 as described below. Also, the processor 13 displays a remaining battery level of the action sensor 6 on the television monitor 5 on the basis of the output voltage data vo as received. Further, while the data of the number of steps in the pedometer mode is sent from the action sensor 6 to the antenna unit 24 at the time of the first communication, the processor 13 stores the data of the number of steps in the EEPROM 44. Also, the processor 13 stores various information items as input by the user using the action sensor 6 of the communication mode in the EEPROM 44.

By the way, the cartridge 4 and the antenna unit 24 can communicate with the action sensor 6 only when the mode of the action sensor 6 is the communication mode. Because of this, the action sensor 6 functions as an input device to the processor 13 only in the communication mode.

Incidentally, the external interface block of the processor 13 is an interface with peripheral devices (the MCU 48, the USB controller 42, the EEPROM 44, and the switching section 20 in the case of the present embodiment).

The USB controller 42 for connecting with a USB device such as a personal computer transmits the data of the number of steps, the amount of the activity, and so on stored in the EEPROM 44 to the USB device.

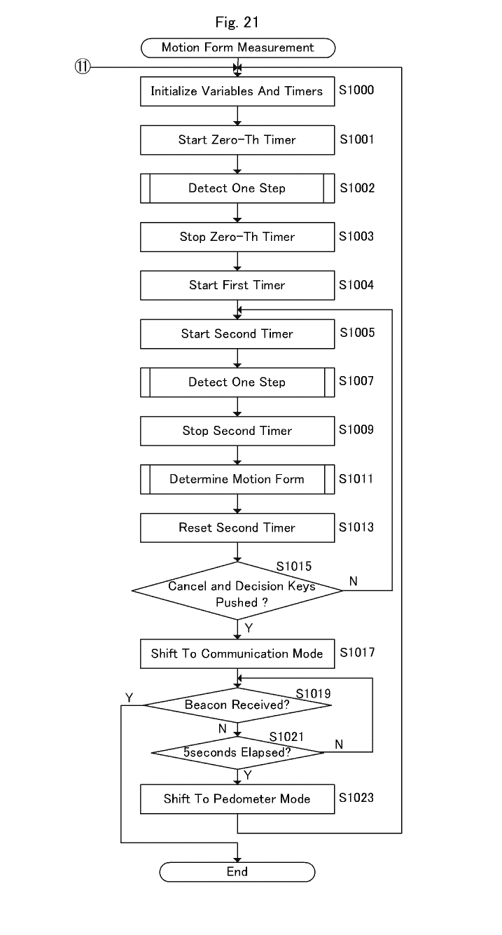

FIG. 21 is a flow chart showing a process for measuring motion form, which is performed by the MCU 52 of the action sensor 6 of FIG. 20. Referring to FIG. 21, in step S1000, the MCU 52 initializes respective variables (including flags and counters) and a timer. Specifically, the MCU 52 sets a motion form flag which indicates motion form of the user 9 to a “standstill”, turns an indetermination flag which indicates whether or not the current time is within an indetermination period on (indicates that it is within the indetermination period), resets variables “max” and “min”, clears counters Nw0, Nq0, Nr0, and No0, initializes the other variables, and resets the zeroth to the fourth timers.

The indetermination period is a period in which it is impossible to determine whether the acceleration from the action sensor 6 is caused by the motion of the user 9 (walking or running) or is noise caused by living actions (e.g., standing up, seating, small sway of a body, or the like) other than the motion of the user 9 (walking or running) and noise caused by extraneous vibrations (e.g., a train, a car, or the like). In the present embodiment, the indetermination period is set to 4 seconds.

The zeroth timer measures a standstill judgment period in a process for detecting one step of the step S1002. The standstill judgment period is set to 1 second in the present embodiment. If one step is not detected during 1 second, the process for detecting one step is reset. The first timer is a timer for measuring the indetermination period and a standstill judgment period. The indetermination period is set to 4 seconds in the present embodiment. Also, the standstill judgment period is set to 1 second in the present embodiment. If one step is not detected during 1 second, the process for detecting one step is reset, and the indetermination period starts from the beginning. The second timer is a timer for measuring a period from a point of time when one step is detected in step S1007 until a point of time when the next one step is detected in the next step S1007, i.e., a time corresponding to one step. The third timer measures a first waiting time. The first waiting time is 180 milliseconds in the present embodiment. The fourth timer measures a second waiting time. The second waiting time is 264 milliseconds in the present embodiment.

Incidentally, it is not until the indetermination period expires that a plurality of motions each of which is one step, which is detected during the indetermination period, is determined as valid motions and is counted as the number of steps. And, the motions each of which is one step, which is detected after the indetermination period expires, is counted as the number of steps one by one. However, even after the expiration of the indetermination period, if the motion of one step is not detected during the standstill judgment period, the indetermination period starts again. A period from a point of time when the indetermination period expires until a point of time when the standstill judgment period expires (i.e., a point of time when the next indetermination period starts) is called a valid period. Also, when the motion of one step is not detected within the standstill judgment period during the indetermination period, the indetermination period starts from the beginning, even if the motion of one step has been detected so far during the indetermination period, all is cleared.

By the way, the counters Nw0, Nq0, Nr0, and No0 are respectively counters for counting, during the indetermination period, the number of times of the standard walking, the number of times of the rapid walking, the number of times of the running, and the number of times of the going up and down. The counters Nw1, Nq1, Nr1, and No1 as described below are respectively counters for counting, during the valid periods for a day, the number of times of the standard walking, the number of times of the rapid walking, the number of times of the running, and the number of times of the going up and down. However, when the indetermination period expires, the values of the counters Nw0, Nq0, Nr0, and No0 during the indetermination period are respectively added to the counters Nw1, Nq1, Nr1, and No1. As the result, the counters Nw1, Nq1, Nr1, and No1 are respectively counters for counting the number of times of the valid standard walking, the number of times of the valid rapid walking, the number of times of the valid running, and the number of times of the valid going up and down, for a day. Incidentally, these counters Nw1, Nq1, Nr1, and No1 are not cleared in step S1000, and, for example, these are cleared at midnight.

In step S1001, the MCU 52 starts the zeroth timer. In step S1002, the MCU 52 detects the motion of one step of the user 9 on the basis of the acceleration data from the acceleration sensor 29. In step S1003, the MCU 52 stops the zeroth timer.

In step S1004, i.e., when the motion of one step is detected in step S1002, the MCU 52 starts the first timer. In step S1005, i.e., when the motion of one step is detected in step S1002 or S1009, the MCU 52 starts the second timer.

In step S1007, the MCU 52 detects the motion of one step of the user 9 on the basis of the acceleration data from the action sensor 6. In step S1009, i.e., when the motion of one step is detected in step S1007, the MCU 52 stops the second timer. In step S1011, the MCU 52 determines the form of the motion performed by the user 9 on the basis of the acceleration data from the acceleration sensor 29. In the present embodiment, the motion form of the user 9 is classified into any one of the standard walking, the rapid walking, and the running. In step S1013, the MCU 52 resets the second timer.

In step S1015, the MCU 52 determines whether or not the cancel button 16 and the decision button 14 are simultaneously pushed, the process proceeds to step S1017 so as to shift to the communication mode if they are simultaneously pushed, conversely, if they are not simultaneously pushed, the process keeps the pedometer mode, and repeats the one step detection and the motion form determination by returning to step S1005.

By the way, a time from when the second timer is stopped in step S1009 until when the second timer is started in step S1005 again after the second timer is reset in step S1013 is substantially 0 time with regard to the process for measuring the motion form. Also, a time from when the zeroth timer is stopped in step S1003 until when the second timer is started in step S1005 after the first timer is started in step S1004 is substantially 0 time with regard to the process for measuring the motion form.

By the way, in step S1019 after the mode is shifted to the communication mode in step S1017, the MCU 52 determines whether or not the beacon is received from the MCU 48 of the antenna unit 24, the pedometer mode is terminated if it is received, conversely the process proceeds to step S1021 if it is not received. In step S1021, the MCU 52 determines whether or not a time of 5 seconds elapses after the mode is shifted to the communication mode, the process proceeds to step S1023 so as to return to the pedometer mode if it elapses, conversely the process returns to step S1019 if it does not elapse. The processor 13 proceeds to step S1000 after shifting to the pedometer mode in step S1023.

In this way, even when the mode is shifted to the communication mode, if it is impossible to communicate with the antenna unit 24 or the communication is not carried out for 5 seconds or more, the mode returns to the pedometer mode.

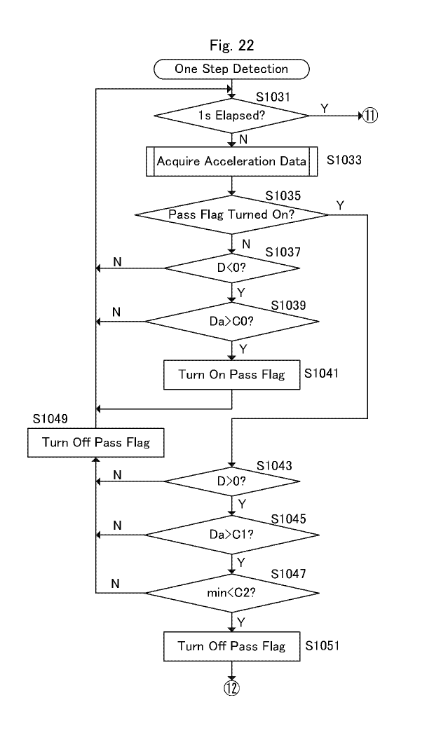

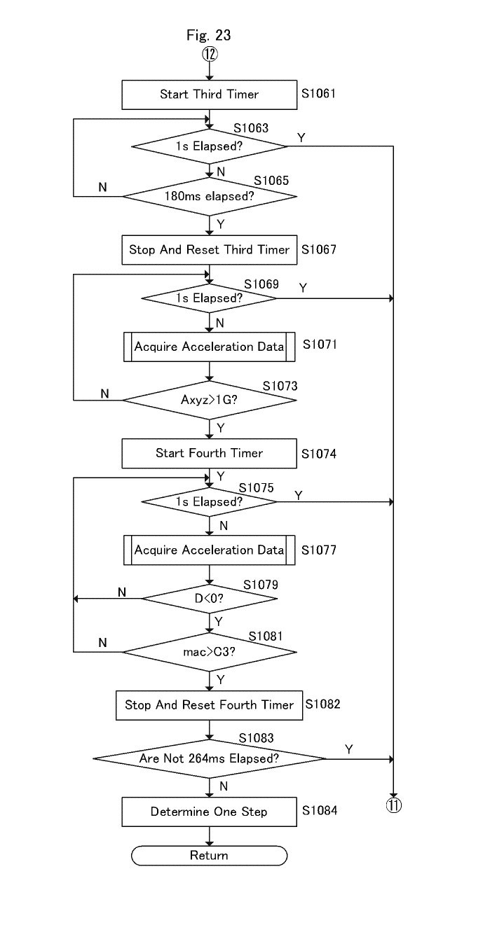

FIGS. 22 and 23 are flowcharts showing the process for detecting one step, which is performed in step S1007 of FIG. 21. Referring to FIG. 22, in step S1031, the MCU 52 determines whether or not 1 second (the standstill judgment period) elapses from the time when the first timer starts (in step S1004), the process determines that the user 9 stops if it elapses, and thereby returns to step S1000 of FIG. 21, conversely the process proceeds to step S1033 if it does not elapse. In step S1033, the MCU 52 acquires the acceleration data from the acceleration sensor 29.

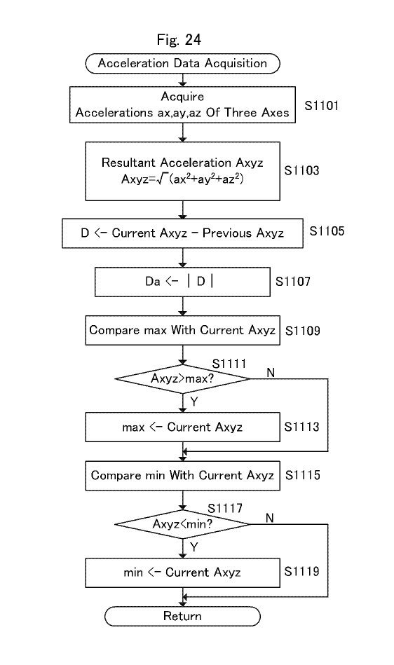

FIG. 24 is a flow chart showing the process for acquiring acceleration data, which is performed in step S1033 of FIG. 22. Referring to FIG. 24, in step S1101, the MCU 52 acquires the acceleration data ax, ay and az for each of three axes from the acceleration sensor 29. In step S1103, the MCU 52 computes the resultant acceleration Axyz.

In step S1105, the MCU 52 subtracts the resultant acceleration Axyz computed previously from the resultant acceleration Axyz computed currently so as to obtain the subtraction result D. In step S1107, the MCU 52 computes an absolute value of the subtraction result D, and assigns it to a variable Da.

In step S1109, the MCU 52 compares the value of the variable “max” with the resultant acceleration Axyz which is currently computed. In step S1111, the MCU 52 proceeds to step S1113 if the current resultant acceleration Axyz as computed exceeds the value of the variable “max”, otherwise proceeds to step S1115. Then, in step S1113, the MCU 52 assigns the current resultant acceleration Axyz to the variable “max”. It is possible to acquire the maximum value “max” of the resultant acceleration Axyz during a period from when one step is detected until when the next one step is detected, i.e., during a stride, by steps S1109 to S1113.

In step S1115, the MCU 52 compares the value of the variable “min” with the resultant acceleration Axyz which is currently computed. In step S1117, the MCU 52 proceeds to step S1119 if the current resultant acceleration Axyz as computed is below the value of the variable “min”, otherwise returns. Then, in step S1119, the MCU 52 assigns the current resultant acceleration Axyz to the variable “min”, and then returns. It is possible to acquire the minimum value “max” of the resultant acceleration Axyz during a period from when one step is detected until when the next one step is detected, i.e., during a stride, by steps S1115 to S1119.

Returning to FIG. 22, in step S1035, the MCU 52 determines whether or not a pass flag is turned on, the process proceeds to step S1043 if it is turned on, conversely the process proceeds to step S1037 if it is turned off. The pass flag is a flag which is turned on when the positive determination is made in both of steps S1037 and S1039. In step S1037, the MCU 52 determines whether or not the subtraction result D is negative, the process proceeds to step S1039 if it is negative, otherwise the process returns to step S1031. In step S1039, the MCU 52 determines whether or not the absolute value Da exceeds a predetermined value C0, the process proceeds to step S1041 if it exceeds, otherwise the process returns to step S1031. Then, in step S1041, the MCU 52 turns on the pass flag, and then proceeds to step S1031.

Incidentally, in the case where the subtraction result D is negative, the case means that the current resultant acceleration Axyz decreases relative to the previous resultant acceleration Axyz. Also, in the case where the absolute value Da exceeds the predetermined value C0, the case means that the decrease in the current resultant acceleration Axyz relative to the previous resultant acceleration Axyz exceeds the predetermined value C0. That is, in the case where the positive determination is made in both of steps S1037 and S1039, the case means that the resultant acceleration Axyz decreases by the predetermined value C0 or more in comparison with the previous value.

By the way, in step S1043 after “YES” is determined in step S1035, the MCU 52 determines whether or not the subtraction result D is positive, the process proceeds to step S1045 if it is positive, otherwise the process returns to step S1049. In step S1045, the MCU 52 determines whether or not the absolute value Da exceeds a predetermined value C1, the process proceeds to step S1047 if it exceeds, otherwise the process returns to step S1049. In step S1047, the MCU 52 determines whether or not the value of the variable “min” is below a predetermined value C2, the process proceeds to step S1051 if it is below, otherwise the process proceeds to step S1049. In step S1051, the MCU 52 turns off the pass flag, and then proceeds to step S1061 of FIG. 23.

Incidentally, in the case where the subtraction result D is positive, the case means that the current resultant acceleration Axyz increases relative to the previous resultant acceleration Axyz. Also, in the case where the absolute value Da exceeds the predetermined value C1, the case means that the increase in the current resultant acceleration Axyz relative to the previous resultant acceleration Axyz exceeds the predetermined value C1. Further, in the case where the value of the variable “min” is below the predetermined value C2, the case means that the resultant acceleration Axyz is the minimum value. That is, in the case where the positive determination is made in steps S1043 to S1047, the case means that the resultant acceleration Axyz increases by the predetermined value C1 or more in comparison with the previous value after the resultant acceleration Axyz becomes the minimum value.

By the way, in step S1049 after “NO” is determined in step S1043, S1045, or S1047, the MCU 52 turns off the pass flag, and then returns to step S1031. That is, in the case where the negative determination is made in any one of steps S1043 to S1047, the process for detecting one step is performed from the beginning, and the process does not return to step S1043.

Referring to FIG. 23, in step S1061, the MCU 52 starts the third timer. In step S1063, the MCU 52 determines whether or not 1 second (the standstill judgment period) elapses from the time when the first timer starts, the process determines that the user 9 stops if it elapses, and thereby returns to step S1000 of FIG. 21, conversely the process proceeds to step S1065 if it does not elapse. In step S1065, the MCU 52 determines whether or not 180 milliseconds (the first waiting time) elapses from the time when the third timer starts, the process returns to step S1063 if it does not elapse, conversely the process proceeds to step S1067 if it elapses. In step S1067, the MCU 52 stops and resets the third timer.

Incidentally, the first waiting time (step S1065) is established so as to exclude noise near the maximum value and noise near the minimum value of the resultant acceleration Axyz from the determination target. In passing, the maximum value of the resultant acceleration Axyz arises during a period from when a foot lands until when the foot separates from the ground while the minimum value thereof arises just before landing.

By the way, in step S1069, the MCU 52 determines whether or not 1 second (the standstill judgment period) elapses from the time when the first timer starts, the process determines that the user 9 stops if it elapses, and thereby returns to step S1000 of FIG. 21, conversely the process proceeds to step S1071 if it does not elapse. In step S1071, the MCU 52 acquires the acceleration data from the acceleration sensor 29. This process is the same as that of the step S1033. In step S1073, the MCU 52 determines whether or not the resultant acceleration Axyz exceeds 1G, the process proceeds to step S1074 if it exceeds, conversely the process returns to step S1069 if it does not exceed. Then, in step S1074, the MCU 52 starts the fourth timer. Incidentally, the process in step S1073 is a process for determining a point of time when the fourth timer is started.

In step S1075, the MCU 52 determines whether or not 1 second (the standstill judgment period) elapses from the time when the first timer starts, the process determines that the user 9 stops if it elapses, and thereby returns to step S1000 of FIG. 21, conversely the process proceeds to step S1077 if it does not elapse. In step S1077, the MCU 52 acquires the acceleration data from the acceleration sensor 29. This process is the same as that of the step S1033. In step S1079, the MCU 52 determines whether or not the subtraction result D is negative, the process proceeds to step S1081 if it is negative, otherwise the process returns to step S1075. In step S1081, the MCU 52 determines whether or not the value of the variable “max” exceeds a predetermined value C3, the process proceeds to step S1082 if it exceeds, otherwise the process returns to step S1075.

Incidentally, in the case where the subtraction result D is negative, the case means that the current resultant acceleration Axyz decreases relative to the previous resultant acceleration Axyz. Accordingly, the resultant acceleration Axyz decreases from the time when the process for detecting one step is started (the positive determination in step S1037 and S1039), then becomes minimal (the positive determination in steps S1043 to S1047), then increases (the positive determination in step S1073), and then decreases again (the positive determination in step S1079). That is, in the case where the positive determination is made in step S1079, the case means that the peak of the resultant acceleration Axyz is detected. Also, in the case where the value of the variable “max” exceeds the predetermined value C3, the case means that the resultant acceleration Axyz becomes maximal during a period from the time when the process for detecting one step is started until the current time. Incidentally, it is not always true that the peak of the resultant acceleration Axyz coincides with the maximum value.

By the way, in step S1082, the MCU 52 stops and resets the fourth timer. In step S1083, the MCU 52 determines whether 264 milliseconds (the second waiting time) does not elapse still, the process returns to step S1000 of FIG. 21 if it elapses (the negative determination), conversely the process proceeds to step S1084 if it does not elapse still (the positive determination) so as to determine that one step arises. A point of time when it is determined in step S1084 that one step arises is the time when the motion of one step is detected. Then, the process returns.

In this way, if the positive determination is made within 1 second (the standstill determination period) in all step S1037, S1039, S1043, S1045, S1047, S1065, S1073, S1079, S1081, and S1083, it is determined that one step arises.

Incidentally, the second waiting time (step S1083) is established so as to exclude the resultant acceleration Axyz, which relatively increases moderately That is, noise of relatively-low-frequency is excluded from the determination target.

Also, in the case where the negative determination is made in any one of step S1043, S1045 and S1047, the processing returns to not step S1043 but step S1031 through step S1049, and therefore the process for detecting one step is performed from the beginning again. Because, in the case where the negative determination is made in any one of step S1043, S1045 and S1047, the positive determination in step S1037 and S1039 is empirically experimentally uncertain, i.e., it is highly possible that the positive determination is made on the basis of noise. On the other hand, even when the negative determination is made in any one of step S1043, S1045 and S1047, the processing does not return to step S1031.

Incidentally, the predetermined values C0>C1, and the predetermined values C2<C3. The predetermined value C2 is the probable maximum value of the minimum values of the resultant acceleration Axyz which can be assumed when the resultant acceleration Axyz arises by the walking which is not noise. The predetermined value C3 is the probable minimum value of the maximum values of the resultant acceleration Axyz which can be assumed when the resultant acceleration Axyz arises by the walking which is not noise. The predetermined values C0 to C3 are experimentally given.

By the way, a time from when it is determined that the motion of one step is detected in step S1084 until when the second timer is started in step S1005 again after the second timer is stopped in step S1009 of FIG. 21 and is reset in step S1013 is substantially 0 time with regard to the process for detecting one step. Accordingly, the second timer measures the time from when one step is detected until when the next one step is detected, i.e., a time corresponding to one step. More specifically, the second timer measures the time from the peak of the resultant acceleration Axyz until the next peak thereof, the time indicates the time corresponding to one step. Incidentally, a time from when the positive determination is made in step S1079 until when the positive determination is made in step S1083 after the positive determination in step S1081 is substantially 0 time with regard to the process for detecting one step. Besides, in the present embodiment, the time corresponding to one step may be called a “tempo”. Because, the time corresponding to one step correlates with (is in inverse proportion to) the speed of the walking and the running under the assumption that a stride is a constant, and becomes an indication of the speed.

By the way, the process for detecting one step in step S1002 of FIG. 21 is similar to the process for detecting one step in step S1007. 21 However, in the description of FIGS. 22 and 23, the “first timer” is replaced with the “zeroth timer”

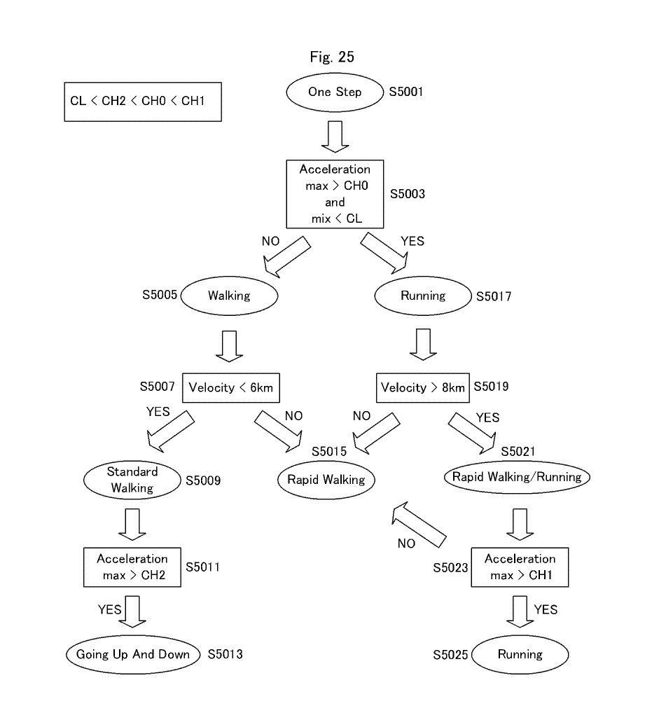

FIG. 25 is an explanatory view showing the method for determining the motion form, which is performed in step S1011 of FIG. 21. Referring to FIG. 25, in step S5001, the MCU 52 proceeds to step S5003 if the MCU 52 determines that the user 9 performs the motion of one step (step S1084 of FIG. 23). In step S5003, the MCU 52 proceeds to step S5017 if the maximum value “max” of the resultant acceleration Axyz (step S1109 to S1113 of FIG. 24) exceeds the predetermined value CH0 and the minimum value “min” of the resultant acceleration Axyz (step S1115 to S1119 of FIG. 24) is below the predetermined value CL, and provisionally classifies the motion of the user 9 into the motion form indicating the running, otherwise proceeds to step S5005, and provisionally classifies the motion of the user 9 into the motion form indicating the walking.

In step S5007, the MCU 52 determines whether or not the speed of the user 9 is below 6 kilometers per hour, the process proceeds to step S5009 if it is below, and conclusively classifies the motion of the user 9 into the motion form indicating the standard walking, otherwise proceeds to step S5015, and conclusively classifies the motion of the user 9 into the motion form indicating the rapid walking.

In step S5011, the MCU 52 determines whether or not the maximum value “max” of the resultant acceleration Axyz exceeds the predetermined value CH2, the process proceeds to step S5013 if it exceeds, and specifies that the motion of the user 9 is the standard walking which includes the going up and down stairs or the like, otherwise specifies that it is the usual standard walking.

On the other hand, in step S5019, the MCU 52 determines whether or not the speed of the user 9 exceeds 8 kilometers per hour, the process proceeds to step S5021 if it exceeds, and provisionally classifies the motion of the user 9 into the motion form indicating the rapid walking/running, otherwise proceeds to step S5015, and conclusively classifies the motion of the user 9 into the motion form indicating the rapid walking. In this case, the rapid walking/running indicates the state where the motion of the user 9 is either the rapid walking or the running and therefore is unsettled yet.

In step S5023, the MCU 52 determines whether or not the maximum value “max” of the resultant acceleration Axyz exceeds the predetermined value CH1, the process proceeds to step S5025 if it exceeds, and conclusively classifies the motion of the user 9 into the motion form indicating the running, otherwise proceeds to step S5015, and conclusively classifies the motion of the user 9 into the motion form indicating the rapid walking.

As described above, the motion of the user 9 is provisionally classified into the walking or the running in step S5003. The reason is as follows.

In the present embodiment, as described below, the amount of the activity is calculated depending on the motion form of the user 9. The amount (Ex) of the activity is obtained by multiplying the intensity (METs) of the motion by the time (hour). The intensity of the motion is determined depending on the motion form. The walking of the motion form is discriminated from the running of the motion form on the basis of the velocity. Accordingly, in the case where the amount of the activity is calculated depending on the walking and the running, it is preferred that the motion of the user is finally classified on the basis of the velocity.

However, if the classification is performed using only the velocity, there is a possibility that the following inexpedience occurs. A stride and a time corresponding to one step (tempo) are needed so as to obtain the velocity of the user 9. In general, the time corresponding to one step is shorter when walking, and is longer when running. On the other hand, in general, the stride decreases when walking, and increases when running. Accordingly, although he/she really runs, if the velocity is calculated on the basis of the stride in walking, the value thereof becomes small, and therefore it may be classified into the standard walking. On the other hand, although he/she really walks, if the velocity is calculated on the basis of the stride in running, the value thereof becomes large, and therefore it may be classified into the running.

Because of this, in the present embodiment, first of all, the motion of the user 9 is roughly classified into either the walking or the running on the basis of the magnitude of the resultant acceleration Axyz in step S5003. In this way, the stride can be set for each of the walking and the running. As the result, the above inexpedience does not occur, it is possible to appropriately classify the motion of the user 9 in accordance with the velocity, and eventually it is possible to appropriately calculate the amount of the activity. In the present embodiment, the strides are set so that the stride of the walking is smaller than the stride of the running, and thereby the velocity of the user 9 is calculated. In the present embodiment, the time corresponding to one step is indicated by the value at the time when the second timer stops in step S1009 of FIG. 21.

By the way, after the motion of the user 9 is classified into the rapid walking/running in step S5019, it is conclusively specified to be any one of the rapid walking and the running on the basis of the magnitude of the resultant acceleration Axyz in step S5023. Because, if only the step S5019 is applied, there is a possibility of the classification into the running depending on a person despite the rapid walking really, and therefore the determination has to perform more certainly.

Also, it is possible to determine the going up and down in step S5011 because the motion of the user 9 is classified into either the walking or the running on the basis of the magnitude of the acceleration in step S5003 in the stage before determining the going up and down, and furthermore it is classified on the basis of the velocity. If the motion of the user 9 is classified using only the magnitude of the acceleration, the going up and down can not be distinguished from the running.

Incidentally, the predetermined values CL, CH0, CH1, and CH2 satisfy CL<CH2<CH0<CH1. Also, the predetermined value C3 in step S1081 of FIG. 23 satisfies C3<CH2<CH0<CH1.

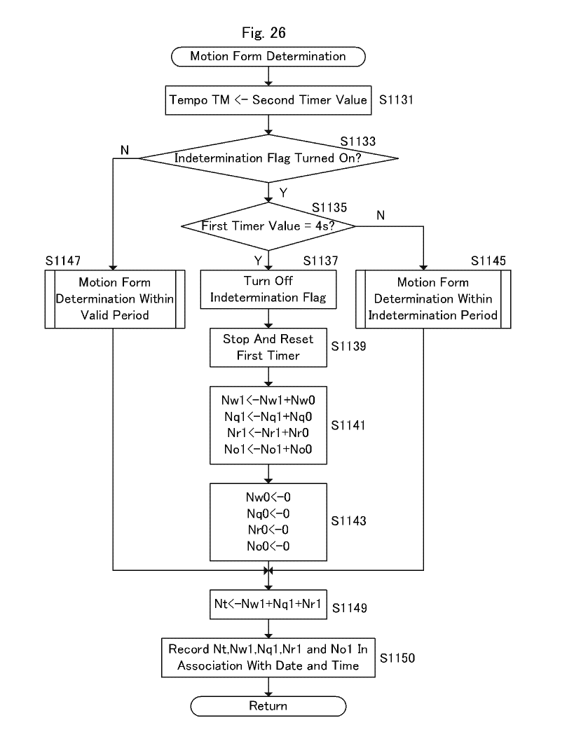

FIG. 26 is a flow chart showing the process for determining the motion form, which is performed in step S1011 of FIG. 21. Referring to FIG. 26, in step S1131, the MCU 52 assigns the value of the second timer, i.e., the time corresponding to one step to a tempo “TM”. In step S1133, the MCU 52 determines whether or not the indetermination flag is turned on, the process proceeds to step S1135 if it is turned on, conversely, if it is turned off, it is indicated that the indetermination period expires and thereby the present time is within the valid period, and therefore the process proceeds to step S1147. In step S1135, the MCU 52 determines whether or not the value of the first time is 4 seconds (the indetermination period), if it is 4 seconds, it is indicated that the indetermination period expires, it is determined that the plurality of the motions each of which is one step, which are detected within the indetermination period, are not the noise, and therefore the process proceeds to step S1137 so as to treat the provisional motion form within the indetermination period as the proper motion form, otherwise the process proceeds to step S1145 because the present time is within the indetermination period and there is a possibility that they are the noise.

In step S1137, the MCU 52 turns off the indetermination flag because the indetermination period expires. In step S1139, the MCU 52 stops and resets the first timer. In step S1141, the MCU 52 adds the value of the provisional counter Nw0 of the indetermination period to the value of the proper counter Nw1 for counting the standard walking. The MCU 52 adds the value of the provisional counter Nq0 of the indetermination period to the value of the proper counter Nq1 for counting the rapid walking. The MCU 52 adds the value of the provisional counter Nr0 of the indetermination period to the value of the proper counter Nr1 for counting the running. The value of the provisional counter No0 of the indetermination period is added to the value of the proper counter No1 for counting the going up and down. In step S1143, the MCU 52 assigns 0 to the counters Nw0, Nq0, Nr0, and No0 of the indetermination period, and proceeds to step S1149.

In step S1145 after “NO” is determined in step S1135, the MCU 52 performs the process for determining the motion form within the indetermination period, and then proceeds to step S1149. On the other hand, in step S1147 after “NO” is determined in step S1133, the MCU 52 performs the process for determining the motion form within the valid period, and then proceeds to step S1149. In step S1149 after step S1147, S1143, or S1145, the MCU 52 assigns the sum of the values of the proper counters Nw1, Nq1, and Nr1 to the counter Nt which indicates the total number of steps where the motion forms are not distinguished.

Then, in step S1150, the MCU 52 stores the values of the counters Nt1, Nw1, Nq1, Nr1m, and No1 in association with date and time from the RTC 56 in the EEPROM 27, and then returns. In this case, the MCU 52 stores these values in units of a predetermined time (e.g., 5 minutes) in the EEPROM 27.

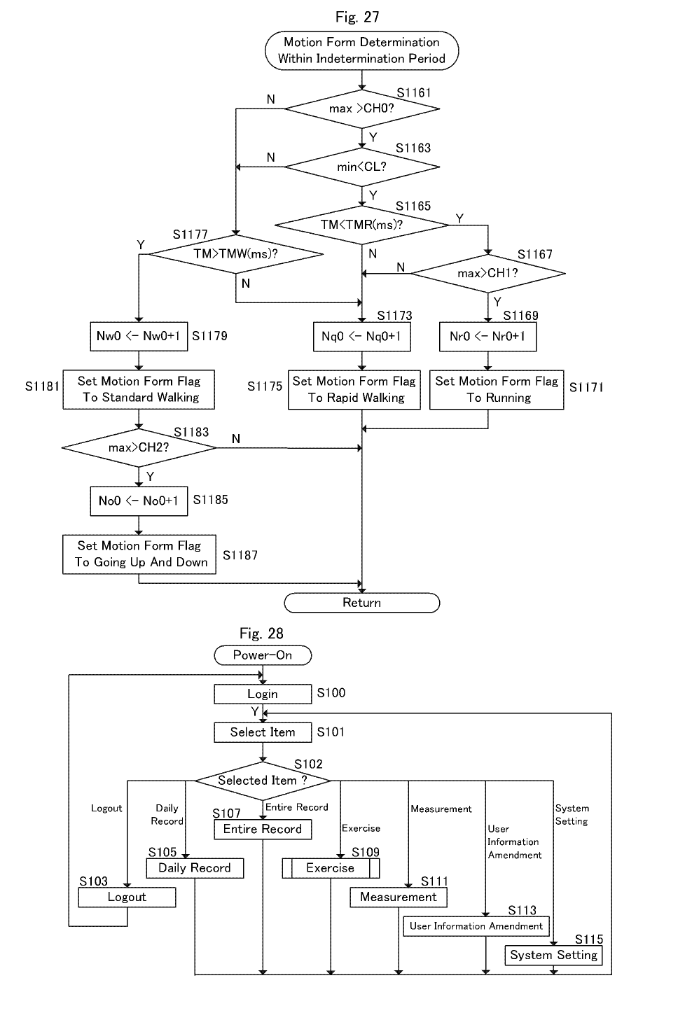

FIG. 27 is a flow chart showing the process for determining the motion form within the indetermination period, which is performed in step S1145 of FIG. 26. Incidentally, an outline of this flowchart is indicated by FIG. 25. Referring to FIG. 27, in step S1161, the MCU 52 determines whether or not the maximum value “max” of the resultant acceleration Axyz (step S1109 to S1113 of FIG. 24) exceeds the predetermined value CH0, the process proceeds to step S1163 if it exceeds, otherwise the process provisionally classifies the motion of the user 9 into the walking, and proceeds to step S1177. In step S1163, the MCU 52 determines whether or not the minimum value “min” of the resultant acceleration Axyz (steps S1115 to S1119 of FIG. 24) is below the predetermined value CL, if it is below, the process provisionally classifies the motion of the user 9 into the running and proceeds to step S1165, otherwise the process provisionally classifies the motion of the user 9 into the walking, and proceeds to step S1177.

In step S1165, the MCU 52 determines whether or not the tempo “TM” (step S1131 of FIG. 26) is below the predetermined value (TMR milliseconds), if it is below, the process classifies the motion of the user 9 into the rapid walking/running and proceeds to step S1167, otherwise the process conclusively classifies the motion of the user 9 into the rapid walking, and proceeds to step S1173.

In step S1167, the MCU 52 determines whether or not the maximum value “max” exceeds the predetermined value CH1, if it exceeds, the process conclusively classifies the motion of the user 9 into the running and proceeds to step S1169, otherwise the process conclusively classifies the motion of the user 9 into the rapid walking, and proceeds to step S1173. On the other hand, in step S1177 after “NO” is determined in step S1161 or S1163, the MCU 52 determines whether or not the tempo “TM” exceeds the predetermined value (TMW milliseconds), if it exceeds, the process conclusively classifies the motion of the user 9 into the standard walking and proceeds to step S1179, otherwise the process conclusively classifies the motion of the user 9 into the rapid walking, and proceeds to step S1173.

In step S1173, the MCU 52 increments the counter Nq0 for counting the rapid walking by 1. In step S1175, the MCU 52 sets the motion form flag indicating the motion form of the user 9 to the rapid walking, and then returns.

On the other hand, in step S1169 after “YES” is determined in step S1167, the MCU 52 increments the counter Nr0 for counting the running by 1. In step S1171, the MCU 52 sets the motion form flag to the running, and then returns.

Also, on the other hand, in step S1179 after “YES” is determined in step S1177, the MCU 52 increments the counter Nw0 for counting the standard walking by 1. In step S1181, the MCU 52 sets the motion form flag to the standard walking.

In step S1183, the MCU 52 determines whether or not the maximum value “max” exceeds the predetermined value CH2, if it exceeds, the process regards that the standard walking of the user 9 includes the going up and down, and proceeds to step S1185, otherwise returns. In step S1185, the MCU 52 increments the counter No0 for counting the going up and down by 1. In step S1187, the MCU 52 sets the motion form flag to the going up and down, and then returns.

Incidentally, in steps S5007 and S5019 of FIG. 25, the classification is carried out on the basis of the velocity of the user 9. However, in step S1177 and S1165 of FIG. 27, the classification is carried out on the basis of the tempo “TM” which correlates with (is in inverse proportion to) the velocity. In this case, it is assumed that the stride WL in walking and the stride RL in running are constant. The relation between the stride WL and WR is WL<WR. Because, in general, the stride in walking is shorter than the stride in running. Also, the relation between the predetermined values TMW and TMR is TMW<TMR. Because, in general, the tempo of the walking is shorter than that of the running.

By the way, the process for determining the motion form within the valid period in step S1047 of FIG. 26 is similar to the process for determining the motion form within the indetermination period in step S1145. However, in the description of FIG. 27, the “counter Nw0”, “counter Nq0”, “counter Nr0” and “counter No0” are respectively replaced with the “counter Nw1”, “counter Nq1”, “counter Nr1” and “counter No1”.

FIG. 28 is a flowchart showing the overall process flow by the processor 13 of the cartridge 4 of FIG. 20. Referring to FIG. 28, in step S100, the processor 13 displays a login screen on the television monitor 5, and performs the login process. In this case, first of all, the user 9 simultaneously pushes the decision button 14 and the cancel button 16 so as to shift to the communication mode. Then, the user 9 pushes a login button on the login screen by manipulating the switch section 50 of the action sensor 6, and thereby instructs the processor 13 to login. The processor 13 logins in response to the instruction.

Incidentally, the communication procedure among the cartridge 4, the antenna unit 24, and the action sensor 6, which is performed in logging in, will be described.

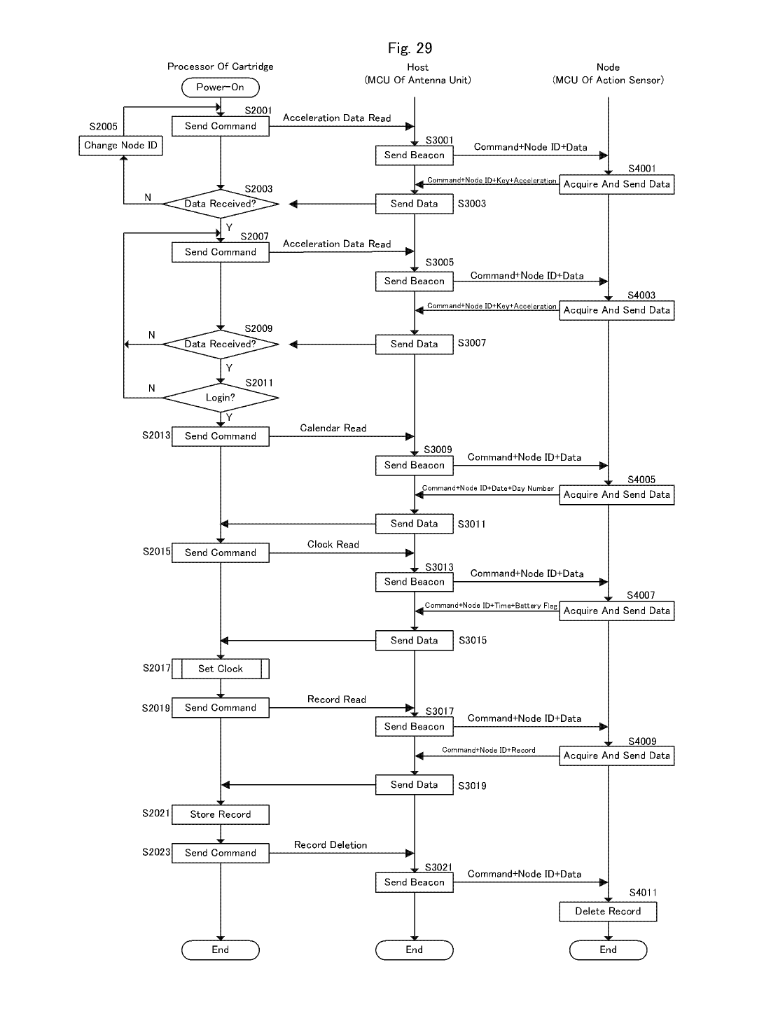

FIG. 29 is a view showing the communication procedure among the processor 13 of the cartridge 4, the MCU 48 of an antenna unit 24 (hereinafter referred to as the “host 48” in the description of this figure), and the MCU 52 (hereinafter referred to as the “node 52” in the description of this figure) of the action sensor 6, which is performed in logging in step S100 of FIG. 28. Referring to FIG. 29, in step S2001, the processor 13 sends a read command of acceleration data to the host 48. Then, in step S3001, the host 48 transmits a beacon including the read command, the node ID, and the data to the node 52. In this case, the node ID is information for identifying the node 52, i.e., the action sensor 6. In the present embodiment, for example, the four action sensors 6 can be login respectively, and the different node IDs are respectively assigned to the four action sensors 6.

When the node 52 receives the beacon including the node ID assigned to itself, in step S4001, the node 52 transmits the command as received from the host 48, its own node ID, the status (hereinafter referred to as the “key status”) of the keys (14, 16, and 18) of the switch section 50, and acceleration data ax, ay and az as acquired from the acceleration sensor 29 to the host 48.

In step S3003, the host 48 transmits the data as received from the node 52 to the processor 13. In step S2003, the processor 13 determines whether or not the data from the host 48 is received, the process proceeds to step S2005 if the data is not received, conversely the process proceeds to step S2007 if the data is received. In step S2005, the processor 13 changes the node ID which is included in the beacon, and then proceeds to step S2001. If the node 52 which has the node ID included in the beacon is not found, the response is not returned, and therefore another node 52 is found by changing the node ID in step S2005. Incidentally, in the case where the node 52 is found, subsequently, the processor 13 communicates with only the found node 52.

In step S2007, the processor 13 sends a read command of acceleration data to the host 48. Then, in step S3005, the host 48 transmits a beacon including the read command, the node ID, and the data to the node 52. In step S4003, the node 52 transmits the command as received from the host 48, its own node ID, the key status, and acceleration data of the acceleration sensor 29 to the host 48.

In step S3007, the host 48 transmits the data as received from the node 52 to the processor 13. In step S2009, the processor 13 determines whether or not the data from the host 48 is received, the process returns to step S2007 if the data is not received, conversely the process proceeds to step S2011 if the data is received. In step S2011, the processor 13 determines whether or not the user 9 carries out the login operation on the basis of the key status, the process proceeds to step S2013 if the login operation is carried out, otherwise the process returns to step S2007.

In step S2013, the processor 13 sends a read command of calendar information to the host 48. Then, in step S3009, the host 48 transmits a beacon including the read command, the node ID, and the data to the node 52. In step S4005, the node 52 transmits the command as received from the host 48, its own node ID, the date information received from the RTC 56, and the information of the number of days to the host 48. The information of the number of days is information which indicates how many days of the data of the number of steps is stored in the EEPROM 27. In step S3011, the host 48 transmits the data as received from the node 52 to the processor 13. Then, the processor 13 stores the received data in the main RAM and/or the EEPROM 44.

In step S2007, the processor 13 sends a read command of clock information to the host 48. Then, in step S3013, the host 48 transmits a beacon including the read command, the node ID, and the data to the node 52. In step S4007, the node 52 transmits the command as received from the host 48, its own node ID, the time information received from the RTC 56, and the battery flag to the host 48. The battery flag is a flag which indicates whether or not the battery of the action sensor 6 is demounted. In step S3015, the host 48 transmits the data as received from the node 52 to the processor 13. Then, in step S2017, the processor 13 performs the setting of its own clock. Also, the processor 13 stores the received data in the main RAM and/or the EEPROM 44.

In step S2019, the processor 13 sends a read command of activity record to the host 48. Then, in step S3017, the host 48 transmits a beacon including the read command, the node ID, and the data to the node 52. In step S4009, the node 52 transmits the command as received from the host 48, its own node ID, and the activity record stored in the EEPROM 27 (including date and time information, and the data of the number of steps for each motion form in association with them) to the host 48. In step S3019, the host 48 transmits the data as received from the node 52 to the processor 13. Then, in step S2021, the processor 13 stores the received data in the main RAM and/or the EEPROM 44.

In step S2023, the processor 13 sends a command for deleting record to the host 48. Then, in step S3021, the host 48 transmits a beacon including the read command, the node ID, and the data to the node 52. In step S4011, the node 52 deletes the activity record (including the data of the number of steps) stored in the EEPROM 27 in response to the command for deleting the record, which is received from the host 48.

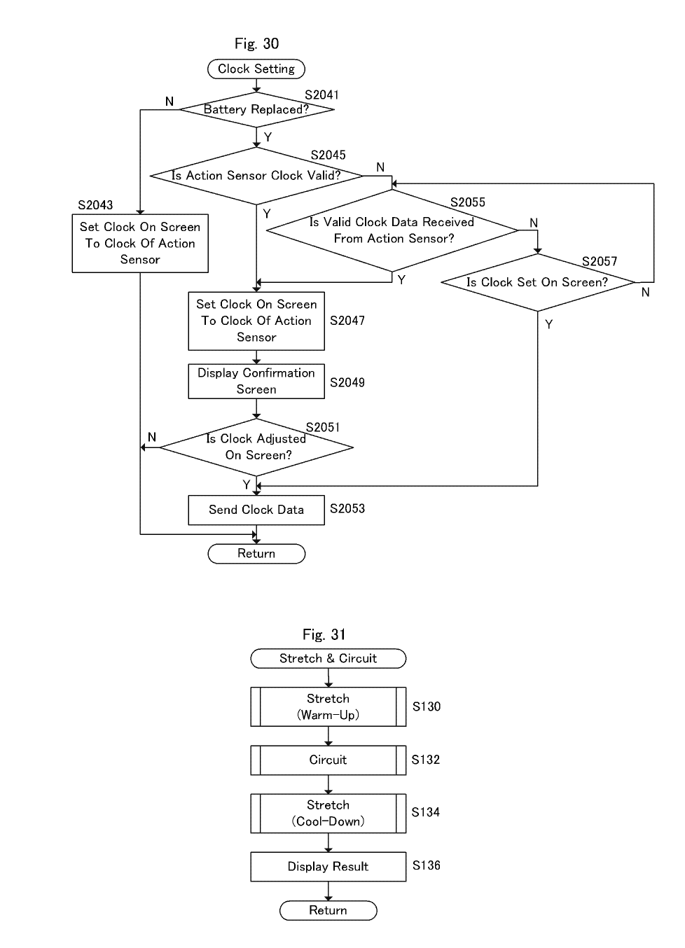

FIG. 30 is a flow chart showing a process for setting the clock in step S2017 of FIG. 29. Referring to FIG. 30, in step S2041, the processor 13 refers to the battery flag, and determines whether or not the battery of the action sensor 6 is replaced, the process proceeds to step S2043 if it is not replaced, conversely the process proceeds to step S2045 if it is replaced. In step S2043, the processor 13 sets its own clock (i.e., the clock to be displayed on the television monitor 5) to the date and time as transmitted by the action sensor 6 in steps S4005 and S4007 of FIG. 29.

In step S2045, the processor 13 determines whether or not the information of the date and time as transmitted by the action sensor 6 indicates the initial value, if it indicates the initial value, the process determines that the information of the date and time from the action sensor 6 is invalid, and proceeds to step S2055, conversely, if it indicates the value other than the initial value, the process regards that the information of the date and time from the action sensor 6 is valid, and proceeds to step S2047.

Incidentally, as described above, even when the battery of the action sensor 6 is demounted, since the RTC 56 is driven during a certain time by the capacitor 62 of FIG. 20, the correct information of the date and time is sent from the action sensor 6 during the certain time. Accordingly, in this case, “YES” is determined in step S2045.

In step S2047, the processor 13 sets its own clock to the date and time of the action sensor 6 because it is regarded that the information from the action sensor 6 is valid. In step S2049, the processor 13 displays a confirmation screen of the clock on the television monitor 5. In step S2051, the processor 13 determines whether or not the clock is adjusted on the confirmation screen by the operation of the action sensor 6 by the user 9, the process returns if it is not adjusted, conversely the process proceeds to step S2053 if it is adjusted. In step S2053, the processor 13 transmits the clock data (date and time) as adjusted to the action sensor 6 via the antenna unit 24, and then returns. Then, the action sensor 6 sets its own clock to the date and time as received from the processor 13.

In step S2055 after “NO” is determined in step S2045, the processor 13 determines whether or not the valid clock data (date and time) is received from the action sensor 6, the process proceeds to step S2047 if it is received, otherwise the process proceeds to step S2057.

Incidentally, even if the battery of the action sensor 6 is demounted and thereby the clock data is invalid, the user 9 can input the date and time to the action sensor 6. Accordingly, in this case, “YES” is determined in step S2055.

In step S2057 after “NO” is determined in step S2055, the processor 13 determines whether or not the clock of the processor 13 is set on the screen of the television monitor 5 by the operation of the action sensor 6 by the user 9, the process returns to step S2055 if it is not set, conversely the process proceeds to step S2053 if it is set. In step S2053, the processor 13 transmits the clock data (date and time) as set to the action sensor 6 via the antenna unit 24, and then returns. Then, the action sensor 6 sets its own clock to the date and time as received from the processor 13.

Incidentally, the user 9 can set the clock of the processor 13 on the screen of the television monitor 5 by operating the action sensor 6. Accordingly, in this case, “YES” is determined in step S2057.

By the way, in the clock setting in step S115 of FIG. 28, when the user 9 sets the clock of the processor 13 on the screen of the television monitor 5, the clock data is sent to the action sensor 6, and the clock of the action sensor 6 is set to the clock of the processor 13.

Also, the MCU 52 of the action sensor 6 stores the battery flag in the internal RAM. When the battery is mounted and the power supply voltage is supplied, the MCU 52 sets the battery flag stored in the internal RAM to “1”. However, if the battery is demounted, the data stored in the internal RAM is instantaneously deleted, then, when the battery is mounted again, the battery flag stored in the internal RAM is set to the initial value “0”. Accordingly, it is possible to determine on the basis of the battery flag whether or not the battery of the action sensor 6 is demounted.

By the way, returning to FIG. 28, when the login is performed in step S100, in step S101, the processor 13 displays an item selection screen for selecting an item. The user 9 manipulates the switch section 50 to select the intended item on the item selection screen. In the present embodiment, the prepared items are an item “Logout”, an item “Daily record”, an item “Entire record”, an item “Exercise”, an item “Measurement”, an item “Use information amendment”, and an item “System setting”.

In step S102, the process of the processor 13 proceeds to any one of step S103, S105, S107, S109, S111, S113, and S115 in accordance with the item as selected in step S101.

In step S103 after the item “Logout” is selected in step S101, the processor 13 displays an end screen (not shown in the figure) on the television monitor 5. This end screen includes the accumulated number of steps so far (the number of steps in the pedometer mode plus the number of steps as measured in step S109), and the walking distance as acquired by converting the accumulated number of steps into the distance. In this case, the walking distance is related to a route on an actual map and footprints are displayed on the map in order to express a sense of reality of the walking distance. The user 9 pushes the logout button on the end screen by manipulating the switch section 50, and instructs the processor 13 to logout. The processor 13 logouts in response to the instruction, transmits a command for shifting to the pedometer mode to the action sensor 6, and then returns to step S100. The action sensor 6 shifts to the pedometer mode in response to the command.

In step S105 after the item “Daily record” is selected in step S101, the processor 13 displays a screen which indicates the daily record on the television monitor 5, and returns to step S101. Specifically, at first, the processor 13 displays a screen including a calendar on the television monitor 5. The user 9 selects the desired date from the calendar by manipulating the switch section 50 of the action sensor 6. Then, the processor 13 displays a selection screen on the television monitor 5. This selection screen includes a button of “Movements of activity amount and step number” and a button of “Movement of vital sign”.

The user 9 selects the desired button by manipulating the switch section 50 of the action sensor 6. When the button of “Movements of activity amount and step number” is selected, the processor 13 displays a transition screen which represents the amount of the activity and the number of steps as accumulated so far using a bar graph on the television monitor 5. This transition screen changes over and displays a display for a week, a display for a day, or a display for an hour.

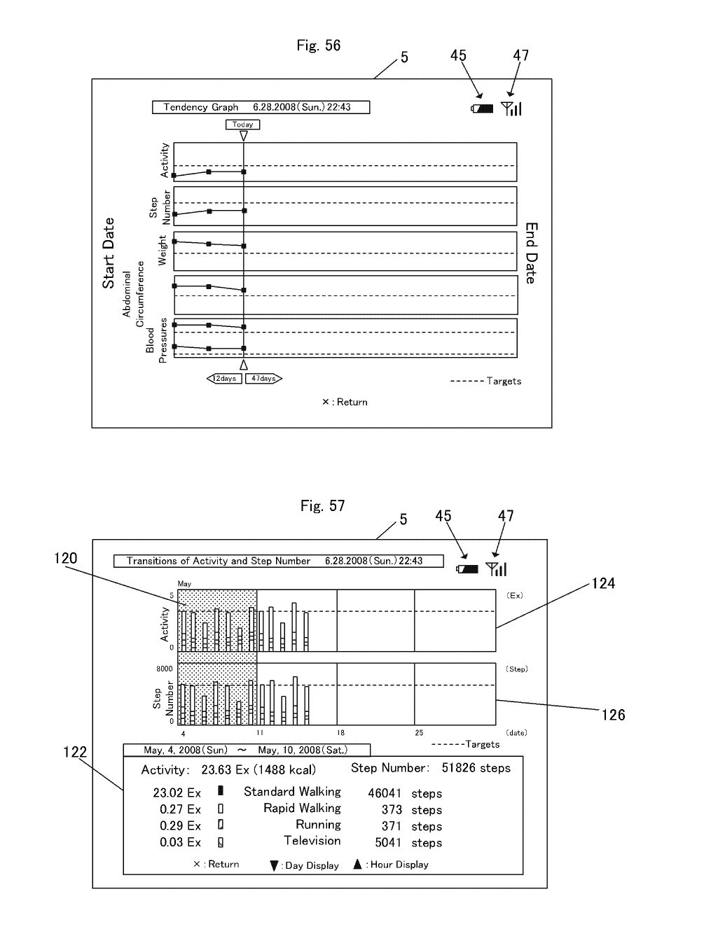

FIG. 57 is a view showing an example of the transition screen including a display for a week. Referring to FIG. 57, the processor 13 displays the transition screen on the television monitor 5. This transition screen includes an activity amount displaying section 124 which displays the amount of the activity during four weeks on a day-to-day basis using a bar graph, and a step number displaying section 126 which displays the number of steps during four weeks on a day-to-day basis using a bar graph.

Each bar of the bar graph in the activity amount displaying section 124 consists of four colors (color is omitted). The four colors correspond to the standard walking, the rapid walking, the running, and the television respectively. That is, the amount of the activity is displayed in different color for each of the standard walking, the rapid walking, the running, and the television. In this case, the term “television” here indicates the amount of the activity at the time when the user 9 exercises in step S109 of FIG. 28. The same is true of the bars of the bar graph of the step number displaying section 126.

Also, a cursor 120 is displayed over the activity amount displaying section 124 and the step number displaying section 120. This cursor 120 covers the activity amount displaying section 124 and the step number displaying section 120 for a week, and the data of the amount of the activity and the number of steps for a week, on which the cursor 120 is placed, is displayed on a data displaying section 122. The user 9 can move the cursor 120 at will by manipulating the arrow keys 18.

The user 9 manipulates the arrow keys 18 so that the cursor 120 covers the activity amount displaying section 124 and the step number displaying section 120 for a day, and thereby it is also possible to display the data of the amount of the activity and the number of steps for a day, on which the cursor 120 is placed, on the data displaying section 122.

Also, the user 9 manipulates the arrow keys 18, and thereby it is also possible to display the amount of the activity for a day on an hourly basis using a bar graph by the activity amount displaying section 124 and display the number of steps for a day on an hourly basis using a bar graph by the step number displaying section 126. In this case, the cursor 120 covers the activity amount displaying section 124 and the step number displaying section 120 for an hour, and thereby the data displaying section 122 displays the data of the amount of the activity and the number of steps for an hour, on which the cursor 120 is placed. Incidentally, another item may be optionally set as the item to be displayed.

By the way, on the other hand, when the user 9 manipulates the switch section 50 of the action sensor 6 and thereby the button of “Movement of vital sign” is selected, the processor 13 displays a vital sign screen which represents the record of the vital sign as accumulated so far using a line graph on the television monitor 5.

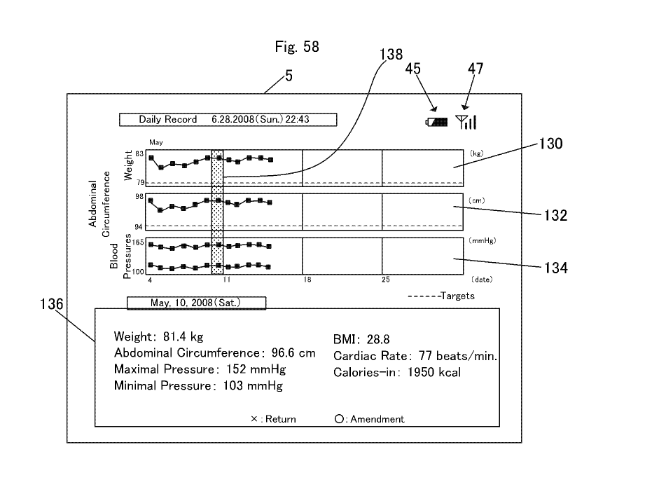

FIG. 58 is a view showing an example of the vital sign screen. Referring to FIG. 58, the vital sign screen includes an weight displaying section 130 which displays the body weight during four weeks on a day-to-day basis using a line graph, an abdominal circumference displaying section 132 which displays the abdominal circumference during four weeks on a day-to-day basis using a line graph, and a blood pressure displaying section 134 which displays the blood pressures during four weeks on a day-to-day basis using a line graph. Also, a cursor 138 is displayed over the weight displaying section 130, the abdominal circumference displaying section 132, and the blood pressure displaying section 134. This cursor 138 covers the weight displaying section 130, the abdominal circumference displaying section 132, and the blood pressure displaying section 134 for a day, and the data of the body weight, the abdominal circumference, and the blood pressures on the day, on which the cursor 120 is placed, is displayed on a data displaying section 136. The user 9 can move the cursor 138 at will by manipulating the arrow keys 18. Incidentally, another item may be optionally set as the item to be displayed.

Returning to FIG. 28, in step S107 after the item “Entire record” is selected in step S101, the processor 13 displays a screen which represents the entire record on the television monitor 5, and then returns to step S101. A tendency graph screen, a record management screen, and a screen for indicating an achievement rate of reduction are prepared as the screens which represent the entire record. The user 9 can switch among these displays by manipulating the switch section 50 of the action sensor 6.

FIG. 56 is a view showing an example of the tendency graph screen. Referring to FIG. 56, the processor 13 can display the tendency graph screen on the television monitor 5. This screen includes line graphs which indicate the movements of the amount of the activity, the number of steps, the body weight, the abdominal circumference, and the blood pressures during a period from when an weight-loss program is started until when it is finished. Incidentally, another item may be optionally set as the item to be displayed.

FIG. 55 is a view showing an example of the screen for indicating the achievement rate of reduction. Referring to FIG. 55, the processor 13 can display the screen for indicating the achievement rate of reduction on the television monitor 5. This screen for indicating the achievement rate of reduction includes a targeted body weight, a present body weight, and an achievement rate of weight loss. Also, it includes an actual value and a remaining targeted value of weight loss. Further, this screen for indicating the achievement rate of reduction includes a targeted abdominal circumference, a present abdominal circumference, and an achievement rate of reduction of the abdominal circumference. Also, it includes an actual value and a remaining targeted value of the reduction of the abdominal circumference.

Incidentally, although the figure is omitted, the record management screen includes a record management table. The record management table is a table which assembles the main record such as the vital information, the amount of the activity, and the number of steps for each day.

Returning to FIG. 28, in step S109 after the item “Exercise” is selected in step S101, the processor 13 performs the processing for exercising the user 9, and returns to step S101. The detail of this processing will be described below.

In step S111 after the item “Measurement” is selected in step S101, the processor 13 selectively performs one of measurement of a cardiac rate, measurement of leg strength (an air sit test), measurement of physical strength, a physical strength age test, and brain training in response to the operation of the action sensor 6 by the user 9, and then returns to step S101. These processes are the same as the processing for the sub-contents in step S13 of FIG. 5, and therefore the description is omitted.

In step S113 after the item “Use information amendment” is selected in step S101, the processor 13 performs the process for amending the user information, and then returns to step S101.

Specifically, in step S113, in response to the operation of the action sensor 6 by the user 9, the processor 13 selectively performs the process for amending one of the basic information, the initial vital sign information, and the weight-loss program, which the user 9 inputs by manipulating the action sensor 6 at the time when the user registration is performed. The basic information includes a name, ID, an age, sex, and so on. The initial vital sign information includes a height, body weight, BMI (automatic calculation), an abdominal circumference, blood pressures, a cardiac rate, neutral fat, HDL, a blood glucose value, a stride, and so on. The weight-loss program includes a targeted body weight at the time when the program is finished, a targeted abdominal circumference at the time when the program is finished, a period of time until when the program is finished, the present average number of steps for a day, a ratio of exercise to a meal with regard to weight loss, and so on.

FIG. 53 is a view showing an example of a screen for amending the weight-loss program, which is performed in step S113 of FIG. 28. Referring to FIG. 53, the user 9 can amend the targeted body weight at the time when the program is finished, the targeted abdominal circumference, the period of time until the finish, the present average number of steps for a day, and the ratio of weight loss (the ratio of the body activity to the meal) on the amending screen by operating the action sensor 6. Then, on the basis of these values as inputted and the currently registered body weight, the processor 13 computes the targeted amount (Ex and kcal) of activity for a week, the targeted amount (Ex and kcal) of activity for a day, and the targeted number of steps, which the user 9 should consume by doing exercise in order to attain the goal. Also, the processor 13 displays the targeted energy (kcal) for a week and for a day, which the user 9 should reduce by the meal in order to attain the goal.

Incidentally, the input screen similar to the amending screen is displayed also when the user registration is performed, and thereby the user 9 sets the weight-loss program at first.

Returning to FIG. 28, in step S115 after the item “System setting” is selected in step S101, the processor 13 performs the system setting, and then returns to step S101. Specifically, the processor 13 selectively performs one of the setting of the clock, the adjusting of the action sensor 6, and the sensor preview. Incidentally, in the case where the user 9 feels a feeling of strangeness relating to the detection by the action sensor 6, the user 9 can adjust the action sensor 6. The feeling of strangeness includes a phenomenon where the number of steps is not counted rightly in playing, a phenomenon where the character displayed on the television monitor 5 makes the motion different from his/her own motion, and so on. Also, the user 9 can check the sensitivity of the action sensor 6 by the sensor preview.

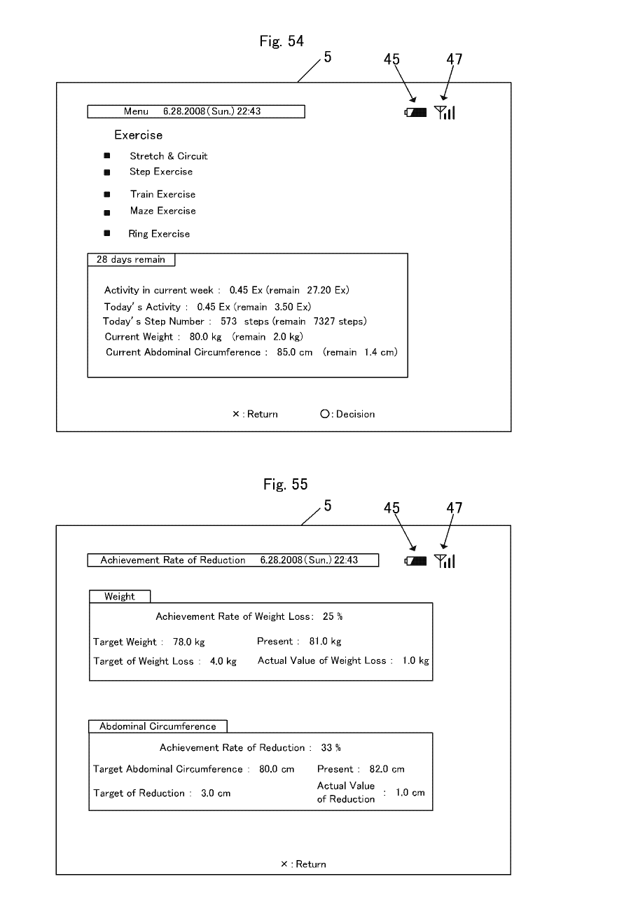

By the way, next, the detail of the exercise processing, which is performed in step S109 of FIG. 28, will be described. In step S109, the processor 13 displays the menu screen of FIG. 54 on the television monitor 5 at first. This screen includes an item “stretch & circuit”, an item “step exercise”, an item “train exercise”, an item “maze exercise”, and an item “ring exercise”. When the user 9 selects the desired item by manipulating the action sensor 6, the processor 13 performs the processing corresponding to the selected item.

Also, the processor 13 displays the number of days until when the weight-loss program is finished on the menu screen. Also, the processor 13 displays the attained amount of the activity for the current week and the amount of the activity until reaching the goal of the current week, the attained amount of the activity today and the amount of the activity until reaching the goal of today, the number of steps today and the remaining number of steps until reaching the goal, the difference between the present body weight and the targeted body weight, and the difference between the present abdominal circumference and the targeted abdominal circumference, on the screen. These targeted values is computed on the basis of the latest targeted values of the body activity, which are calculated in the input screen of the weight-loss program at the time of the user registration, or the amending screen of FIG. 53.

The processes of the “stretch & circuit”, the “step exercise”, the “train exercise”, the “maze exercise”, and the “ring exercise” in the second embodiment are the same as the processes of the “stretch & circuit”, the “step exercise”, the “train exercise”, the “maze exercise”, and the “ring exercise” in the first embodiment.

Accordingly, referring to FIGS. 7 to 18 as necessary, in what follows, the details of the “stretch & circuit”, the “step exercise”, the “train exercise”, the “maze exercise”, and the “ring exercise” will be described in sequence.

FIG. 31 is a flow chart showing the process of the stretch & circuit mode, which is performed in the exercise process of step S109 of FIG. 28. Referring to FIG. 31, in step S130, the processor 13 performs the process for making the user 9 perform the stretching exercises for warm-up (e.g., FIG. 7). In step S132, the processor 13 performs the process for making the user 9 perform the circuit exercises (e.g., FIG. 8). In step S134, the processor 13 performs the process for making the user 9 perform the stretching exercises for cool-down (e.g., FIG. 7). In step S136, the processor 13 displays a result screen including the amount of the activity as performed in the present stretch & circuit mode, and then returns.

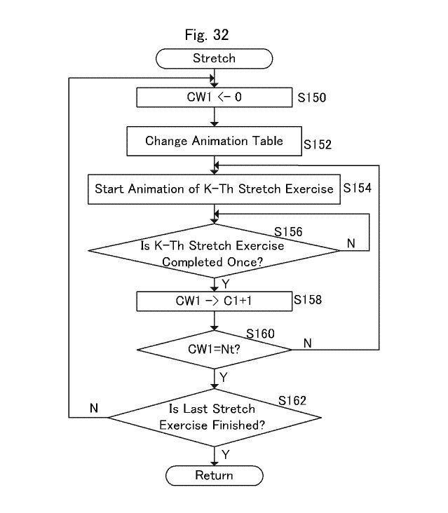

FIG. 32 is a flow chart showing the stretch process, which is performed in step S130 of FIG. 31. Referring to FIG. 32, in step S150, the processor 13 assigns 0 to a counter CW1, which counts the number of times of the K-th stretching exercises performed by the trainer character 43. In step S152, the processor 13 changes (sets) an animation table. The animation table is a table for controlling an animation of the trainer character 43 which performs the stretching exercise, and is prepared for each kind of the stretching exercises. In step S154, in accordance with the animation table changed (set) in step S152, the processor 13 starts the animation of the trainer character 43 which performs the K-th stretching exercise.

In step S156, the processor 13 determines whether or not the K-th stretching exercise is finished once, the process returns to step S156 if it is not finished, conversely, the process proceeds to step S158 if it is finished. In step S158, the processor 13 increments the counter CW1 by one. In step S160, the processor 13 determines whether or not the counter CW1 is equal to a predetermined value Nt, i.e., whether or not the K-th stretching exercise is performed Nt times, the process returns to step S154 if it is not equal to the predetermined value Nt, conversely, if it is equal to the predetermined value Nt, since the stage of the K-th stretching exercise is finished, the process proceeds to step S162. In step S162, the processor 13 determines whether or not the last stretching exercise is finished, the process returns if it is finished, otherwise the process proceeds to step S150 so as to perform the process for the (K+1)-th stretching exercise.

Incidentally, the process in step S134 of FIG. 31 is similar to the process in step S130 (the process of FIG. 32) except that the animation of the stretching exercise is changed so as to be suitable for cool-down. In passing, in step S130, the animation for the suitable stretching exercise for warm-up is performed.

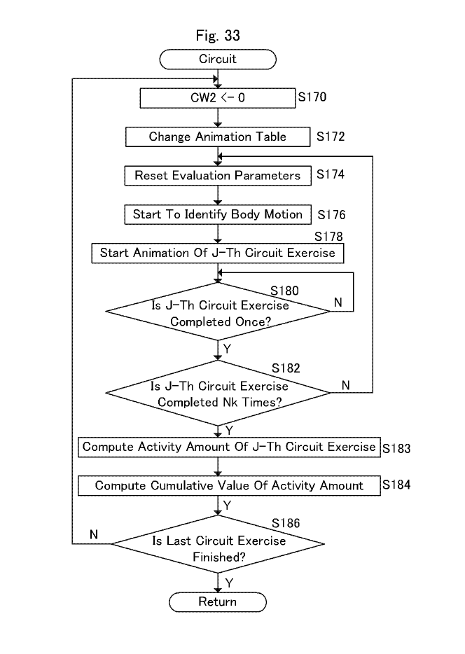

FIG. 33 is a flow chart showing the circuit process, which is performed in step S132 of FIG. 31. Referring to FIG. 33, in step S170, the processor 13 assigns 0 to a counter CW0, which counts the number of times of the J-th circuit exercises performed by the user 9. In step S172, the processor 13 changes (sets) an animation table. The animation table is a table for controlling an animation of the trainer character 43 which performs the circuit exercise, and is prepared for each kind of the circuit exercises.

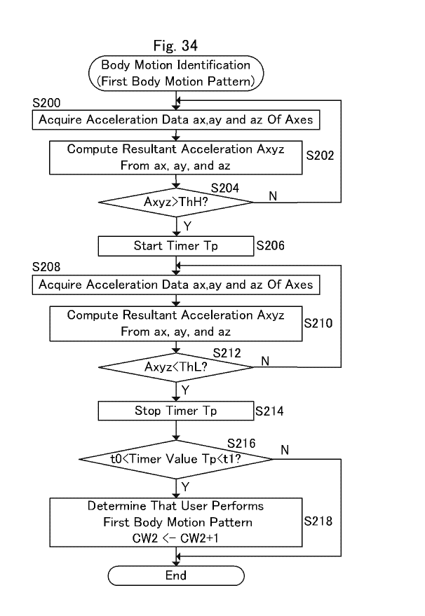

In step S174, the processor 13 resets evaluation parameters (values of various timers Tp, Tp1 to Tp3, Ti, Ti1, and Ti2) which are used in the processes of FIGS. 34 to 39 as described below. In step S176, the processor 13 starts to identify the motion of the user 9 depending on the circuit exercise which the trainer character 43 performs. In this case, the motion of the user 9 is identified using the method for identifying body motion as described in FIGS. 14(a) to 14(e).

In step S178, in accordance with the animation table changed (set) in step S172, the processor 13 starts the animation of the trainer character 43 which performs the J-th circuit exercise. In step S180, the processor 13 determines whether or not the animation of the J-th circuit exercise is finished once, the process returns to step S180 if it is not finished, conversely, the process proceeds to step S182 if it is finished.

In step S182, the processor 13 determines whether or not the J-th circuit exercise is completed Nk times, the process returns to step S174 if it is not completed, conversely, if it is completed, the process proceeds to step S183. In step S183, the processor 13 computes the amount of the activity in the J-the circuit exercise. Specifically, the amount of the activity per once is preliminarily obtained for each kind of the circuit exercises. And, the amount EXU of the activity of the user 9 which has performed the circuit exercises is obtained by multiplying the amount of the activity per once by the number of times of the corresponding circuit exercises (the value of the counter CW2). In step S184, the processor 13 obtains the latest cumulative value by adding the amount EXU of the activity obtained in step S183 to the cumulative value AEX of the amount of the activity obtained during the current circuit process (AEX<-AEX+EXU).

In step S186, the processor 13 determines whether or not the animation of the last circuit exercise is finished, the process proceeds to step S170 so as to perform the animation of the (J+1)-th circuit exercise if it is not finished, conversely, the process returns if it is finished.

Returning to FIG. 31, in step S136, the processor 13 displays the result screen including the cumulative value AEX of the amount of the activity in step S184 just before “YES” is determined in step S186. Incidentally, the amount of the activity of the user 9 as performed in the stretching processes in step S130 and S134 is added to the cumulative value AEX in the circuit process, and the result thereof may be displayed. In this case, the amount of the activity is computed under the assumption that the user 9 has performed the stretching exercise as displayed on the television monitor 5. However, it is not regarded that the stretching exercise as skipped by the user 9 has been performed by the user 9. Incidentally, the user 9 can skip the animation of the trainer character 43 which is displayed on the television monitor 5 and performs the circuit exercise by manipulating the action sensor 6.

FIG. 34 is a flow chart showing the process for identifying the body motion (the first body motion pattern of FIG. 14(a)), which is started in step S176 of FIG. 33. Referring to FIG. 34, in step S200, the processor 13 acquires the acceleration data ax, ay and az of the respective axes from the action sensor 6. In step S202, the processor 13 computes the resultant acceleration Axyz of the acceleration data ax, ay and az. In step S204, the processor 13 determines whether or not the resultant acceleration Axyz exceeds a threshold value ThH, the process proceeds to step S206 if it exceeds, otherwise the process returns to step S200

In step S206, the processor 13 starts a timer Tp for measuring the time Tp of FIG. 14(a). In step S208, the processor 13 acquires the acceleration data ax, ay and az of the respective axes from the action sensor 6. In step S210, the processor 13 computes the resultant acceleration Axyz of the acceleration data ax, ay and az. In step S212, the processor 13 determines whether or not the resultant acceleration Axyz is below a threshold value ThL, the process proceeds to step S214 if it is below, otherwise the process returns to step S208.

In step S214, the processor 13 stops the timer Tp. In step S216, the processor 13 determines whether or not the value of the timer Tp falls between a predetermined value t0 and a predetermined value t1, if it falls, it is determined that the user 9 has performed the circuit exercise (the first body motion pattern) instructed by the trainer character 43, the process proceeds to step S218, otherwise the process is terminated. In step S218, the processor 13 increments the counter CW2 by one, and terminates the process.

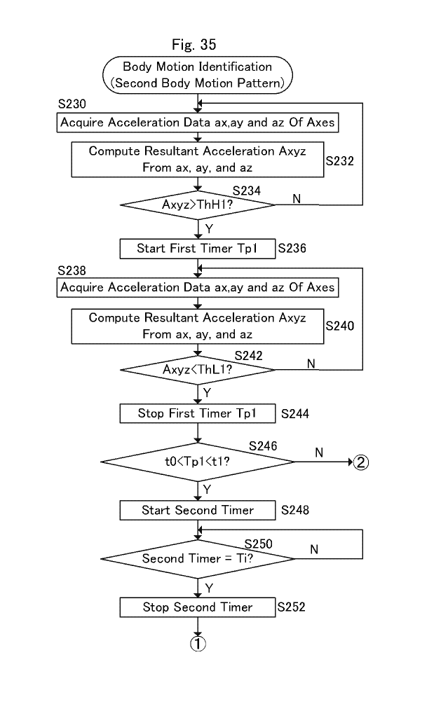

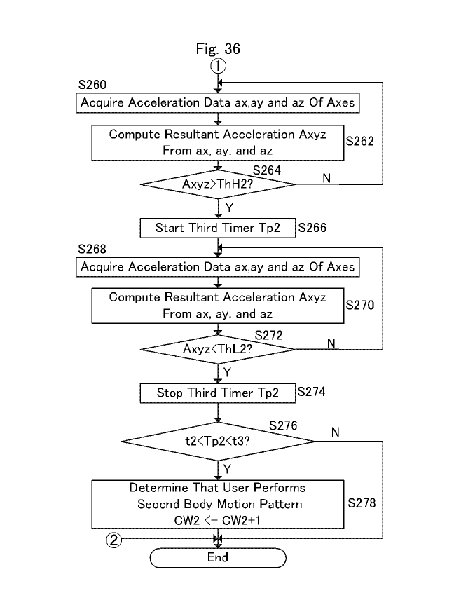

FIGS. 35 and 36 are flowcharts showing the process for identifying body motion (the second body motion pattern of FIG. 14(b)), which is started in step S176 of FIG. 33. Referring to FIG. 35, in step S230, the processor 13 acquires the acceleration data ax, ay and az of the respective axes from the action sensor 6. In step S232, the processor 13 computes the resultant acceleration Axyz of the acceleration data ax, ay and az. In step S234, the processor 13 determines whether or not the resultant acceleration Axyz exceeds a threshold value ThH1, the process proceeds to step S236 if it exceeds, otherwise the process returns to step S230.

In step S236, the processor 13 starts a first timer Tp1 for measuring the time Tp1 of FIG. 14(b). In step S238, the processor 13 acquires the acceleration data ax, ay and az of the respective axes from the action sensor 6. In step S240, the processor 13 computes the resultant acceleration Axyz of the acceleration data ax, ay and az. In step S242, the processor 13 determines whether or not the resultant acceleration Axyz is below a threshold value ThL1, the process proceeds to step S244 if it is below, otherwise the process returns to step S238.

In step S244, the processor 13 stops the first timer Tp1. In step S246, the processor 13 determines whether or not the value of the first timer Tp1 falls between a predetermined value t0 and a predetermined value t1, if it falls, the process proceeds to step S248, otherwise the process is terminated. In step S248, the processor 13 starts a second timer Ti for measuring the time T1 of FIG. 14(b). In step S250, the processor 13 determines whether or not the value of the second timer Ti is equal to a predetermined value Ti, the process proceeds to step S252 if it is equal, otherwise the process returns to step S250. In step S252, the processor 13 stops the second timer Ti, and then proceeds to step S260 of FIG. 36.

Referring to FIG. 36, in step S260, the processor acquires the acceleration data ax, ay and az of the respective axes from the action sensor 6. In step S262, the processor 13 computes the resultant acceleration Axyz of the acceleration data ax, ay and az. In step S264, the processor 13 determines whether or not the resultant acceleration Axyz exceeds a threshold value ThH2, the process proceeds to step S266 if it exceeds, otherwise the process returns to step S260.

In step S266, the processor 13 starts a third timer Tp2 for measuring the time Tp2 of FIG. 14(b). In step S268, the processor 13 acquires the acceleration data ax, ay and az of the respective axes from the action sensor 6. In step S270, the processor 13 computes the resultant acceleration Axyz of the acceleration data ax, ay and az. In step S272, the processor 13 determines whether or not the resultant acceleration Axyz is below a threshold value ThL2, the process proceeds to step S274 if it is below, otherwise the process returns to step S268.

In step S274, the processor 13 stops the third timer Tp2. In step S276, the processor 13 determines whether or not the value of the third timer Tp2 falls between a predetermined value t2 and a predetermined value t3, if it falls, it is determined that the user 9 has performed the circuit exercise (the second body motion pattern) instructed by the trainer character 43, the process proceeds to step S278, otherwise the process is terminated. In step S278, the processor 13 increments the counter CW2 by one, and terminates the process.

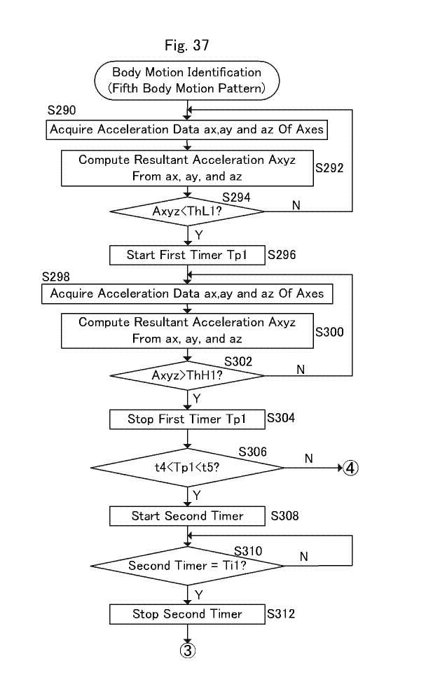

FIGS. 37 to 39 are flowcharts showing the process for identifying body motion (the fifth body motion pattern of FIG. 14(e)), which is started in step S176 of FIG. 33. Referring to FIG. 37, in step S290, the processor 13 acquires the acceleration data ax, ay and az of the respective axes from the action sensor 6. In step S292, the processor 13 computes the resultant acceleration Axyz of the acceleration data ax, ay and az. In step S294, the processor 13 determines whether or not the resultant acceleration Axyz is below a threshold value ThL1, the process proceeds to step S296 if it is below, otherwise the process returns to step S290.

In step S296, the processor 13 starts a first timer Tp1 for measuring the time Tp1 of FIG. 14(e). In step S298, the processor 13 acquires the acceleration data ax, ay and az of the respective axes from the action sensor 6. In step S300, the processor 13 computes the resultant acceleration Axyz of the acceleration data ax, ay and az. In step S302, the processor 13 determines whether or not the resultant acceleration Axyz exceeds a threshold value ThH1, the process proceeds to step S304 if it exceeds, otherwise the process returns to step S298.

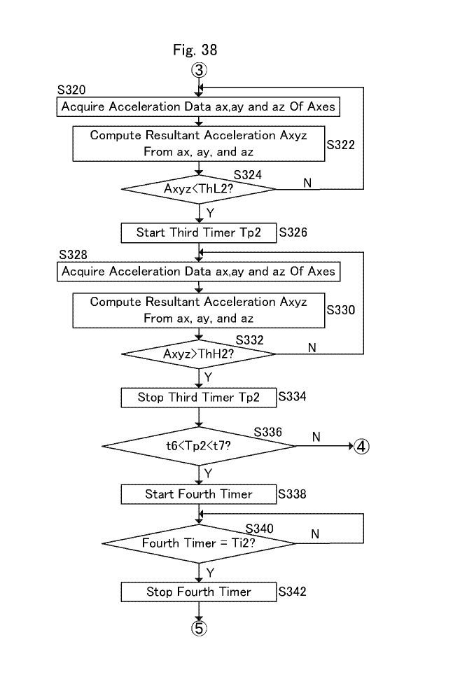

In step S304, the processor 13 stops the first timer Tp1. In step S304, the processor 13 determines whether or not the value of the first timer Tp1 falls between a predetermined value t4 and a predetermined value t5, if it falls, the process proceeds to step S308, otherwise the process is terminated. In step S308, the processor 13 starts a second timer Ti1 for measuring the time Ti1 of FIG. 14(e). In step S310, the processor 13 determines whether or not the value of the second timer Ti1 is equal to a predetermined value Ti1, the process proceeds to step S312 if it is equal, otherwise the process returns to step S310. In step S312, the processor 13 stops the second timer Ti1, and then proceeds to step S320 of FIG. 38.

Referring to FIG. 38, in step S320, the processor acquires the acceleration data ax, ay and az of the respective axes from the action sensor 6. In step S322, the processor determines whether or not it is below, the process proceeds to step S326 if it is below, otherwise the process returns to step S320.

In step S326, the processor 13 starts a third timer Tp2 for measuring the time Tp2 of FIG. 14(e). In step S328, the processor 13 acquires the acceleration data ax, ay and az of the respective axes from the action sensor 6. In step S330, the processor 13 computes the resultant acceleration Axyz of the acceleration data ax, ay and az. In step S332, the processor 13 determines whether or not the resultant acceleration Axyz exceeds a threshold value ThH2, the process proceeds to step S334 if it exceeds, otherwise the process returns to step S328.

In step S334, the processor 13 stops the third timer Tp2. In step S336, the processor 13 determines whether or not the value of the third timer Tp2 falls between a predetermined value t6 and a predetermined value t7, if it falls, the process proceeds to step S338, otherwise the process is terminated.

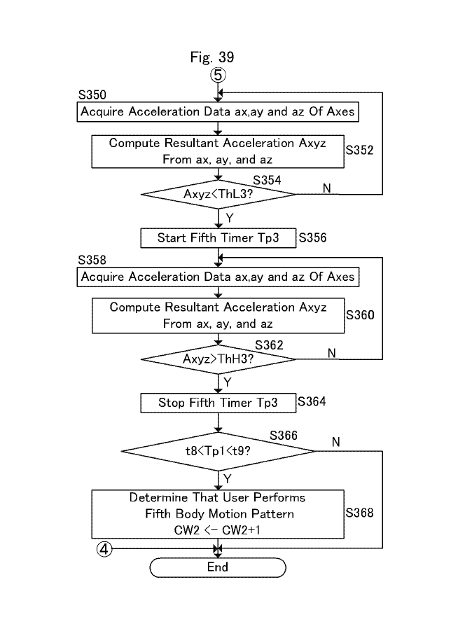

In step S338, the processor 13 starts a fourth timer Ti2 for measuring the time Ti2 of FIG. 14(e). In step S340, the processor 13 determines whether or not the value of the fourth timer Ti2 is equal to a predetermined value Ti2, the process proceeds to step S342 if it is equal, otherwise the process returns to step S340. In step S342, the processor 13 stops the fourth timer Ti2, and then proceeds to step S350 of FIG. 39.

Referring to FIG. 39, in step S350, the processor acquires the acceleration data ax, ay and az of the respective axes from the action sensor 6. In step S352, the processor 13 computes the resultant acceleration Axyz of the acceleration data ax, ay and az. In step S354, the processor 13 determines whether or not the resultant acceleration Axyz is below a threshold value ThL3, the process proceeds to step S356 if it is below, otherwise the process returns to step S350.

In step S356, the processor 13 starts a fifth timer Tp3 for measuring the time Tp3 of FIG. 14(e). In step S358, the processor 13 acquires the acceleration data ax, ay and az of the respective axes from the action sensor 6. In step S360, the processor 13 computes the resultant acceleration Axyz of the acceleration data ax, ay and az. In step S362, the processor 13 determines whether or not the resultant acceleration Axyz exceeds a threshold value ThH3, the process proceeds to step S364 if it exceeds, otherwise the process returns to step S358.

In step S364, the processor 13 stops the fifth timer Tp3. In step S366, the processor 13 determines whether or not the value of the fifth timer Tp3 falls between a predetermined value t8 and a predetermined value t9, if it falls, it is determined that the user 9 has performed the circuit exercise (the fifth body motion pattern) instructed by the trainer character 43, the process proceeds to step S368, otherwise the process is terminated. In step S368, the processor 13 increments the counter CW2 by one, and terminates the process.

By the way, the process flow of the process for identifying body motion (the third body motion pattern of FIG. 14(c)), which is started in step S176 of FIG. 33, is similar to that of the flowcharts of FIGS. 35 and 36. However, when identifying the third body motion pattern of FIG. 14(c), the processes of steps S248 to S252 are not performed, and the process proceeds to step S260 if “YES” is determined in step S246.

Also, the process flow of the process for identifying body motion (the fourth body motion pattern of FIG. 14(d)), which is started in step S176 of FIG. 33, is similar to that of the flowcharts of FIGS. 37 to 39. However, when identifying the fourth body motion pattern of FIG. 14(d), the processes of steps S338 to S366 are not performed, and the process proceeds to step S368 if “YES” is determined in step S336.

By the way, next, the detail of the “step exercise” will be described.

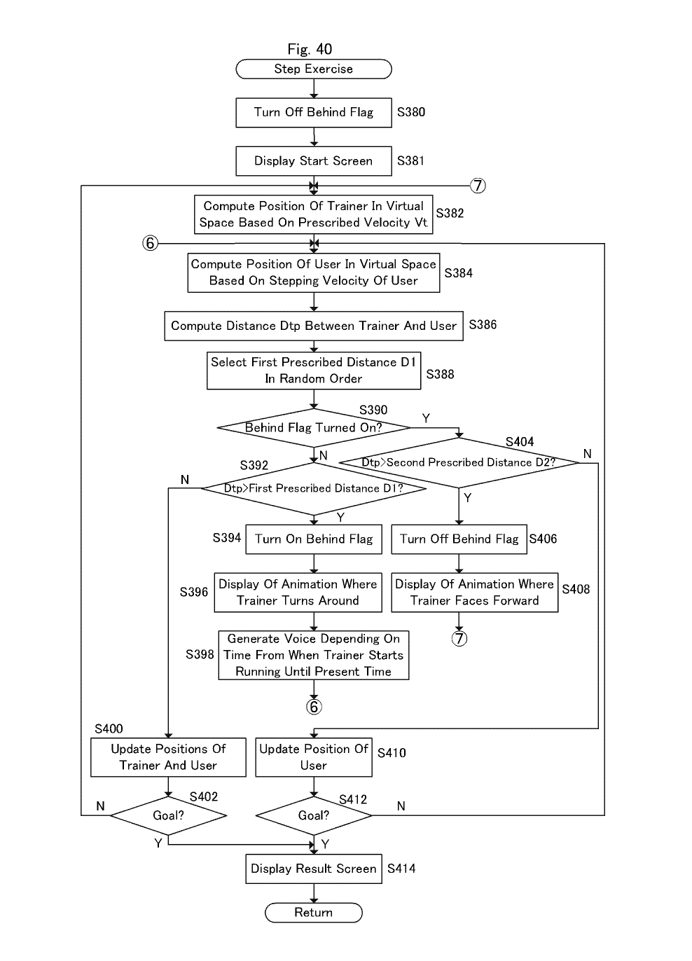

FIG. 40 is a flow chart showing the step exercise process, which is performed in the exercise process of step S109 of FIG. 28. Referring to FIG. 40, in step S380, the processor 13 turns off a behind flag. The behind flag is a flag which is turned on when a distance between a position of the user 9 in a virtual space and a position of the trainer character 43 is larger than a first predetermined distance D1 (>a second predetermined distance D2).

In step S381, the processor 13 displays the start screen of FIG. 9. In step S382, the processor 13 computes the position of the trainer character 43 in the virtual space on the basis of a predetermined velocity Vt. In step S384, the processor 13 computes the position of the user 9 in the virtual space on the basis of the velocity of the stepping of the user 9. In step S386, the processor 13 computes the distance Dtp between the trainer character 43 and the user 6 in the virtual space.

In step S388, the processor 13 determines the first predetermined distance D1 in a random manner. In step S390, the processor 13 determines whether or not the behind flag is turned on, the process proceeds to step S404 if it is turned on, conversely, the process proceeds to step S392 if it is turned off. In step S404, the processor 13 determines whether or not the distance Dtp is smaller than the second predetermined distance D2, if it is smaller, it is determined that the user 9 catches up with the trainer character 43 again, and the process proceeds to step S406, otherwise, it is determined that the user 9 is way behind the trainer character 43, and the process proceeds to step S410.

In step S406, the processor 13 turns off the behind flag. In step S408, the processor 13 displays the animation in which the trainer character 43 faces forward, and proceeds to step S382.

In step S392, the processor 13 determines whether or not the distance Dtp is larger than the first predetermined distance D1, if it is larger, it is determined that the user 9 is way behind the trainer character 43, and the process proceeds to step S394, otherwise, the process proceeds to step S400. In step S394, the processor 13 turns on the behind flag. In step S396, the processor 13 displays the animation in which the trainer character 43 turns around (e.g., FIG. 11). In step S398, the processor 13 generates voice depending on the time from the time when the trainer character 43 starts to run until the present time, and then proceeds to step S384.

The determination of “NO” in step S392 means that the user 9 stomps in accordance with the pace led by the trainer character 43, and in step S400, the processor 13 updates the positions of the trainer character 43 and the user 9 in the virtual space on the basis of the results of steps S382 and S384 (e.g., FIG. 10). In step S402, the processor 13 determines whether or not the user 9 reaches the finishing line, the process proceeds to step S382 if he/she does not reach, conversely, the process proceeds to step S414 if he/she reaches.

In step S410 after “NO” is determined in step S404, the processor 13 updates the position of the user 9. In step S412, the processor 13 determines whether or not the user 9 reaches the finishing line, the process proceeds to step S384 if he/she does not reach, conversely, the process proceeds to step S414 if he/she reaches.

In step S414 after “YES” is determined in step S402 or S412, the processor 13 displays the result screen including the amount of the activity as performed during the current step exercise, and then returns.

By the way, next, the detail of the “train exercise” will be described.

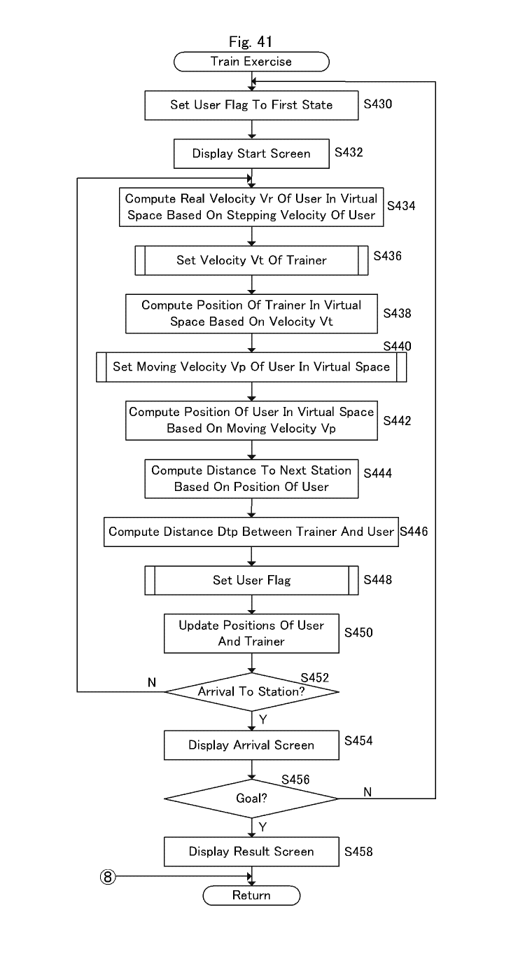

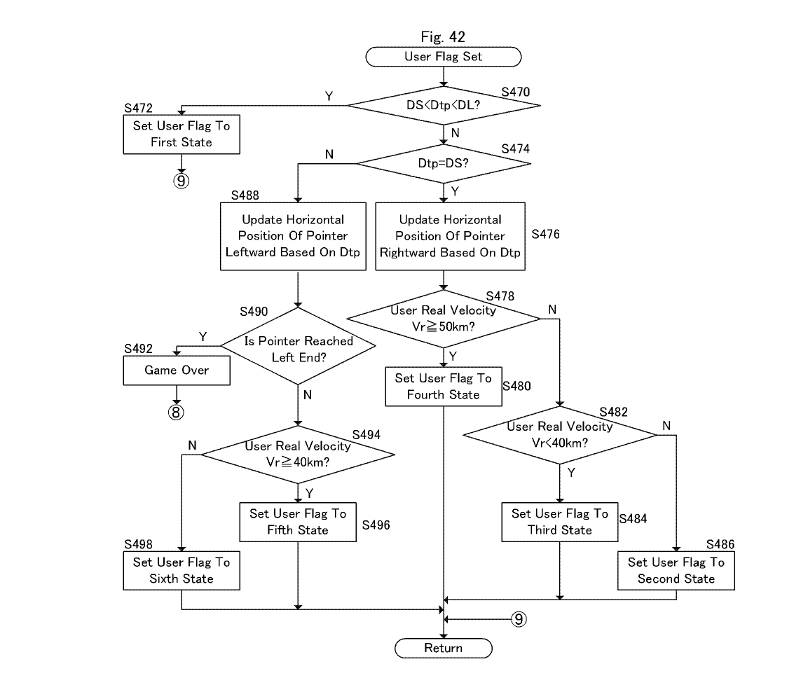

FIG. 41 is a flowchart showing the train exercise process, which is performed in the exercise process of step S109 of FIG. 28. Referring to FIG. 41, in step S430, the processor 13 sets a user flag to a first state. The user flag is a flag which indicates a state of the user 9, and will be described in detail in FIG. 42.

In step S432, the processor 13 displays the start screen of FIG. 12. In step S434, the processor 13 computes a real velocity Vr of the user 9 in the virtual space on the basis of the velocity of the stepping of the user 9. The real velocity Vr is proportional to the velocity of the stepping of the user 9. On the other hand, a moving velocity Vp as described below is a moving velocity of the user 9 in the virtual space, i.e., a velocity for a display, is not necessarily consistent with the real velocity Vr, and may be determined depending on the relation with the trainer character 43.

In step S436, the processor 13 sets the velocity Vt of the trainer character 43 in accordance with the content of the user flag. In step S438, the processor 13 computes the position of the trainer character 43 in the virtual space on the basis of the velocity Vt.

In step S440, the processor 13 sets the moving velocity Vp of the user 9 in the virtual space in accordance with the content of the user flag. In step S442, the processor 13 computes the position of the user 9 in the virtual space on the basis of the moving velocity Vp.

In step S444, the processor 13 computes the distance to the next station on the basis of the position of the user 9 in the virtual space. In step S446, the processor 13 computes the distance Dtp between the trainer character 43 and the user 6 in the virtual space on the basis of the results of steps S438 and S442. In step S448, the processor 13 sets the user flag on the basis of the real velocity Vr of the user 9, and the distance Dtp between the trainer character 43 and the user 6. In step S450, the processor 13 updates the positions of the trainer character 43 and the user 9 in the virtual space on the basis of the results of steps S438 and S442.

In step S452, the processor 13 determines whether or not the user 9 arrives at the station, the process proceeds to step S454 if he/she arrives, otherwise the process proceeds to step S434. In step S454, the processor 13 displays a screen as if the user 9 arrived at the station in the virtual space. In step S456, the processor 13 determines whether or not the user 9 reaches the finishing line (i.e., the last station), the process proceeds to step S458 if he/she reaches, otherwise, the process proceeds to step S430. In step S458, the processor 13 displays the result screen including the amount of the activity as performed during the current train exercise, and then returns.

FIG. 42 is a flow chart showing the process for setting the user flag, which is performed in step S448 of FIG. 41. Referring to FIG. 42, in step S470, the processor 13 determines whether or not the distance Dtp between the trainer character 43 and the user 9 is larger than a predetermined value DS and moreover is smaller than a predetermined value DL, the process proceeds to step 472 if it falls therebetween, conversely, the process proceeds to step S474 if it does not falls therebetween. In step S472, the processor 13 sets the user flag to the first state, and then returns. In this case, DS<DL. The predetermined value DS is a distance when the ropes 58 are slackest. The predetermined value DL is a distance when the ropes 58 are strained as shown in FIG. 13.

In step S474, the processor 13 determines whether or not the distance Dtp is equal to the predetermined value DS, the process proceeds to step S476 if it is equal, otherwise, i.e., if the distance Dtp is equal to DL, the process returns to step S488.

In the case where “NO” is determined in step S470 and “YES” is determined in step S474, the case means that the distance Dtp is equal to the predetermined value DS. Accordingly, in step S476, the processor 13 changes the horizontal position of the pointer 66 of the mood meter 61 to the right direction depending on the real velocity Vr. In this case, as the real velocity Vr is smaller, the moving distance is smaller, and as the real velocity Vr is larger, the moving distance is larger. On the other hand, in the case where “NO” is determined in steps S470 and S474, the case means that the distance Dtp is equal to the predetermined value DL. Accordingly, in step S488, the processor 13 changes the horizontal position of the pointer 66 of the mood meter 61 to the left direction depending on the real velocity Vr. In this case, as the real velocity Vr is smaller, the moving distance is larger, and as the real velocity Vr is larger, the moving distance is smaller.

By the way, in step S478 after step S476, the processor 13 determines whether or not the real velocity Vr of the user 9 is 50 km or more, the process proceeds to step S480 if it is 50 km or more, otherwise, the process proceeds to step S482. In step S480, the processor 13 sets the user flag to the fourth state, and then returns. On the other hand, in step S482, the processor 13 determines whether or not the real velocity Vr of the user 9 is not 40 km or more, the process proceeds to step S484 if it is not 40 km or more, otherwise, the process proceeds to step S486. In step S486, the processor 13 sets the user flag to the second state, and then returns. On the other hand, in step S484, the processor 13 sets the user flag to the third state, and then returns.

In step S490 after in step S488, the processor 13 determines whether or not the pointer 66 reaches the left end and then one second elapses, the process proceeds to step S492 if it elapses, otherwise, the process proceeds to step S494. In step S492, the processor 13 displays a game over screen, and returns to step S101 of FIG. 28. On the other hand, in step S494, the processor 13 determines whether or not the real velocity Vr of the user 9 is 40 km or more, the process proceeds to step S496 if it is 40 km or more, otherwise, the process proceeds to step S498.

In step S496 after “YES” is determined in step S494, the processor 13 sets the user flag to the fifth state, and then returns. On the other hand, in step S498 after “NO” is determined in step S494, the processor 13 sets the user flag to the sixth state, and then returns.

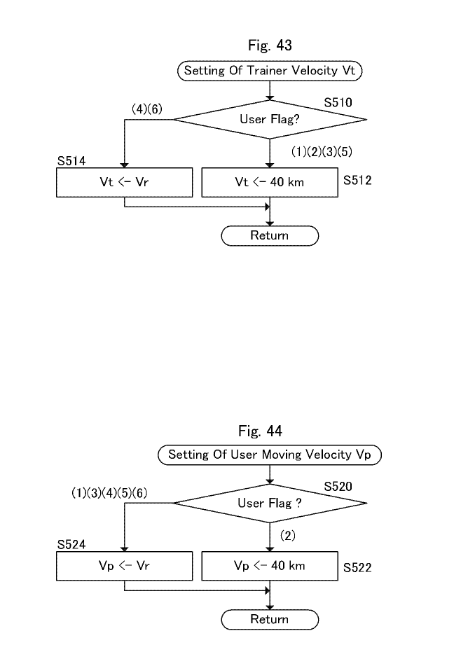

FIG. 43 is a flow chart showing the process for setting the velocity Vt of the trainer character 43, which is performed in step S436 of FIG. 41. Referring to FIG. 43, in step S510, the processor 13 proceeds to step S514 if the user flag is set to the fourth state or the sixth state, and proceeds to step S512 if the user flag is set to the first state, the second state, the third state, or the fifth state. In step S514, the processor 13 assigns the real velocity Vr of the user 9 to the moving velocity Vt of the trainer character 43, and then returns. On the other hand, in step S512, forty km is assigned to the moving velocity Vt of the trainer character 43, and then the return is performed.

FIG. 44 is a flow chart showing the process for setting the moving velocity Vp of the user 9, which is performed in step S440 of FIG. 41. Referring to FIG. 44, in step S520, the processor 13 proceeds to step S524 if the user flag is set to the first state, the third state, the fourth state, the fifth state, or the sixth state, and proceeds to step S522 if the user flag is set to the second state. In step S524, the processor 13 assigns the real velocity Vr of the user 9 to the moving velocity Vp of the user 9, and then returns. On the other hand, in step S522, forty km is assigned to the moving velocity Vp of the user 9, and then the return is performed.

Besides, as is obvious from the description of FIGS. 42 to 44, when the distance Dtp between the trainer character 43 and the user 9 falls between the predetermined value Ds and the predetermined value DL (the first state), the velocity Vt of the trainer character 43 is 40 km while the moving velocity Vp of the user 9 is the real velocity Vr. When the distance Dtp is equal to the predetermined value DL and therefore the ropes 58 are strained, moreover if the real velocity Vr of the user 9 is not 40 km or more (the sixth state), the velocity Vt of the trainer character 43 is the real velocity Vr while the moving velocity Vp of the user 9 is the real velocity Vr. On the other hand, when the distance Dtp is equal to the predetermined value DL and therefore the ropes 58 are strained, moreover if the real velocity Vr of the user 9 is 40 km or more (the fifth state), the velocity Vt of the trainer character 43 is 40 km while the moving velocity Vp of the user 9 is the real velocity Vr. Also, when the distance Dtp is equal to the predetermined value DS and therefore the ropes 58 are slackest, moreover if the real velocity Vr of the user 9 is 50 km or more (the fourth state), the velocity Vt of the trainer character 43 is the real velocity Vr while the moving velocity Vp of the user 9 is the real velocity Vr. On the other hand, when the distance Dtp is equal to the predetermined value DS and therefore the ropes 58 are slackest, moreover if the real velocity Vr of the user 9 is 40 km or more and is not 50 km or more (the second state), the velocity Vt of the trainer character 43 is 40 km while the moving velocity Vp of the user 9 is 40 km. Still, on the other hand, when the distance Dtp is equal to the predetermined value DS and therefore the ropes 58 are slackest, moreover if the real velocity Vr of the user 9 is not 40 km or more (the third state), the velocity Vt of the trainer character 43 is 40 km while the moving velocity Vp of the user 9 is the real velocity Vr.

By the way, next, the detail of the “maze exercise” will be described.

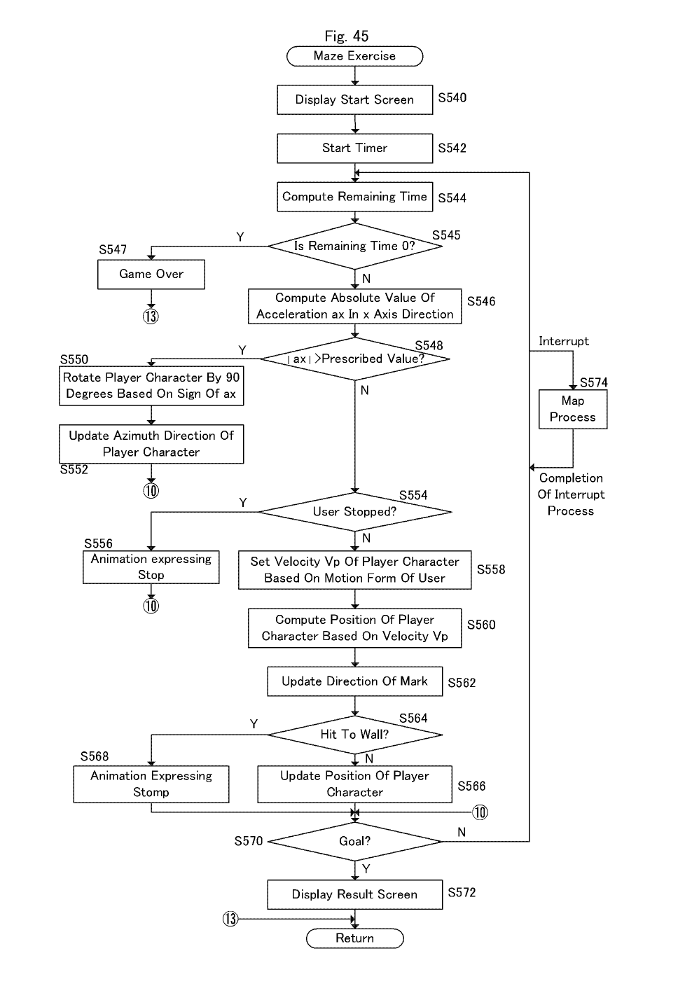

FIG. 45 is a flow chart showing the maze exercise process, which is performed in the exercise process of step S109 of FIG. 28. Referring to FIG. 45, in step S540, the processor 13 displays the start screen. In step S542, the processor 13 starts a timer. In step S544, the processor computes the remaining time of the maze exercise by referring to the timer, and updates the time displaying section 74. In step S545, the processor 13 determines whether or not the remaining time is 0, the process proceeds to step S547 if 0, otherwise proceeds to step S546. In step S547, since there is no remaining time, the processor 13 displays a screen representing the game over on the television monitor 5, and proceeds to step S101 of FIG. 28.

On the other hand, in step S546, the processor 13 computes the absolute value of the acceleration ax in the x direction of the action sensor 6. In step S548, the processor 13 determines whether or not the absolute value of the acceleration ax exceeds a predetermined value, if it exceeds, it is determined that the user 9 twists the body rightward or leftward, and the process proceeds to step S550, otherwise the process proceeds to step S554.

In step S550, the processor 13 rotates the player character 78 by 90 degrees depending on a sign of the acceleration ax. That is, the processor 13 rotates the player character 78 by 90 degrees leftward if the sign of the acceleration ax is positive. Also, the processor 13 rotates the player character 78 by 90 degrees rightward if the sign of the acceleration ax is negative. Incidentally, the direction of the player character 78 changes only in step S550. Accordingly, otherwise, the player character 75 goes straight ahead. In step S552, depending on the rotation in step S550, the processor 13 updates the azimuth direction displaying section 70 for indicating an azimuth direction in which the player character 78 heads, and proceeds to step S570.

In step S554 after “NO” is determined in step S548, the processor 13 determines whether or not the motion form flag indicating the motion form of the user 9 is set to “standstill”, the process proceeds to step S556 if it is set to “standstill”, otherwise the process proceeds to step S558. In step S556, the processor 13 displays the animation in which the player character 78 stops, and then proceeds to step S570.

In step S558, the processor 13 sets the velocity Vp of the player character 78 depending on the motion form of the user 9 (the standard walking, the rapid walking, or the running). Specifically, when the motion form of the user 9 is the standard walking, the value v0 is assigned to the velocity Vp. When the motion form of the user 9 is the rapid walking, the value v1 is assigned to the velocity Vp. When the motion form of the user 9 is the running, the value v2 is assigned to the velocity Vp. The relation thereof is v0<v1<v2. In step S560, the processor 13 computes the position of the player character 78 on the basis of the velocity Vp. In step S562, the processor 13 updates the direction of the mark 80 on the basis of the position of the player character 78 and the position of the goal.

In step S564, the processor 13 determines whether or not the player character 78 hits the wall of the maze 82, the process proceeds to step S568 if it hits, otherwise the process proceeds to step S566. In step S568, the processor 13 displays the animation in which the player character 78 hits the wall and stomps. On the other hand, in step S566, the processor 13 updates the position of the player character 78 in the virtual space on the basis of the result of step S560.

In step S570, the processor 13 determines whether or not the player character 78 reaches the goal, the process proceeds to step S572 if it reaches, otherwise the process returns to step S544. In step S572, the processor 13 displays a result screen including the amount of the activity as performed in the present maze exercise, and then returns.

Incidentally, when the user 9 pushes the decision button 14 of the action sensor 6, the interrupt is issued, in step S574, the processor 13 performs the process for displaying the map screen of FIG. 16. And, when the user 9 pushes the decision button 14 again, the former routine (the screen of FIG. 15) is performed again.

By the way, next, the detail of the “ring exercise” will be described.

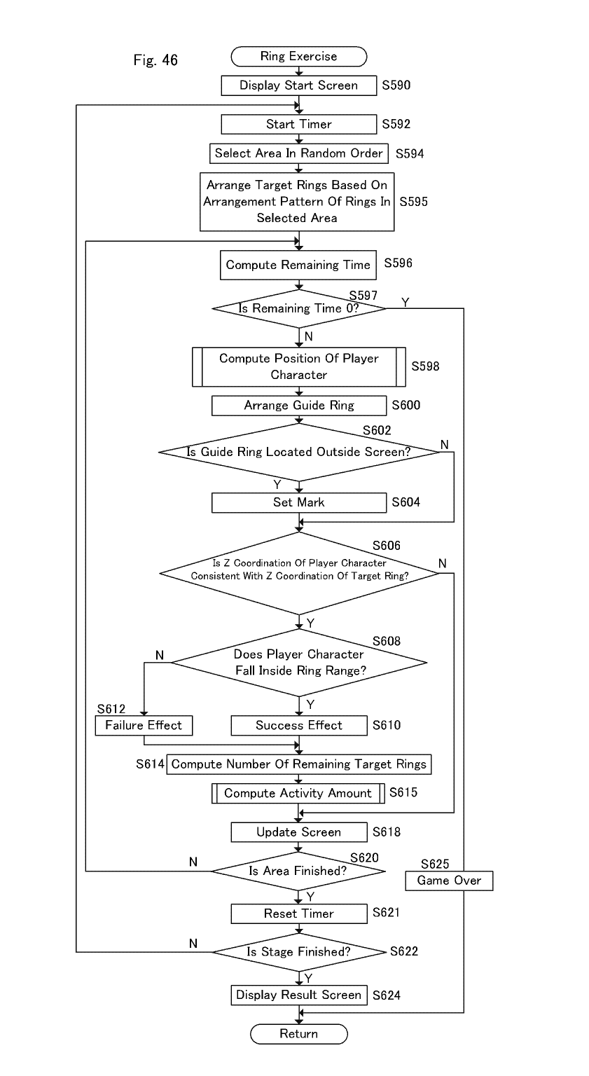

FIG. 46 is a flow chart showing the ring exercise process, which is performed in the exercise process of step S109 of FIG. 28. Referring to FIG. 46, in step S590, the processor 13 displays the start screen. In step S592, the processor 13 starts a timer. In step S594, the processor 13 selects an area in a random manner. In step S595, the processor 13 arranges the target rings 102 in the virtual space in accordance with the arrangement pattern of the target rings 102 in the selected area.

In step S596, the processor 13 computes the remaining time of this area by referring to the timer. In step S597, the processor 13 determines whether or not the remaining time of this area is 0, the process proceeds to step S625 if 0, otherwise proceeds to step S598. In step S625, since there is no remaining time, the processor 13 displays a screen representing the game over on the television monitor 5, and proceeds to step S101 of FIG. 28.

In step S598, the processor 13 computes the position of the player character 78 in the virtual space on the basis of the acceleration data of the action sensor 6. In step S600, the processor 13 arranges the guide ring 100. In this case, the X and Y coordinates of the guide ring 100 are the same as the X and Y coordinates of the target ring 102 through which the player character 78 next passes. Also, the X coordinate of the guide ring 100 is the same as the Z coordinate of the player character 78. In step S602, the processor 13 determines whether or not the guide ring 100 is located outside the screen, the process proceeds to step S604 if outside, otherwise the process proceeds to step S606. In step S604, the processor 13 sets the mark 104. In this case, the mark 104 is set so that it points to the target ring 102 through which the player character 78 next passes.

In step S606, the processor 13 determines whether or not the Z coordinate of the player character 78 is consistent with the Z coordinate of the target ring 102, the process proceeds to step S608 if it is consistent, otherwise the process proceeds to step S618. In step S608, the processor 13 determines whether or not the player character 78 falls inside the range of the target ring 102, the process proceeds to step S610 if it falls, otherwise the process proceeds to step S612.

In step S610, the processor 13 sets the success effect because the player character 78 successfully passes through the target ring 102. On the other hand, in step S612, the processor 13 sets the failure effect because the player character 78 can not pass through the target ring 102. In step S614, the processor 13 computes the number of the remaining target rings 102.

In step S615, the processor 13 computes the amount of the activity of the user 9 during the ring exercise. The specific description is as follows. Since the squat exercise is mainly performed in the ring exercise, the amount E of the activity is preliminarily obtained during the period when a subject performs the squat exercise. Simultaneously, the action sensor 6 is mounted on the subject, and thereby the acceleration ax, ay and az, i.e., the resultant acceleration Axyz in measuring the amount of the activity is recorded. Incidentally, it is assumed that the sampling frequency of the resultant acceleration Axyz in measuring the amount of the activity is M times. Also, for the purpose of defining the resultant acceleration Axyz for each sampling, the parenthesis is appended to the suffix position of the reference symbol Axyz and the sampling number is contained therein

And, the amount UE of the activity per unit resultant acceleration (hereinafter referred to as the “unit activity amount”) is preliminarily obtained using the following formula.

$$UE = E / {\sum }_{m = 1}^{M} Axyz ( m )$$

Then, the amount SE of the activity in sampling the resultant acceleration Axyz is obtained by multiplying the resultant acceleration Axyz as acquired successively during the ring exercise by the unit activity amount UE. And, the amount AE of the activity of the user 9 during the ring exercise is obtained by accumulating the amount SE of the activity every time the resultant acceleration Axyz is sampled (AE<-AE+SE).

However, for the purpose of eliminating noise other than the squat exercise as much as possible, if the resultant acceleration Axyz as acquired is below a predetermined value CMI, the resultant acceleration Axyz is excluded, and the amount SE of the activity is not computed on the basis of the resultant acceleration Axyz. Also, for a similar reason, if the resultant acceleration Axyz as acquired exceeds a predetermined value CMA, the clipping is performed, the value of the resultant acceleration Axyz is set to a predetermined value CMA (>CMI), and then the amount SE of the activity is computed. Incidentally, the probable minimum value and the probable maximum value of the resultant acceleration Axy in performing the squat exercise are empirically determined by measuring the resultant acceleration Axy in performing the squat exercise, and are assigned to the predetermined values CMI and CMA respectively.

After “NO” is determined in step S606 or after step S615, in step S618, the processor 13 updates the screen (FIGS. 17 and 18) to be displayed on the television monitor 5 in accordance with the results of steps S595, S598, S600, S604, S610, S612, S614 and S615.

In step S620, the processor 13 determines whether or not the area is finished, the process proceeds to step S621 if it is finished, otherwise the process returns to step S596. In step S621, the processor 13 resets the timer. And, in step S622, the processor 13 determines whether or not the stage is finished, the process proceeds to step S624 if it is finished, otherwise the process returns to step S592. In step S624, the processor 13 displays a result screen including the amount of the activity as performed in the present ring exercise (the final amount AE of the activity in step S615), and then returns.

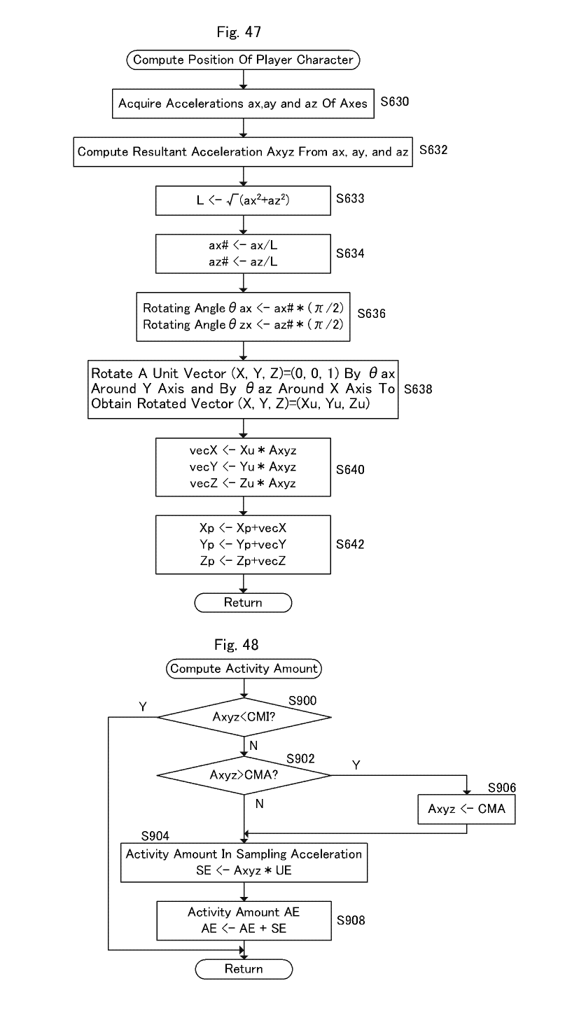

FIG. 47 is a flow chart showing the process for computing the location of the player character 78, which is performed in step S598 of FIG. 46. Referring to FIG. 47, in step S630, the processor 13 acquires the accelerations ax, ay and az of the respective axes from the acceleration sensor 29. In step S632, the processor 13 computes the resultant acceleration Axyz on the basis of the accelerations ax, ay and az (=√(ax²+ay²+az²)).

In step S632, the processor 13 computes the length (=√(ax²+az²)). In step S634, the processor 13 computes the normalized accelerations ax# (=ax/L) and az# (=az/L). In step S636, the processor 13 computes the rotating angles θax (=ax#*(π/2)) and θaz (=az#*(π/2)).

In step S638, the processor 13 rotates a unit vector (X, Y, Z)=(0, 0, 1) by θax around the Y axis and rotates the unit vector by θaz around the X axis, and obtains the unit vector after the rotation (X, Y, Z)=(Xu, Yu, Zu). In step S640, the processor 13 computes components vecX (=Xu*Axyz), vecY (=Yu*Axyz), and vecZ (=Zu*Axyz). In step S642, the processor 13 computes the position of the player character 78 (X, Y, Z)=(Xp, Yp, Zp) on the basis of the following formulae, and returns.

Xp<-Xp+VecX

Yp<-Yp+VecY

Zp<-Zp+VecZ

FIG. 48 is a flow chart showing the process for computing amount of activity, which is performed in step S615 of FIG. 46. Referring to FIG. 48, in step S900, the processor 13 determines whether or not the resultant acceleration Axyz is below the predetermined value CMI, the process returns without computing the amount of the activity if it is below, otherwise process proceeds to step S902. In step S902, the processor 13 determines whether or not the resultant acceleration Axyz exceeds the predetermined value CMA, the process proceeds to step S906 if it exceeds, otherwise process proceeds to step S904. In step S906, the processor 13 assigns the predetermined value CMA to the resultant acceleration Axyz.

After “NO” is determined in step S902, or after step S906, in step S904, the amount SE of the activity in sampling the acceleration is obtained by multiplying the resultant acceleration Axyz by the unit activity amount UE. Then, in step S908, the latest amount AE of the activity is obtained by adding the amount SE of the activity as computed in step S904 to the current amount AE of the activity. And, then, it returns.

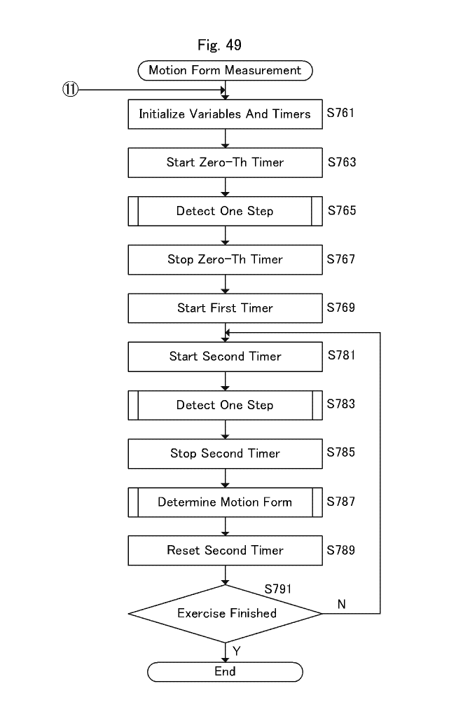

FIG. 49 is a flow chart showing the process for measuring the motion form, which is performed by the processor 13 of the cartridge 4 of FIG. 20. Referring to FIG. 49, the processes of steps S761 to S789 are similar to the processes of steps S1000 to S1013 of FIG. 21 respectively, and therefore the descriptions thereof are omitted. However, the process for determining the motion form in step S787 is different from that of FIG. 21, and therefore will be described below. Also, although the MCU 52 performs the processing in the process of FIG. 21, the processor 13 performs the processing in the process of FIG. 49. By the way, in step S791, the processor 13 determines whether or not the exercise is finished, the process is finished if it is finished, the process returns to step S781 if it is not finished.

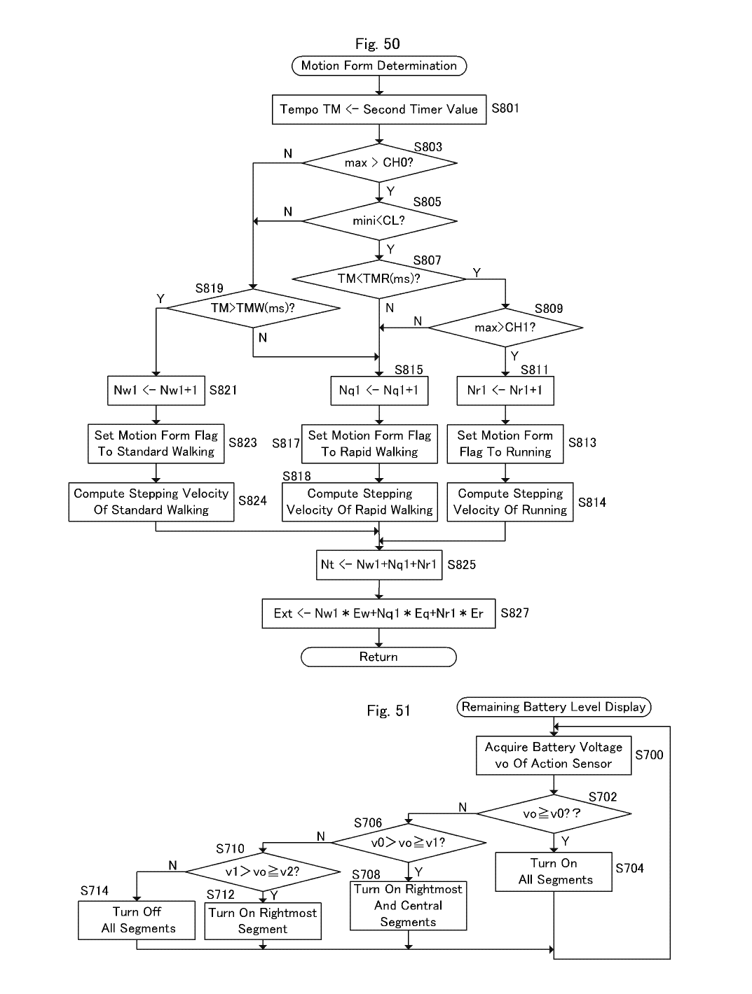

FIG. 50 is a flow chart showing the process for determining motion form, which is performed in step S787 of FIG. 49. Referring to FIG. 50, in step S801, the processor 13 assigns the value of the second timer, i.e., the time corresponding to one step to the tempo TM. The processes of steps S803, S805, S807, S809, S811, S813, S815, S817, S819, S821, and S823 are similar to the processes of steps S1161, S1163, S1165, S1167, S1169, S1171, S1173, S1175, S1177, S1179, and S1181 of FIG. 27 respectively, and therefore the descriptions thereof are omitted.

However, in step S811, the processor increments the counter Nr1 by one. In step S815, the processor increments the counter Nq1 by one. In step S821, the processor increments the counter Nw1 by one.

By the way, in step S814 after the motion form flag is set to the running in step S813, the processor 13 computes the velocity of the stepping of the user 9 on the basis of the probable stride in the case of the tempo TM and the running, and proceeds to step S825. Also, in step S818 after the motion form flag is set to the rapid walking in step S817, the processor 13 computes the velocity of the stepping of the user 9 on the basis of the probable stride in the case of the tempo TM and the rapid walking, and proceeds to step S825. Further, in step S824 after the motion form flag is set to the standard walking in step S823, the processor 13 computes the velocity of the stepping of the user 9 on the basis of the probable stride in the case of the tempo TM and the standard walking, and proceeds to step S825.

In step S825, the processor 13 assigns the sum of the values of the counters Nw1, Nq1, and Nr1 to the counter Nt which indicates the total number of steps where the motion forms are not distinguished. In step S827, the processor 13 computes a cumulative sum Ext of the amount of the activity during this exercise, and returns. The cumulative sum Ext is obtained from the following formula.

Ext<-Nw1*Ew+Nq1*Eq+Nr1*Er

Incidentally, in this formula, the “Ew” indicates the amount of the activity of one step in the standard walking, the “Eq” indicates the amount of the activity of one step in the rapid walking, and the “Er” indicates the amount of the activity of one step in the running.

Also, in the process for determining the motion form by the processor 13, the determination of the indetermination period and the going up and down is not performed because of the following reason. Because, in the step exercise, the train exercise, and the maze exercise, the processor 13 performs the processing on the condition that the user 9 performs the stepping on the spot, and the user performs the stepping in accordance with the video image on the television monitor 5 instead of performing the stepping by preference.

Incidentally, in each of steps S414 of FIG. 40, S458 of FIGS. 41, and S572 of FIG. 45, a result screen including the cumulative sum Ext of step S827 of FIG. 50 as computed in the each exercise is displayed on the television monitor 5. Also, the cumulative sum Ext and the number Nt of steps are displays on the screen of the each exercise in real time (e.g., the activity displaying section 76).

FIG. 51 is a flow chart showing a process for displaying a remaining battery level, which is performed by the processor 13 of the cartridge 4 of FIG. 20. Referring to FIG. 51, in step S700, the processor 13 acquires the value of the battery voltage vo from the action sensor 6. In step S702, the processor 13 determines whether or not the battery voltage vo is a predetermined value v0 or more, the process proceeds to step S5704 if it is the predetermined value v0 or more, otherwise the process proceeds to step S706. In step S704, the processor 13 turns on all of the segments of the remaining battery level displaying section 45, and then returns to step S700.

In step S706, the processor 13 determines whether or not the battery voltage vo is not the predetermined value v0 or more and moreover is the predetermined value v1 or more, the process proceeds to step S708 if “YES”, conversely, the process proceeds to step S710 if “NO”. In step S708, the processor 13 turns on the rightmost segment and the central segment of the remaining battery level displaying section 45, and then returns to step S700.

In step S710, the processor 13 determines whether or not the battery voltage vo is not the predetermined value v1 or more and moreover is the predetermined value v2 or more, the process proceeds to step S712 if “YES”, conversely, the process proceeds to step S714 if “NO”. In step S712, the processor 13 turns on the rightmost segment of the remaining battery level displaying section 45, and then returns to step S700. On the other hand, in step S714, the processor 13 turns off all of the segments of the remaining battery level displaying section 45, and then returns to step S700.

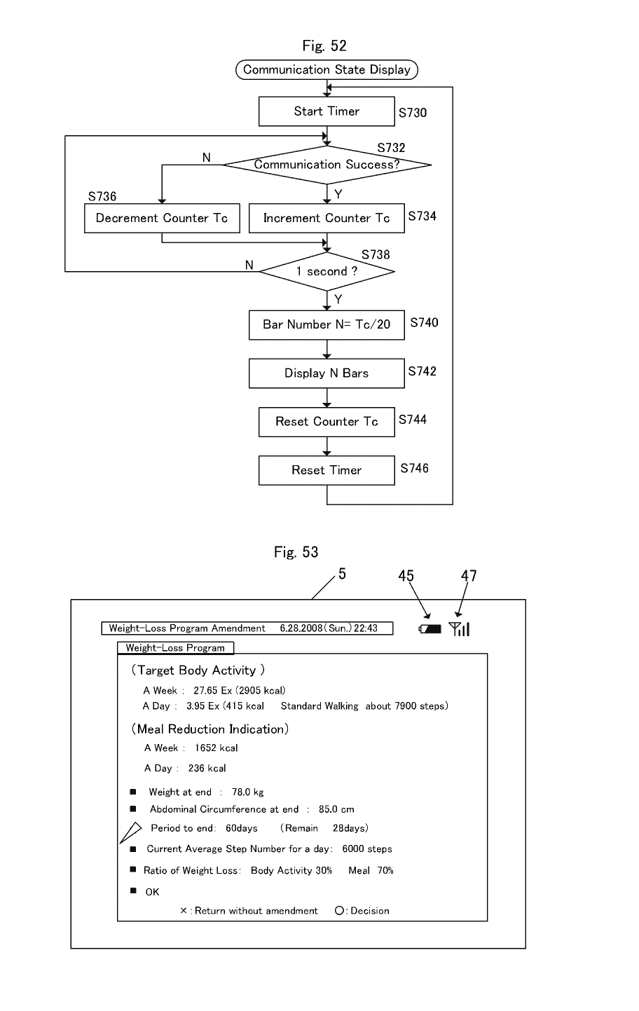

FIG. 52 is a flow chart showing a process for displaying state of communication, which is performed by the processor 13 of the cartridge 4 of FIG. 20. Referring to FIG. 52, in step S730, the processor 13 starts a timer. In step S732, the processor 13 determines whether or not the communication with the action sensor 6 is successful, the process proceeds to step S734 if it is successful, conversely, the process proceeds to step S736 if it is failed. In step S734, the processor 13 increments a counter Tc by one. On the other hand, in step S736, the processor 13 decrements the counter Tc by one.

In step S738, the processor 13 determines whether or not the timer advances by one second, the process returns to step S732 if it does not advance, conversely, the process proceeds to step S740 if it advances. In step S740, the processor 13 computes the number N (=Tc/20) of bars of the communication condition displaying section 47. In step S742, the processor 13 displays the N bars in the communication condition displaying section 47. In step S744, the processor 13 resets the counter Tc. In step S746, the timer is reset, and then the process returns to step S730.

By the way, first of all, advantage as the exercise supporting system will be described.

By the way, as described above, the action sensor 6 according to the present embodiment detects a physical quantity (the acceleration in the above example) in accordance with the motion of the user 9 in the three-dimensional space, and therefore can display information (the number of steps in the above example) based on the detected physical quantity on the LCD 35 as equipped therewith. Therefore, the action sensor 6 also functions as a stand-alone device (functions as a pedometer in the above example). That is, in the pedometer mode, it does not depend on the distance to an external device (the cartridge 4 in the above example), and singly functions independently of the external device. In addition to this function, in the communication mode, it is possible to input information (the acceleration in the above example) relating to a physical quantity as detected to an external device (the cartridge 4 in the above example) in real time, and provide the user 9 with various contents (representatively, the stretching exercise, the circuit exercise, the step exercise, the train exercise, the maze exercise, the ring exercise, and so on) using the images (representatively, FIGS. 7 to 13, FIGS. 15 to 18, and so on) in cooperation with the external device. In this case, the processor 13 of the cartridge 4 may control an image (representatively, FIGS. 15 to 18, and so on) on the basis of the information (the acceleration in the above example) relating to the physical quantity as received from the action sensor 6, or may also process the information relating to the physical quantity as received from the action sensor 6 in association with an image (representatively, FIGS. 7 to 13, and so on) which the processor 13 of the cartridge 4 controls without depending on the information relating to the physical quantity.

Also, the user 9 can also do exercise (walking or running) carrying only the action sensor 6 in the pedometer mode. On the other hand, in the communication mode, the user 9 can input a physical quantity (the acceleration in the above example) depending on the motion to an external device (the cartridge 4 in the above example) in real time by moving the body. That is, the action for inputting to the external device corresponds to an exercise in itself. In this case, the external device provides the user 9 with the various contents (representatively, the stretching exercise, the circuit exercise, the step exercise, the train exercise, the maze exercise, the ring exercise, and so on) using the images (representatively, FIGS. 7 to 13, FIGS. 15 to 18, and so on) in accordance with the input from the user 9. Accordingly, instead of moving the body excursively, the user 9 can do exercise while enjoying these contents.

As the result, while the exercise is done carrying only the action sensor 6 in the pedometer mode, it is possible to supplement the insufficient exercise therein with the action sensor 6 and the external device (the cartridge 4 in the above example) using the communication mode. Also, the opposite is true. In this way, it is possible to more effectively support attainment of a goal of the exercise by doing exercise in two stages.

By the way, generally, various exercises such as a stretching exercise and a circuit exercise have a goal, and it is required to adequately perform specified motion so as to effectively attain the goal. In this case, while an instruction indicates the motion by an image and so on, it is difficult for the user himself or herself to judge whether or not the user adequately performs the instructed motion.

However, in accordance with the present embodiment, it is possible to judge whether or not the user 9 performs the motion as instructed by the image, and therefore it is possible to show the result of the judgment to the user (representatively, the circuit exercise of FIG. 8). For this reason, the user can correct his/her motion by looking at the result, and adequately perform the instructed exercise. As the result, the user 9 can effectively attain the goal of the instructed exercise.

Also, in accordance with the present embodiment, since the acceleration information depending on the motion is transmitted from the action sensor 6 to the cartridge 4, the user 9 can control the moving image as displayed on the television monitor 5 (the traveling in the virtual space in the first person viewpoint in the step exercise and the train exercise of FIGS. 9 to 13, and the traveling of the player character 78 in the virtual space in the maze exercise and the ring exercise of FIGS. 15 to 18) by moving the body in the three-dimensional space. As the result, since the user 9 can do exercise while looking at the moving image which responds to the motion of his/her own body, the user 9 does not get bored easily in comparison with the case where the body is excursively moved, and it is possible to support the continuation of the exercise.

For example, the user 9 can control the player character 78 by moving the body (representatively, the maze exercise and the ring exercise). As the result, since the user 9 can do exercise while looking at the player character 78 which responds to the his/her motion, the user 9 does not get bored easily in comparison with the case where the body is excursively moved, and it is possible to support the continuation of the exercise.

Also, for example, the user 9 can look at such the video image as if actually moving in virtual space as displayed on the television monitor 5 by moving the body in the three-dimensional space (representatively, the step exercise, the train exercise, the maze exercise, and the ring exercise). That is, the user 9 can experience the event in the virtual space by simulation by moving the body. As the result, the tediousness is not felt easily in comparison with the case where the body is excursively moved, and it is possible to support the continuation of the exercise.

Especially, the user 9 can experience the maze 82 by simulation by doing the maze exercise. A maze game is well known and does not require knowledge and experience, and therefore many users 9 can easily enjoy the maze game using the action sensor 6 and the cartridge 4.

By the way, although a size of the virtual space is substantially infinite, a part thereof is just displayed on the television monitor 5. Accordingly, even if the user 9 tries to travel to a predetermined location in the virtual space, the user 9 can not recognize the location. However, in accordance with the present embodiment, since the mark 80, which indicates the direction of the goal of the maze as formed in the virtual space, is displayed, it is possible to assist the user 9 whose objective is to reach the goal of the maze 82 as formed in the huge virtual space (representatively, the maze exercise).

Further, in accordance with the present embodiment, the change of the direction in the virtual space is performed on the basis of the acceleration transmitted from the action sensor 6. Accordingly, the user 9 can intuitively change the direction in the virtual space only by changing the direction of the body to the desired direction (representatively, the maze exercise and the ring exercise).

By the way, generally, in the case where his/her own position is moved in the virtual space as displayed on the television monitor 5, it may be difficult for a person who is unused to a video game and so on for playing in the virtual space to get the feeling of the virtual space (e.g., his/her own position in the virtual space, the position relative to the other object in the virtual space, and so on). However, especially, the guide ring 100 is displayed in the ring exercise, and thereby it is possible to assist the user 9 so as to be appropriately able to move toward the target ring 102. As the result, even a person is unused to the virtual space, it is easily handled.

Still further, in accordance with the present embodiment, the user 9 can do the stepping exercise not at a subjective pace but at a pace of the trainer character 43, i.e., at an objective pace by doing the stepping exercise in accordance with the trainer character 43 (representatively, the step exercise and the maze exercise). In this case, it is determined that whether or not the user 9 appropriately carries out the stepping exercise which the trainer character 43 guides, and the result of the determination is shown to the user 9 via the television monitor 5 (in the above example, the voice of the trainer character 43 in the step exercise, and the mood meter 61 and the effect in the train exercise). For this reason, the user 9 can correct the pace of his/her stepping and so on by looking at the result, and stably do the stepping exercise.

Moreover, in accordance with the present embodiment, since the action sensor 6 is mounted on the torso or the head region, it is possible to measure not the motion of the part of user 9 (the motion of arms and legs) but the motion of the entire body.

Generally, since the arms and legs can be moved independently from the torso, even if the action sensors 6 are mounted on the arms and legs, it is difficult to detect the motion of the entire body, and therefore it is required to mount the action sensor 6 on the torso. However, although the head region can be moved independently from the torso, in the case where the torso is moved, the head region hardly moves by itself, and usually moves integrally with the torso, therefore, even when the action sensor 6 is mounted on the head region, it is possible to detect the motion of the entire body.

Also, in accordance with the present embodiment, since the amount of the activity of the user 9 is computed (step S615 of FIG. 46, and step S827 of FIG. 50), the user 9 can acquire his/her objective amount of the activity by showing it to the user 9 via television monitor 5.

Because of the above advantage, for example, the exercise supporting system according to the present embodiment can be utilized so as to prevent and improve a metabolic syndrome.

By the way, next, advantage focused on the process for measuring the motion form in FIGS. 21 and 49 will be described.

As described above, in accordance with the present embodiment, the MCU 52 and the processor 13 provisionally classifies the motion of the user 9 into any one of the plurality of the first motion forms (the walking and the running) at first. The reason is as follows.

In the present embodiment, the amount of the activity is calculated depending on the motion form of the user 9. The amount (Ex) of the activity is obtained by multiplying the intensity (METs) of the motion by the time (hour). The intensity of the motion is determined depending on the motion form. The motion form in this case is classified on the basis of the velocity. Accordingly, in the case where the amount of the activity is calculated depending on the motion form, it is preferred that the motion of the user 9 is finally classified on the basis of the velocity.

However, if the classification is performed using only the velocity, there is a possibility that the following inexpedience occurs. A specific example will be described. A stride and a time corresponding to one step are needed so as to obtain the velocity of the user. In general, the time corresponding to one step is shorter when walking, and is longer when running. On the other hand, in general, the stride decreases when walking, and increases when running. Accordingly, although he/she really runs, if the velocity is calculated on the basis of the stride in walking, the value thereof becomes small, and therefore it may be classified into the walking. On the other hand, although he/she really walks, if the velocity is calculated on the basis of the stride in running, the value thereof becomes large, and therefore it may be classified into the running.

Because of this, in the present embodiment, the motion of the user 9 is provisionally classified into any one of the plurality of the first motion forms (the walking and the running) on the basis of the magnitude of the acceleration (step S1161 and S1163, and steps S803 and S805). In this way, the stride can be set for each of the first motion forms. As the result, the above inexpedience does not occur, it is possible to appropriately classify the motion of the user 9 into any one of the plurality of the second motion forms (the standard walking, the rapid walking, and the running) in accordance with the velocity, and eventually it is possible to appropriately calculate the amount of the activity.

Also, in the present embodiment, the classifying process for the determination of the motion form is performed after it is determined that the motion corresponding to one step is performed (step S1007 and S1011 of FIG. 21, and steps S783 and S787 of FIG. 49). In this way, the motion corresponding to one step is separated from the noise before the classifying process. Accordingly, the process for eliminating the noise is not required in the classifying process, and therefore it is possible to simplify and speed up the classifying process. In passing, while the classifying process includes many determination processes, setting the determination of the noise after the first determination process aside, in the case where it is determined as the noise after the subsequent determination process, the determination process and the processing, which are performed till then, waste. In the present embodiment, it is possible to reduce these wasteful processes by eliminating the noise before the classifying process.

Further, in the present embodiment, since the MCU 52 and the processor 13 performs the classifying process on the basis of the maximum value “max” and the minimum value “min” of the resultant acceleration Axyz, it is possible to classify the motion of the user 9 into any one of the plurality of the first motion forms (the walking and the running) simply appropriately (step S1161 and S1163, and steps S803 and S805). Specifically, the MCU 52 and the processor 13 classifies the motion of the user 9 into the running when the amplitude of the resultant acceleration Axyz is larger, otherwise classifies into the walking.

Further, in the present embodiment, the MCU 52 and the processor 13 can classify the walking of the first motion form into either the standard walking or the rapid walking in more detail in accordance with the velocity of the user 9 (step S1177 and S819).

In this case, the MCU 52 can specify what kind of form (the going up and down in the above description) is further included in the standard walking on the basis of the magnitude (the “max” in the above description) of the resultant acceleration Axyz (step S1183).

In this case, it is possible to determine the going up and down because the motion of the user 9 is provisionally classified on the basis of the magnitude of the resultant acceleration Axyz in the stage before determining the going up and down (step S1161 and S1163 of FIG. 27), and then moreover is classified on the basis of the velocity of the user 9 (step S1177 and S1167 of FIG. 27). If the motion of the user 9 is classified using only the magnitude of the resultant acceleration Axyz, the going up and down can not be distinguished from the running.

Further, in the present embodiment, the MCU 52 and the processor 13 can classify the running of the first motion form into either the rapid walking/running or the rapid walking in more detail in accordance with the velocity of the user 9 (step S1165 and S807). In this case, after the motion of the user 9 is classified into the rapid walking/running, the MCU 52 and the processor 13 conclusively specifies to any one of the rapid walking and the running on the basis of the magnitude (the “max” in the above description) of the resultant acceleration Axyz (step S1167 and S809). Because, if the classifying process is performed only by the step S1165 of FIG. 27 or the step S807 of FIG. 50, there is a possibility of the classification into the running depending on a person despite the rapid walking really, and therefore the determination has to perform more certainly.

By the way, next, advantage focused on the process for calculating the amount of the activity in FIG. 48 will be described.

As described above, in the present embodiment, the amount SE of the activity in sampling the acceleration is obtained by multiplying the resultant acceleration Axyz of the user 9 as acquired by the amount of the activity per unit acceleration, i.e., the unit activity amount UE. And, the total amount AE of the activity of the user 9 during the accumulation period is calculated by accumulating the amount SE of the activity every time the acceleration is sampled.

In this way, by obtaining the amount SE of the activity and the amount AE of the activity of the user 9 on the basis of the unit activity amount UE, it is anticipated that it is possible to obtain the amount of the activity in which the motion of the user 9 is more directly reflected in comparison with the case of calculating the amount of the activity based on the number of steps (the case of calculating the amount of the activity of the user 9 by multiplying the number of steps by the amount of the activity per step). The reason is as follows.

It is assumed that the amount of the activity per step is set to one value. But, even when the attention is paid only upon the walking, the movements differ depending on respective steps or persons, or current conditions. Accordingly, when these are lumped together as the walking, even if the amount of the activity per step is multiplied the number of steps, the result is not necessarily a value in which the motion of the user is more directly reflected. Of course, if the walking is classified into one of the more forms and the amount of the activity per step is set for each form, it is possible to obtain the amount of the activity in which the motion of the user is reflected in more detail. However, there is a limit to the number of classifications, and it is difficult to reflect ways of walking and current conditions of respective persons. Although the user can input his/her own way of walking and the current condition, it is impractical.

By the way, the acceleration data of the action sensor 6 correlates with the motion of the user 9. That is, the motion of the user 9 is directly reflected in the acceleration. And, in the present embodiment, the amount of the activity is obtained on the basis of the acceleration data in which the motion of the user 9 is directly reflected. As the result, it is possible to obtain the amount of the activity in which the motion of the user 9 is more directly reflected.

### Third Embodiment

A configuration and behavior of an exercise supporting system in accordance with a third embodiment are similar to the configuration and the behavior of the exercise supporting system in accordance with the second embodiment. In what follows, the different points from the second embodiment will be mainly described.

In the second embodiment, in the case where the action sensor 6 is used alone, i.e., in the case of the pedometer mode, the action sensor 6 is used as a pedometer. However, in the third embodiment, in the case where the action sensor 6 is used alone, an automatic recording mode and a manual recording mode are established. In what follows, the detail will be described.

The action sensor 6 according to the third embodiment has the automatic recording mode and the manual recording mode as well as the communication mode (since it is the same as the second embodiment, the description is omitted). The automatic recording mode and the manual recording mode are modes in the case where the action sensor 6 functions alone. Accordingly, like the pedometer mode of the second embodiment, in the automatic recording mode and the manual recording mode, the action sensor 6 does not communicate with the cartridge 4, and functions independently.

The automatic recording mode is a mode in which the action sensor 6 records behavior information of the user 9 in association with date and time in the EEPROM 27 automatically.

In the present embodiment, the behavior information to be recorded in the automatic recording mode includes the motion form (the standard walking, the rapid walking, and the running) and the frequency (the number of steps) for each motion form. Accordingly, in the present embodiment, the automatic recording mode is the same as the pedometer mode of the second embodiment.

The manual recording mode is a mode in which the user 9 inputs and records his/her own behavior information and body information in the action sensor 6 by manipulating the switch section 50 of the action sensor 6. The action sensor 6 records the behavior information and body information as inputted by the user 9 in association with date and time in the EEPROM 27.

The behavior information to be recorded in the manual recording mode includes the motion form (the training contents such as the circuit training and weight training, the contents of the sports such as tennis, the movement of each part of the body, and the other contents and types of the body motion), the frequency for each motion form (e.g., the frequency of each body motion such as the number of times of weightlifting), the start and end for each motion form (e.g., the start and end of each body motion such as the start and end of the play of the tennis), and the other information relating to the behavior. However, the behavior information to be recorded in the manual recording mode does not include the behavior information to be recorded in the automatic recording mode.

Also, the behavior information to be recorded in the manual recording mode includes daily activity information. The daily activity information includes contents of housework such as cleaning, washing, and cooking, and information of a meal (kinds, contents, calories, and so on), information of carry, information of work, information of a school, information of a work trip and move (including a ride on a conveyance such as a car, a bicycle, a motorcycle, an electric train, an airplane, and a ship), an avocation, and so on, information of the number of times of them, information of start and end of them, and information of the other behavior and activity which naturally occur in daily life of an individual.

Further, the body information to be recorded in the manual recording mode includes body size information such as a height, an abdominal circumference and BMI, information of eyesight, information of intensity of daily activity, information of the inside of the body (information of urine, information of erythrocyte such as erythrocyte count, a body fat percentage, information of a hepatic function such as γ-GTP, information of fat metabolism such as HDL cholesterol and neutral fat, information of glucose metabolism such as a blood glucose value, a cardiac rate, and so on), and the other information representing condition of a body.

Incidentally, in the manual recording mode, the MCU 52 displays main input possible items on the LCD 35. And, the user 9 selects the desired item by operating the switch section 50 so as to input the information. Also, for example, the user 9 may arbitrarily register an input item by operating the switch section 50.

By the way, like the second embodiment, the action sensor 6 transmits the information recorded in the automatic recording mode and the manual recording mode to the cartridge 4 in the communication mode when the user 9 logins. The cartridge 4 stores the received information in the EEPROM 44. Also, the cartridge 4 responds to the operation of the action sensor 6 by the user 9, processes, converts, and visualizes the information as recorded in the EEPROM 44 properly, and supplies the television monitor 5 with the corresponding video signal VD. And, the television monitor 5 displays the video image corresponding to the received video signal VD.

Incidentally, the visualization means representing numerical information and character information in a viscerally easily understandable format using a graph, a table, and/or an illustration, or the like. In other words, the visualization means representing numerical information and character information in a format which contributes to a viscerally understanding thereof using a graph, a table, and/or an illustration, or the like. FIGS. 56 to 58 show the major examples of the visualization. Incidentally, as shown in FIGS. 54 and 55, even when only the numerals and characters are displayed, in the case where these are processed and converted to be displayed so that the user 9 is easier to understand, the case is included in the visualization.

By the way, in the above description, the behavior information to be recorded in the automatic recording mode is the information of the number of steps for each of the standard walking, the rapid walking, and the running. However, if information can be detected, measured, and computed by a sensor (a sensor such as the acceleration sensor 29 and a gyroscope) and a computer such as the MCU 52 as incorporated in the action sensor 6 regardless of the behavior information and the body information which can be recorded in the manual recording mode, the information may be the object of the record in the automatic recording mode. In this case, the information (item) which is the object of the record may be different or overlap between the automatic recording mode and the manual recording mode. For example, in the case of the overlap, the automatic recording of the overlapped information (item) is preliminarily set by default, and then the user 9 can select the manual recording thereof by operating the switch section 50. Also, the opposite is true. Further, the user 9 can also select each and every time.

Also, the object of the record in the manual recording mode is limited to the above ones. In this case, the object may be detectable, measurable, and computable, or may be undetectable, unmeasurable, and incomputable, by a sensor and a computer as incorporated in the action sensor 6. Because, the user 9 can input the information by himself/herself by operating the switch section 50.

By the way, as is obvious from that the cartridge 4 visualizes the information from the action sensor 6 to display on the television monitor 5 (the screens of FIGS. 53 to 58), this exercise supporting system has a characteristic as a health managing system, a lifestyle managing system, or a behavior managing system. It is easier to look at and operate the screen to display the result of the visualization on the large television monitor 5 than to display it on the small LCD 35. Of course, although the result of the visualization may be displayed on the LCD 35 of the action sensor 6, if portability is considered, there is a limit to enlargement of the LCD 35, and even if the enlargement is applied without detracting the portability, display capability thereof is more inferior than that of the television monitor 5. Also, it is usual to manage the health, the lifestyle, and the behavior in a personal residence than to manage them in the field.

The preferable example will be studied in view of user-friendliness and a characteristic as a managing system, and rationality of the whole system.

Terms to be used will be defined before concretely studying. Original data indicates physical quantity (e.g., the acceleration in the above example) which a sensor (e.g., the acceleration sensor 29 in the above example) detects and outputs, or information which the user 9 inputs in the manual recording mode. First-order processing means obtaining target data (first-order processed data (e.g., the number of steps in the above example)) by processing the original data. Second-order processing means obtaining target data (second-order processed data (e.g., the amount of the activity in the above example)) by processing the first-order processed data. If these is generalized, n-th-order processing (n is one or a larger integer) means obtaining target data (n-th-order processed data) by processing (n−1)-th-order processed data. However, in the generalized definition, zeroth-order processed data indicates the original data.

The term “sensor” here indicates a transducer for detecting physical quantity and converting it an electrical signal. The physical quantity indicates a physical phenomenon or a property inherent in a substance, which does not depend on a measurer.

A detailed study will be made in light of the definition. Although the original data can be recorded in the automatic recording mode, if reduction of memory capacity of the EEPROM 27 of the action sensor 6 is considered, as described above, it is preferable to record the first-order processed data obtained by the first-order processing of the original data in the EEPROM 27 than to record the original data whose data volume is relatively large. Also, it is preferable to record the first-order processed data and transmit it to the cartridge 4 in order to speed up the data communication with the cartridge 4 by reducing the volume of the transmission data. If the volume of the communication data is smaller, it is possible to reduce power consumption of the action sensor 6. Also, it is possible to further improve the function of the action sensor 6 in the automatic recording mode as a stand-alone device by applying the first-order processing to display the information which the user 9 can easily recognize.

And, it is preferred that the cartridge 4 performs the second or more-order processing (the high-order processing) of the data recorded in the automatic recording mode. Because, it is possible to suppress performance (arithmetic capacity) and power consumption of the MCU 52 of the action sensor 6 as much as possible. While the LCD 35 is required to relatively enlarge size and resolution thereof in order to perform the high-order processing and fully express the result, for the purpose of reducing the size and the resolution, it is preferred that the cartridge 4 performs the high-order processing.

Also, for a similar reason, in the manual recording mode, it is preferred that the input information from the user 9 is recorded as original data without applying the n-th-order processing and the cartridge 4 performs the n-th-order processing by sending the original data to the cartridge 4. In passing, the original data in the manual recording mode is inputted by the user 9, and the data volume thereof is considerably small in comparison with the output data from the sensor. For this reason, the first-order processing thereof is not required, unlike the output data form the sensor.

Further, in order to improve the portability of the action sensor 6, it is preferred that the size of the LCD 35 is smaller. Also, if the characteristic as the managing system is considered, there is no major reason why the action sensor 6 displays the result of the visualization, and therefore it is preferred that the size of the LCD 35 is smaller.

As described above, in view of the rationality of the whole system, and the user-friendliness and the characteristic as the managing system, as if the function of the action sensor 6 is suppressed as much as possible, there is rather no inexpedience, and it is possible to reduce a cost and improve the portability.

Incidentally, as is obvious from the above description, the action sensor 6 has the characteristic as a behavior recorder or a lifestyle recorder.

Next, the process flow will be described using flowcharts.

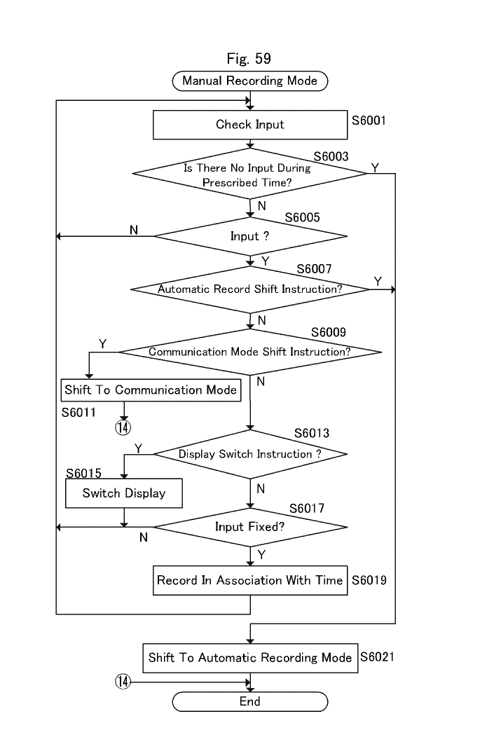

FIG. 59 is a flow chart showing the process in the manual recording mode of the action sensor 6 in accordance with the third embodiment of the present invention. Referring to FIG. 59, in step S6001, the MCU 52 checks an input from the switch section 50. Then, in step S6003, if there is no input during a predetermined time, the MCU 52 proceeds to step S6021 so as to shift to the automatic recording mode and end the processing, otherwise proceeds to step S6005. In step S6005, the MCU 52 proceeds to step S6007 if there is the input from the switch section 50, otherwise returns to step S6001.

In step S6007, the MCU 52 proceeds to step S6021 so as to shift to the automatic recording mode and finish the process when the input from the switch section 50 instructs to shift to the automatic recording mode, otherwise proceeds to step S6009. In step S6009, the MCU 52 proceeds to step S6011 so as to shift to the communication mode and finish the process when the input from the switch section 50 instructs to shift to the communication mode.

In step S6013, when the input from the switch section 50 instructs to switch the display of the LCD 35, the MCU 52 proceeds to step S6015 so as to switch the display of the LCD 35 in response to the input and then proceeds to step S6015, otherwise proceeds to step S6017. In step S6017, the MCU 52 proceeds to step S6019 when the input from the switch section 50 instructs to fix the input, otherwise proceeds to step S6001.

In step S6019, the MCU 52 stores information corresponding to the input from the switch section 50 (the behavior information and the body information: the original data) in association with date and time information from the RTC 56 in the EEPROM 27, and then proceeds to step S6001.

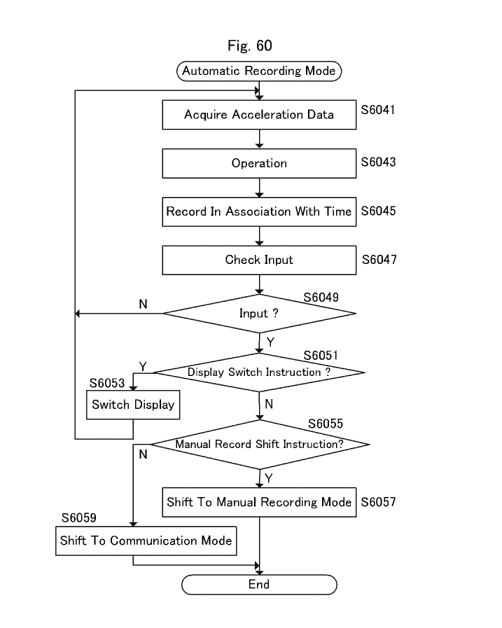

FIG. 60 is a flow chart showing the process in the automatic recording mode of the action sensor 6 in accordance with the third embodiment of the present invention. Referring to FIG. 60, in step S6041, the processor acquires the acceleration data ax, ay and az of the respective axes from the acceleration sensor 29. In step S6043, the processor 13 obtains the resultant acceleration Axyz and the number of steps for each motion form by applying the operation to the acceleration data ax, ay, and az. In step S6045, the MCU 52 stores the number of steps for each motion form (a kind of the behavior information: the first-order processed data) in association with date and time information from the RTC 56 in the EEPROM 27.

In step S6047, the MCU 52 checks an input from the switch section 50. In step S6049, the MCU 52 proceeds to step S6051 if there is the input from the switch section 50, conversely proceeds to step S6041 if there is no input. In step S6051, when the input from the switch section 50 instructs to switch the display of the LCD 35, the MCU 52 proceeds to step S6053 so as to switch the display of the LCD 35 in response to the input and then proceeds to step S6041, otherwise proceeds to step S6055. In step S6055, the MCU 52 proceeds to step S6057 so as to shift to the manual recording mode and finish the process when the input from the switch section 50 instructs to shift to the manual recording mode, otherwise, i.e., when the input from the switch section 50 instructs to shift to the communication mode, proceeds to step S6059 so as to shift to the communication mode and then finish the process.

Incidentally, the process in the communication mode of the action sensor 6, and the processes of the antenna unit 24 and the cartridge 4 according to the third embodiment are similar to that of the second embodiment, and therefore the description thereof is omitted. However, in step S4009 of FIG. 29, the MCU (node) 52 transmits the behavior information and the body information recorded in the EEPROM 27 in the manual recording mode as well as the behavior information recorded in the EEPROM 27 in the automatic recording mode to the host 48 and the processor 13.

By the way, as described above, in accordance with the present embodiment, the following advantage is gotten in addition to the advantage of the second embodiment.

In accordance with the present embodiment, since the action sensor 6 is portable, the user 9 can input and record the behavior information and the body information at any time and place which he/she desires. And, the recorded information is transmitted to the cartridge 4 and is visualized therein. In this case, since the record is associated with the time, it is possible to visualize time variation of the record. Accordingly, this is useful in the behavior management, the health management, the lifestyle management, or the like of the user 9.

Also, since the motion (the behavior information) of the user 9 is automatically detected and the result of the processing thereof is recorded in the automatic recording mode, it is possible to record the information difficult or impossible to input manually by the user 9. For example, this is suitable for recording the result (e.g., the number of steps) of the operation to the information (e.g., the acceleration) which is required to be measured and operated continually.

Further, in accordance with the more preferred example of the present embodiment, in the automatic recording mode, the action sensor 6 does not perform the second or more-order processing (the high-order processing). Accordingly, it is possible to suppress the arithmetic capacity and the power consumption of the action sensor 6 as much as possible. Also, while the LCD 35 is required to relatively enlarge size and resolution thereof in order to perform the high-order processing and fully express the result, since the action sensor 6 does not perform the high-order processing, it is possible to suppress the performance of the LCD 35. Also, since it is possible to miniaturize the size of the LCD 35, it is possible to improve the portability of the action sensor 6, and furthermore it is possible to reduce the power consumption thereof.

Still further, in accordance with the more preferred example of the present embodiment, the action sensor 6 records the input information (the behavior information and the body information) from the user 9 as the original data without applying the n-th-order processing thereto. As the result, it is possible to reduce the processing load and suppress the arithmetic capacity of the MCU 52 of the action sensor 6. In passing, the original data in this case is inputted by the user 9, and the data volume thereof is considerably small in comparison with the output data from the sensor. For this reason, the first-order processing thereof is not required, unlike the output data form the sensor.

Meanwhile, the present invention is not limited to the above embodiment, and a variety of variations may be effected without departing from the spirit and scope thereof, as described in the following modification examples.

(1) In the above description, the acceleration sensor 29 is implemented in the action sensors 6 and 11. However, in addition thereto, a gyroscope, which detects angular velocity, may be implemented therein. As the result, it is possible to detect a rotation and a direction, and thereby a method for utilization of the action sensors 6 and 11 as an input device expands. However, without incorporating the gyroscope, two acceleration sensors 29 may be incorporated so as to detect a rotation. Also, only the gyroscope may be incorporated in the action sensors 6 and 11. Further, the action sensor 6 may have the other motion sensor such as a direction sensor and an inclination sensor.

(2) The method for identifying the motion form of the user 9 is described using FIG. 4. This is an example, and therefore the motion form of the user 9 may be identified by the following method.

In the case where the resultant acceleration Axy increases from 1G, exceeds a threshold value ThH, and subsequently drops below a threshold value ThL, the pedometer 31 provisionally determines that the user 9 performs any one of the standard walking, the rapid walking, and the running. Then, the pedometer 31 computes the velocity of the user 9 on the basis of the time interval Tt between the successive maximum values of the resultant acceleration Axy and a predetermined stride. And, for example, the pedometer 31 classifies the motion of the user 9 into the standard walking if the velocity of the user 9 is not 6 km or more, classifies the motion of the user 9 into the running if the velocity of the user 9 is not 8 km or less, and classifies the motion of the user 9 into the rapid walking if the velocity of the user 9 is 6 km or more and moreover is 8 km or less. However, in the case where the motion of the user 9 is classified into the running, if an absolute value Am of a difference between 1G and the minimum value of the resultant acceleration Axyz drops below a predetermined value, it is determined as the noise, conversely, if it exceeds, the determination of the running is held.

(3) In the above description, the action sensors 6 and 11 are mounted on a torso or a head region of a user 9. Although it is preferable to mount in such a manner in the pedometer mode, they may be put in a pocket, a bag and so on, and then the walking and so on may be performed. Also, in the above contents, in the communication mode, it is preferable to mount the action sensors 6 and 11 on a torso or a head region. However, in the communication mode, the action sensors 6 and 11 may be mounted on or held by a part or all of the arms and legs depending on contents to be provided. Incidentally, needless to say, the contents to be provided by the processor 13 are not limited to the above ones.

(4) In the above description, the processor 13 of the cartridges 3 and 4 processes the acceleration information, which is sequentially received in real time, in relation to the video image to be displayed on the television monitor 5. However, the processor 13 may process the acceleration information, which is sequentially received in real time, in relation to audio, a computer, or a predetermined mechanism. Of course, it is not limited to the acceleration, and the other physical quantity and the result of the operation thereto may be used.

For example, a speaker of the television monitor 5 outputs voice (for instructing the user to perform a motion) generated by the processor 13, simultaneously, it is determined whether or not the user 9 performs the motion in accordance with the voice on the basis of the acceleration from the action sensor 6 or 11, and then the determination result is displayed on the television monitor 5. For example, the processor 13 may control audio to be outputted from a speaker of the television monitor 5 on the basis of the acceleration from the action sensor 6 or 11. For example, the processor 13 may control another computer on the basis of the acceleration from the action sensor 6 or 11. For example, the processor 13 may control the predetermined mechanism such as a machine (a robot and so on) and equipment on the basis of the acceleration from the action sensor 6 or 11.

(5) In the above description, although a cartridge system is employed, the cartridge 3 or 4 and the adapter 1 may be formed as a unit.

(6) In the above description, although the motion form of the user 9 is classified into any one of three types, the number of classifications is not limited thereto, it may be classified into one of two types, or any one of four or more types.

(7) In the above description, the action sensors 6 and 11 do not compute the amount of the activity. However, the action sensors 6 and 11 may compute the amount of the activity and display it on the LCD 35. Incidentally, in this case, in the automatic recording mode of the third embodiment, although the action sensor 6 performs the second-order processing, as described above, just because it is preferable to perform the first or less-processing, it does not mean that the second or more-order processing is restricted. For the similar reason, the n-th-order processing is restricted in the manual recording mode.

(8) In the third embodiment, the action sensor 6 has the communication mode, the automatic recording mode, and the manual recording mode. However, the action sensor 6 may have only the communication mode and the automatic recording mode, or only the communication mode and the manual recording mode.

(9) The action sensor 11 according to the first embodiment may have the same function as the action sensor 11 according to the third embodiment (the communication mode, the automatic recording mode, and the manual recording mode).

While the present invention has been described in detail in terms of embodiments, it is apparent that those skilled in the art will recognize that the invention is not limited to the embodiments as explained in this application. The present invention can be practiced with modification and alteration within the spirit and scope of the present invention as defined by the appended any one of claims.

1-21. (canceled)

22. A motion form determining apparatus for determining a motion form of a user, comprising:
a first classifying unit operable to classify motion of the user into any one of a plurality of first motion forms on the basis of magnitude of acceleration which arises due to the motion of the user; and
a second classifying unit operable to classify the motion of the user which is classified into the first motion form into any one of a plurality of second motion forms on the basis of information relating to velocity of the user based on the acceleration.

23. The motion form determining apparatus as claimed in claim 22, further comprising:
a determining unit operable to determine whether or not the user performs motion corresponding to one step on the basis of the acceleration,
wherein said first classifying unit performs the process for classifying after said determining unit determines that the motion corresponding to one step is performed.

24. The motion form determining apparatus as claimed in claim 22, wherein said first classifying unit performs the process for classifying on the basis of a maximum value and a minimum value of the acceleration during a period from time when one step arises until time when a next one step arises.

25. The motion form determining apparatus as claimed in claim 24, wherein said first classifying unit classifies the motion of the user into the first motion form indicating running if the maximum value exceeds a first threshold value and the minimum value is below a second threshold value, and classifies the motion of the user into the first motion form indicating walking if the maximum value is below the first threshold value or if the minimum value exceeds the second threshold value.

26. The motion form determining apparatus as claimed in claim 22, wherein in a case where the motion of the user is classified into the first motion form indicating walking, said second classifying unit classifies the motion of the user into the second motion form indicating standard walking if the information relating to the velocity of the user is below a third threshold value, and classifies the motion of the user into the second motion form indicating rapid walking if the information relating to the velocity of the user exceeds the third threshold value.

27. The motion form determining apparatus as claimed in claim 26, further comprising:
a first specifying unit operable to specify that the second motion form includes going up and down if a maximum value of the acceleration during a period from time when one step arises until time when a next one step arises exceeds a fourth threshold value, in a case where the motion of the user is classified into the second motion form indicating standard walking.

28. The motion form determining apparatus as claimed in claim 26, wherein in a case where the motion of the user is classified into the first motion form indicating running, said second classifying unit classifies the motion of the user into the second motion form indicating rapid walking/running if the information relating to the velocity of the user exceeds a fifth threshold value, and classifies the motion of the user into the second motion form indicating rapid walking if the information relating to the velocity of the user is below the fifth threshold value.

29. The motion form determining apparatus as claimed in claim 28, further comprising:
a second specifying unit operable to specify that the motion of the user is the second motion form indicating running if a maximum value of the acceleration during a period from time when one step arises until time when a next one step arises exceeds a sixth threshold value, and specify that the motion of the user is the second motion form indicating rapid walking if the maximum value is below the sixth threshold value, in a case where the motion of the user is classified into the second motion form indicating rapid walking/running.

30. The motion form determining apparatus as claimed in claim 22, further comprising:
an activity amount computing unit operable to compute amount of activity for each second motion form.

31. The motion form determining apparatus as claimed in claim 22, further comprising:
a third specifying unit operable to specify on the basis of magnitude of the acceleration that the motion of the user as classified into the second motion form is the second motion form including a third motion form.

32. The motion form determining apparatus as claimed in claim 22, further comprising:
a third classifying unit operable to classify the motion of the user as classified into the second motion form into any one of a plurality of fourth motion forms on the basis of magnitude of the acceleration.

33. An activity computing apparatus, comprising:
a unit operable to acquire acceleration data which arises depending on motion of a user; and
a unit operable to obtain amount of activity in acquiring the acceleration data by multiplying the acceleration data by predetermined amount of activity per unit acceleration.

34. The activity computing apparatus as claimed in claim 33, further comprising:
a unit operable to accumulate the amount of the activity in acquiring the acceleration data.

35-38. (canceled)

39. A motion form determining method for determining a motion form of a user, comprising the steps of:
classifying motion of the user into any one of a plurality of first motion forms on the basis of magnitude of acceleration which arises due to the motion of the user; and
classifying the motion of the user which is classified into the first motion form into any one of a plurality of second motion forms on the basis of information relating to velocity of the user based on the acceleration.

40. An activity computing method, comprising the steps of:
acquiring acceleration data which arises depending on motion of a user; and
obtaining amount of activity in acquiring the acceleration data by multiplying the acceleration data by predetermined amount of activity per unit acceleration.

41-46. (canceled)

47. A computer readable recording medium embodying a computer program, which makes a computer execute the motion form determining method as claimed in claim 39.

48. A computer readable recording medium embodying a computer program, which makes a computer execute the activity computing method as claimed in claim 40.

49-52. (canceled)
